(19) United States
(12) Patent Application Publication
(10) Pub. No.: US 2011/0148248 A1
(43) Pub. Date: Jun. 23, 2011

(54) DEVICE AND METHOD FOR GENERATING ELECTRICITY

(75) Inventor: Benzion Landa, Nes Ziona (IL)

(73) Assignee: Landa Laboratories Ltd., Nes Ziona (IL)

(21) Appl. No.: 13/061,160

(22) PCT Filed: Aug. 27, 2009
(86) PCT No.: PCT/IL09/00831

§ 371 Date: Feb. 28, 2011

Related U.S. Application Data
(60) Provisional application No. 61/136,317, filed on Aug. 28, 2008.

(30) Foreign Application Priority Data
Sep. 8, 2008 (GB) 0816418.8

(51) Int. Cl. H02N 3/00

(52) U.S. Cl. 310/306

(57) ABSTRACT

A device and method for directly converting thermal energy to electricity are disclosed. The device comprises a first surface and second surface preferably of different materials, and a gas medium having gas molecules in thermal motion between the surfaces. The first surface is operative to transfer charge to gas molecules interacting with the first surface, and the second surface is operative to receive the charge from gas molecules interacting with the second surface.

### FIELD AND BACKGROUND OF THE INVENTION

The present invention, in some embodiments thereof, relates to energy conversion and, more particularly, but not exclusively, to a device and method for generating electricity.

Energy conversion systems receive energy in one form and convert it to energy in another form. A thermoelectric converter, for example, receives thermal energy and produces electricity.

One type of thermoelectric converter employs the Seebeck thermoelectric effect, according to which electrical current is generated between two junctions of dissimilar conductive materials. Seebeck-based thermoelectric generators are typically used as temperature sensors also known as thermocouples, but attempts have also been made to use thermoelectric generators for powering electronic circuits (see, e.g., International Patent Publication No. WO 07/149,185).

Another type of thermal energy converter is a thermionic converter which employs the thermionic emission effect according to which, at sufficiently high temperatures, electrons can be emitted out of a solid surface. Thermionic converters typically include a hot body and a cold body, with a thermal gradient of at least several hundreds of Celsius degrees. The hot body is kept at a sufficiently high temperature for the thermionic emission effect to take place (typically above 1000° C.). Electrons are emitted from the surface of the hot body and collide with the surface of the cold body, thereby generating a voltage across the gap between the surfaces. A description of thermionic converters can be found in U.S. Pat. No. 7,109,408.

The operating principle of the thermionic converter differs from that of the thermoelectric generator. One difference is in the nature of charge transport across the device. In the thermionic converter, charge transport is governed by motion of free electrons, while in the thermoelectric generator charge transport is governed by diffusion of electrons and holes in conductors that are in physical contact.

An additional type of heat converter is a thermotunneling converter, which employs a quantum mechanical tunneling effect according to which a particle can penetrate through a potential barrier higher than its kinetic energy. A thermotunneling converter includes a hot surface and a cold surface, and typically operates in vacuum. The surfaces are held sufficiently close to one another so as to allow electrons to move from the hot surface to the cold surface by tunneling. Description of a thermotunneling converter is found in U.S. Pat. Nos. 3,169,200 and 6,876,123. A hybrid energy converter which combines the thermionic and thermotunneling principles is disclosed in U.S. Pat. No. 6,489,704.

Also of interest is an essay by J. M. Dudley, entitled “Maxwell's Pressure Demon and the Second Law of Thermodynamics”, Infinite Energy Magazine 66 (2006) 21. Dudley describes a device which includes a pair of aluminum plates with two fiberglass screens between the aluminum plates with a copper foil between the fiberglass screens. Dudley claims that a voltage drop across the device was increased when a pressure was applied on the aluminum plates. Dudley attempts to dismiss ambient humidity so as to exclude or reduce the effect of electrochemical reaction and postulates that the voltage drop results from the tunneling effect.

### SUMMARY OF THE INVENTION

Some embodiments of the present invention are concerned with a device for generating electricity which derives its energy from thermal motion of gas molecules. In some embodiments of the present invention the device comprises a pair of spaced apart surfaces made of different materials and a gas medium between the surfaces. Each such pair of surfaces and the intermediate gas may be referred to herein as a cell. Gas molecules become charged at a first surface of the pair and by thermal motion move to the second surface of the pair to transfer net charge from a first surface of the pair to a second surface of the pair. In some embodiments of the invention the entire system operates at ambient or near ambient temperature.

Without wishing to be bound by any particular theory, it is believed that the transport of charge between the surfaces is effected by the interaction between two mechanisms. A first mechanism is heat exchange between the gas medium and a source of heat, which may be the environment. A second mechanism is a gas mediated charge transfer which is further detailed hereinunder and exemplified in the Examples section that follows.

The heat exchange maintains the thermal motion of the gas molecules, and the gas mediated charge transfer maintains potential difference between the two surfaces. Due to its thermal energy, a sufficiently fast gas molecule can transport electrical charge from one surface to the other. Due to the interaction between the gas molecules and the surfaces, charge transfer can occur. This interaction can be momentary (e.g., via an elastic or inelastic collision process) or prolonged (e.g., via an adsorption-desorption process) as described hereinunder.

When a gas molecule interacts with the first surface, the first surface can charge the molecule, for example, by transferring an electron to or from the gas molecule. When the charged gas molecule interacts with the second surface, the second surface can receive the excess charge from the charged gas molecule. Thus, the first surface serves as an electrical charge donor surface and the second surface serves as electrical charge receiver surface, or vice versa.

The transferred charge creates an electrical potential difference between the surfaces, optionally without any externally applied voltage, and can be used to produce an electrical current.

It is believed that the gas cools as a result of the gas molecule slowing down due to the work done in transporting the charge across the gap, overcoming the attractive force of its minor image charge. To provide a steady state system, thermal energy is preferably transferred to the gas, for example from the environment.

Since the potential difference between the surfaces is generated by thermal motion of molecules serving as charge transporters from one surface to the other, there is no need to maintain a temperature gradient between the surfaces. Thus, the two surfaces can be within 50 C.°, or within 10 C.°, or within 1 C.° of each other. In some embodiments of the present invention the difference in temperatures between the surfaces in Kelvin scale is less than 5% or less than 3% or less than 2%, e.g., 1% or less.

In various exemplary embodiments of the invention the two surfaces can be at substantially the same temperature. Though no extreme temperatures conditions are necessary for the operation of the cell or device, the proportion of high speed gas molecules able to be efficient charge transporters increases with temperature. Therefore, the efficiency of any given cell or device is expected to increase with increasing temperature, within its operating range. In various exemplary embodiments of the invention, both surfaces are at a temperature which is below 400° C. or below 200° C. or below 100° C. or below 50° C. In some embodiments of the invention both surfaces are at a temperature which is less than 30° C. and above 15° C., for example, at room temperature (e.g., about 25° C.) or in its vicinity. In some embodiments of the invention both surfaces are at a temperature which is less than 15° C. and above 0° C. and in some embodiments of the invention both surfaces are at a temperature which is less than 0° C.

In various exemplary embodiments of the invention the ability of the first surface to transfer charge of a certain polarity to the gas medium is different than the ability of the second surface to transfer charge to the gas medium. This configuration allows for the gas molecules to acquire charge upon interacting with one of the surfaces and to lose charge upon interacting with the other surface.

When the surfaces are connected via electrical contacts to an external electrical load, current flows from the surface which is more likely to lose a negative charge to the gas medium, through the load, to the surface which is more likely to gain a negative charge from the gas medium

It is understood that to provide an efficient transfer of charge, a significant number of the charged molecules should travel from the first to the second surface. In a preferred embodiment of the invention, the distance between the surfaces is small enough so that this condition is met. A sufficiently small gap reduces the number of intermolecular collisions and lowers the image charge potential barrier produced by the charged molecule, hence increases the probability for a sufficiently fast molecule leaving the vicinity of the first surface to successfully traverse the gap without colliding with other gas molecules and to transfer the charge to the second surface. Preferably, the gap between the surfaces is of the order of the mean free path of the gas molecules. In general, it is desirable that the distance between the surfaces be less than 10 and preferably less than 5, 2 or some lesser or intermediate multiple of the mean free path of the molecules at the temperature and pressure of operation. Ideally, it should be one mean free path or less. In general, it is desirable that the distance between the surfaces be less than 1000 nm, more preferably less than 100 nm, more preferably less than 10 nm, and ideally, but not necessarily, less than 2 nm.

Irrespective of the validity of the theory described above, the present inventor has found that under certain circumstances current and voltage can be generated by gas mediated charge transfer between two elements of a system with no input of energy to the system except via the thermal energy of the gas molecules.

Several such cells can be arranged together to form a power source device. In this embodiment, the cells are arranged thereamongst so as to allow current to flow between adjacent cells arranged in series. Preferably, such cells are arranged in series and/or in parallel, with the series arrangement providing an increased voltage output as compared to a single cell and the parallel arrangement providing an increased current.

According to an aspect of some embodiments of the present invention, there is provided a cell device for directly converting thermal energy to electricity. The cell device comprises a first surface and second surface with a gap between the surfaces; and a gas medium having gas molecules in thermal motion situated between the surfaces; the first surface being operative to transfer an electric charge to gas molecules interacting with the first surface, and the second surface being operative to receive the charge from gas molecules interacting with the second surface; wherein an electrical potential difference between the surfaces is generated by the charge transfer in the absence of externally applied voltage.

According to an aspect of some embodiments of the present invention, there is provided a cell device for directly converting thermal energy to electricity. The cell device comprises a first surface and second surface with a gap between the surfaces; and a gas medium having gas molecules in thermal motion situated between the surfaces; the first surface being operative to transfer an electric charge to gas molecules interacting with the first surface, and the second surface being operative to receive the charge from gas molecules interacting with the second surface; wherein the gap is less than 1000 nanometers.

According to an aspect of some embodiments of the present invention, there is provided a cell device for directly converting thermal energy to electricity. The cell device comprises a first surface and second surface with a gap between the surfaces; and a gas medium having gas molecules in thermal motion situated between the surfaces; the first surface being operative to transfer an electric charge to gas molecules interacting with the first surface, and the second surface being operative to receive the charge from gas molecules interacting with the second surface; wherein the first and the second surfaces are within 50 C.° of each other.

According to an aspect of some embodiments of the present invention, there is provided a cell device for directly converting thermal energy to electricity. The cell device comprises a first surface and second surface with a gap between the surfaces; and a gas medium having gas molecules in thermal motion situated between the surfaces; the first surface being operative to transfer an electric charge to gas molecules interacting with the first surface, and the second surface being operative to receive the charge from gas molecules interacting with the second surface; wherein the first and the second surfaces are at a temperature of less than 200° C.

According to some embodiments of the present invention, the first surface has a positive charge transferability and the second surface has a negative charge transferability.

According to an aspect of some embodiments of the present invention, there is provided a cell device for generating electricity. The cell device comprises a first surface in electrical communication with a first electrical contact; a second surface in electrical communication with a second electrical contact and being within 50 C.° of the first surface; and a gas medium situated in a gap between the surfaces; wherein the first surface has a positive charge transferability, and wherein the electrical contacts are connectable to a load to provide a load current flowing from the first surface through the load to the second surface.

According to some embodiments of the present invention, at least one of the surfaces is a surface of an electrically conducting substrate.

According to some embodiments of the present invention, at least one of the surfaces is a surface of a substrate having electrical conductivity less than 10⁻⁹ S/m.

According to an aspect of some embodiments of the present invention, there is provided a power source device. The power source device comprises a plurality of cell devices as described herein, wherein at least one pair of adjacent cell devices is interconnected by a conductor such that current flows through the conductor from a second surface of a first device of the pair to a first surface of a second device of the pair.

According to some embodiments of the present invention, the pairs of adjacent cell devices are arranged in a series and parallel arrangement such that the current of the power source device is greater than that of any single cell and such that the voltage of the power source device is greater than that of any one cell device.

According to an aspect of some embodiments of the present invention, there is provided a power source device. The power source device comprises a first electrically conducting electrode and a second electrically conducting electrode; a first stack of cell devices and a second stack of cell devices between the electrodes, each cell device being as described herein; wherein in each stack, each pair of adjacent cell devices of the stack is interconnected by a conductor such that current flows through the conductor from a second surface of a first cell device of the pair to a first surface of a second cell device of the pair; and wherein both the first stack and the second stack convey charge from the first electrode to the second electrode.

According to some embodiments of the present invention, the conductor is an electrically conductive substrate having two sides, one side of which constitutes a surface of one cell device and the opposite side constitutes a surface of an adjacent cell device.

According to some embodiments of the present invention, the conductor is a substrate coated with a conductive material such as to establish electrical conduction between a first side of the substrate and a second side of the substrate, wherein the conductor is an electrically conductive substrate having two sides, one side of which constitutes a surface of one cell device and the opposite side constitutes a surface of an adjacent cell device.

According to some embodiments of the present invention, the surfaces of the cells overlap one another in an ordered or random manner, such that a single substrate's surface is partially shared by at least two cells.

According to an aspect of some embodiments of the present invention, there is provided a method of directly converting thermal energy to electricity. The method comprises: providing a first surface and a second surface with a gap between the surfaces; interacting molecules of a gas medium with the first surface so as to transfer an electric charge to at least some of the gas molecules; and interacting a portion of the gas molecules with the second surface, so as to transfer the charge to the second surface from at least some of the gas molecules, thereby generating a potential difference between the surfaces; wherein the gap is less than 1000 nm.

According to an aspect of some embodiments of the present invention, there is provided a method of directly converting thermal energy to electricity. The method comprises: providing a first surface and second surface with gap between the surfaces; interacting molecules of a gas medium with the first surface so as to transfer an electric charge to at least some of the gas molecules; and interacting a portion of the gas molecules with the second surface, so as to transfer the charge to the second surface from at least some of the gas molecules, thereby generating a potential difference between the surfaces; wherein the first and the second surfaces are within 50 C.° of each other.

According to an aspect of some embodiments of the present invention, there is provided a method of directly converting thermal energy to electricity. The method comprises: providing a first surface and second surface with a gap between the surfaces; interacting molecules of a gas medium with the first surface so as to transfer an electric charge to at least some of the gas molecules; and interacting a portion of the gas molecules with the second surface, so as to transfer the charge to the second surface from at least some of the gas molecules, thereby generating a potential difference between the surfaces; wherein the first and the second surfaces are at a temperature of less than 200° C.

According to an aspect of some embodiments of the present invention, there is provided a method of directly converting thermal energy to electricity. The method comprises: providing a first surface and second surface with a gap between the surfaces; interacting molecules of a gas medium with the first surface so as to transfer an electric charge to at least some of the gas molecules; and interacting a portion of the gas molecules with the second surface, so as to transfer the charge to the second surface from at least some of the gas molecules, thereby generating a potential difference between the surfaces; wherein the potential difference between the surfaces is generated by the charge transfer in the absence of externally applied voltage.

According to some embodiments of the present invention, one of the surfaces charges the gas molecules and the other surface neutralizes the charged gas molecules.

According to some embodiments of the present invention, both of the surfaces charge gas molecules, one charging gas molecules positively and the other charging gas molecules negatively.

According to some embodiments of the present invention, any voltage between the surfaces is generated by the charge transfer in the absence of externally applied voltage.

According to some embodiments of the present invention, the device further comprises a sealed enclosure for preventing leakage of the gas medium.

According to some embodiments of the present invention, the pressure within the sealed enclosure is higher than ambient pressure. According to some embodiments of the present invention, the pressure within the sealed enclosure is lower than ambient pressure. According to some embodiments of the present invention, the pressure within the sealed enclosure is higher than 1.1 atmospheres. According to some embodiments of the present invention, the pressure within the sealed enclosure is higher than 2 atmospheres.

According to some embodiments of the present invention, the gap is less than 1000 nm, or less than 100 nm, or less than 10 nm, or less than 5 nm, or less than 2 nm.

According to some embodiments of the present invention, the first and the second surfaces are within 50 C.°, or within 10 C.°, or within 1 C.°, of each other.

According to some embodiments of the present invention, the first and the second surfaces are at a temperature of less than 200° C., or less than 100° C., or less than 50° C.

According to some embodiments of the present invention, the first surface and second surface are substantially smooth and are spaced apart by spacers.

According to some embodiments of the present invention, the gap is maintained by roughness features outwardly protruding from at least one of the surfaces.

According to some embodiments of the present invention, at least one of the surfaces comprises at least one magnetic or non-magnetic substance selected from the group consisting of metals, semi-metals, alloys, intrinsic or doped, inorganic or organic, semi-conductors, dielectric materials, layered materials, intrinsic or doped polymers, conducting polymers, ceramics, oxides, metal oxides, salts, crown ethers, organic molecules, quaternary ammonium compounds, cermets, and glass and silicate compounds.

According to some embodiments of the present invention, the surfaces each independently comprise at least one magnetic or non-magnetic substance selected from the group consisting of aluminum, cadmium, chromium, cobalt, copper, gadolinium, gold, graphite, graphene, hafnium, iron, lead, magnesium, manganese, molybdenum, palladium, platinum, nickel, silver, tantalum, tin, titanium, tungsten, zinc; antimony, arsenic, bismuth; graphite oxide, silicon oxide, aluminum oxide, manganese dioxide, manganese nickel oxide, tungsten dioxide, tungsten trioxide, indium tin oxide, calcium oxide, yttrium oxide, zirconium oxide, lanthanum oxide, strontium oxide, yttrium calcium barium copper oxide; brass, bronze, duralumin, invar, steel, stainless steel; barium sulfide, calcium sulfide; intrinsic or doped silicon wafers, germanium, silicon, aluminum gallium arsenide, cadmium selenide, gallium manganese arsenide, zinc telluride, indium phosphide, gallium arsenide and polyacetylene; MACOR®, aluminum nitride, boron nitride, titanium nitride, lanthanum hexaboride; hafnium carbide, titanium carbide, zirconium carbide, tungsten carbide; barium titanate, calcium fluoride, calcium salts, rare-earth salts, zirconium salts, manganese salts, lead salts, cobalt salts, zinc salts; chromium silicide, Cr₃Si—SiO₂, Cr₃C₂—Ni, TiN—Mo; glass and phlogopite mica, nigrosine, sodium petronate, polyethylene imine, gum malaga, OLOA 1200, lecithin, intrinsic and doped nitrocellulose based polymers, polyvinyl chloride based polymers and acrylic resins.

According to some embodiments of the present invention, the surfaces comprise at least one substance independently selected from the group consisting of aluminum, chromium, gadolinium, gold, magnesium, molybdenum, stainless steel, silica, manganese dioxide, manganese nickel oxide, tungsten trioxide, reduced graphite oxide, graphite, graphene, chromium silicide silica, cesium fluoride, HOPG, calcium carbonate, magnesium chlorate, glass, phlogopite mica, aluminum nitride, boron nitride, glass ceramic, doped nitrocellulose, boron doped silicon wafer, and phosphorous doped silicon wafer.

According to some embodiments of the present invention, each of the first and second surfaces is supported by a graphene substrate.

According to some embodiments of the present invention, each of the first and second surfaces is supported by a graphite substrate.

According to some embodiments of the present invention, each of the first and second surfaces is a modified graphite or graphene substrate.

According to some embodiments of the present invention, one of the first and second surfaces is a modified graphite or graphene substrate and the other is an unmodified graphite or graphene substrate.

According to some embodiments of the present invention, the first surface comprises at least one substance selected from the group consisting of gold, magnesium, cesium fluoride, HOPG, calcium carbonate, aluminum, chromium, gadolinium, molybdenum, stainless steel, silica, phlogopite mica, manganese dioxide, manganese nickel oxide, tungsten trioxide, reduced graphite oxide, graphite, graphene, chromium silicide silica, boron doped silicon wafer, phosphorous doped silicon wafer, and boron nitride.

According to some embodiments of the present invention, the second surface comprises at least one substance selected from the group consisting of gold, magnesium chlorate, aluminum, glass ceramic, doped nitrocellulose, glass, silica, aluminum nitride, and phosphorous doped silicon wafer.

According to some embodiments of the present invention, the gas medium comprises at least one element selected from the group consisting of halogen, nitrogen, sulfur, oxygen, hydrogen containing gasses, inert gases, alkaline gases and noble gases.

According to some embodiments of the present invention, the gas medium comprises at least one gas selected from the group consisting of At₂, Br₂, Cl₂, F₂, I₂, WF₆, PF_{S}, SeF₆, TeF₆, CF₄, AsF₅, BF₃, CH₃F, C₅F₈, C₄F₈, C₃F₈, C₃F₆O, C₃F₆, GeF₄, C₂F₆, CF₃COCl, C₂HF₅, SiF₄, H₂FC—CF₃, CHF₃, CHF₃, Ar, He, Kr, Ne, Rn, Xe, N₂, NF₃, NH₃, NO, NO₂, N₂O, SF₆, SF₄, SO₂F₂, O₂, CO, CO₂, H₂, deuterium, i-C₄H₁₀, CH₄, Cs, Li, Na, K, Cr, Rb, and Yb.

According to some embodiments of the present invention, the gas medium comprises at least one gas selected from the group consisting of sulfur-hexafluoride, argon, helium, krypton, neon, xenon, nitrogen, methane, carbon tetrafluoride, octofluoropropane, water vapors and air.

According to some embodiments of the present invention, the gas medium is not consumed during operation of the device.

According to an aspect of some embodiments of the present invention, there is provided a method, which comprises providing at least one cell device having a first surface and second surface with a gap between the surfaces filled with a liquid medium having therein electroactive species, the gap being of less than 50 micrometers; applying voltage between the first and the second surfaces so as to induce electrochemical or electrophoretic interaction of the electroactive species with at least one of the surfaces, thereby modifying surface properties of the interacted surface; and evacuating at least a portion of the liquid so as to reduce the gap by at least 50%.

According to some embodiments of the present invention, the method is executed simultaneously for a plurality of cell devices.

According to some embodiments of the present invention, the evacuation reduces the gap by at least 90%.

According to some embodiments of the present invention, the first and the second surfaces are made of the same material prior to the surface modification, and the electroactive species are selected such that subsequent to the electrodeposition, a characteristic charge transferability of the first surface differs from a characteristic charge transferability of the second surface.

According to some embodiments of the present invention, the same material is graphene.

According to some embodiments of the present invention, the same material is graphite.

According to some embodiments of the present invention, the electroactive species are selected from the group consisting of salts and dyes.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, shall apply. In addition, the materials, methods, and examples are illustrative only and are not intended to be necessarily limiting.

### BRIEF DESCRIPTION OF THE DRAWINGS

Some embodiments of the invention are herein described, by way of example only, with reference to the accompanying drawings and images. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIGS. 1A and 1B are schematic illustrations of a cell for generating electricity, according to various exemplary embodiments of the present invention.

FIGS. 1C-1F are schematic illustrations of potentials within the cell of FIG. 1A, or a modified version thereof. FIGS. 1C and 1D show the image charge potential across the gap of a cell of FIG. 1A modified to have identical surfaces. FIGS. 1E and 1F show the potential across the gap of a cell of FIG. 1A where the surfaces are different. FIGS. 1G and 1H shows the potential barrier (FIG. 1G) and the current per surface area (FIG. 1H) as a function of the gap size within the cell of FIG. 1A.

FIGS. 2A and 2B are schematic illustrations of a power source device, according to various exemplary embodiments of the present invention.

FIG. 3 is a schematic illustration of an experimental setup used according to some exemplary embodiments of the present invention for the measurements of charge transferability in terms of electrical current generated between a target mesh and a jet nozzle in response to a gas jet flowing through the mesh.

FIG. 4 shows peak currents measured in the setup illustrated in FIG. 3 for various materials.

FIG. 5 shows Kelvin probe measurements for various materials in the presence of various gases.

FIG. 6 is a schematic illustration of an experimental setup used according to some embodiments of the present invention for generating electrical current by thermal motion of gas molecules, wherein the surfaces are in no direct or indirect contact.

FIGS. 7A-7C are typical oscilloscope outputs obtained during an experiment performed according to some embodiments of the present invention using the experimental setup illustrated in FIG. 6.

FIG. 8 is a schematic illustration of an experimental setup used for work function modification, according to some embodiments of the present invention.

FIG. 9 is a schematic illustration of an experimental setup used for the analysis of several non-conductive materials for use as spacers, according to some embodiments of the present invention.

FIG. 10 shows discharge graphs for several materials studied for use as spacers according to some embodiments of the present invention using the experimental setup illustrated in FIG. 9.

FIG. 11 is a schematic illustration of an experimental setup used according to some embodiments of the present invention for generating electrical current by thermal motion of gas molecules, wherein the surfaces are in direct or indirect contact through asperities or spacers.

FIG. 12 shows a current as a function of time, as measured for several gas pressures during an experiment performed according to some embodiments of the present invention using the experimental setup illustrated in FIG. 11. The arrows indicate changes in gas pressure.

FIG. 13 is a graph showing threshold pressures for obtaining maximal current in a specific setup, as measured in an experiment performed according to some embodiments of the present invention. The pressures are presented as a function of the reciprocal diameter square of the gas molecule.

FIG. 14 shows current as a function of time, as measured for several temperatures during an experiment performed according to some embodiments of the present invention using the experimental setup illustrated in FIG. 11.

FIG. 15 shows current as a function of temperature as measured in eight experiment runs, performed according to some embodiments of the present invention.

FIG. 16 shows the voltage accumulating over time as measured across a single pair of surfaces (continuous line) over minutes (bottom abscissa) or across a stack of surfaces (dash line) over hours (top abscissa) in experiments performed according to some embodiments of the present invention.

FIG. 17 shows the variations in current (left ordinate) and the fluctuations in chamber temperature (right ordinate) as a function of time (abscissa) as simultaneously measured in an experiment performed according to some embodiments of the present invention.

FIG. 18 shows current at threshold pressure as a function of the size of spacers as measured in nine experiment runs, performed according to some embodiments of the present invention.

FIG. 19 shows the threshold pressures needed to obtain maximal current as a function of the reciprocal diameter square of the gas molecules, as measured in nine experiment runs in the absence or presence of spacers, performed according to some embodiments of the present invention.

FIGS. 20A-20D show the current (FIGS. 20A and 20C) and power (FIGS. 20B and 20D) as a function of applied voltage as measured in an experiment performed according to some embodiments of the present invention.

FIG. 21 shows current as a function of pressure as measured in an experiment performed according to some embodiments of the present invention.

### DESCRIPTION OF SPECIFIC EMBODIMENTS OF THE INVENTION

The present invention, in some embodiments thereof, relates to energy conversion and, more particularly, but not exclusively, to a device and method for generating electricity.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways. Furthermore, while the inventor believes that the theoretical explanation given for the operation of the various embodiments is correct, the apparatus and method as described and claimed are not dependent on said theory. The various embodiments are not necessarily mutually exclusive, as some embodiments can be combined with one or more other embodiments to form new embodiments. For clarity, certain elements in some of the drawings are illustrated not-to-scale. The drawings are not to be considered as blueprint specifications.

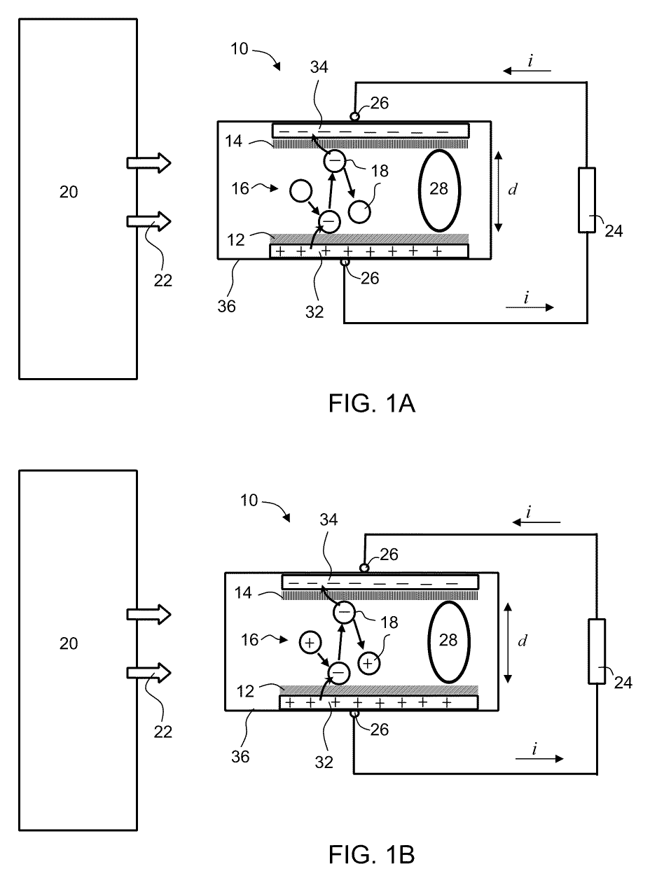

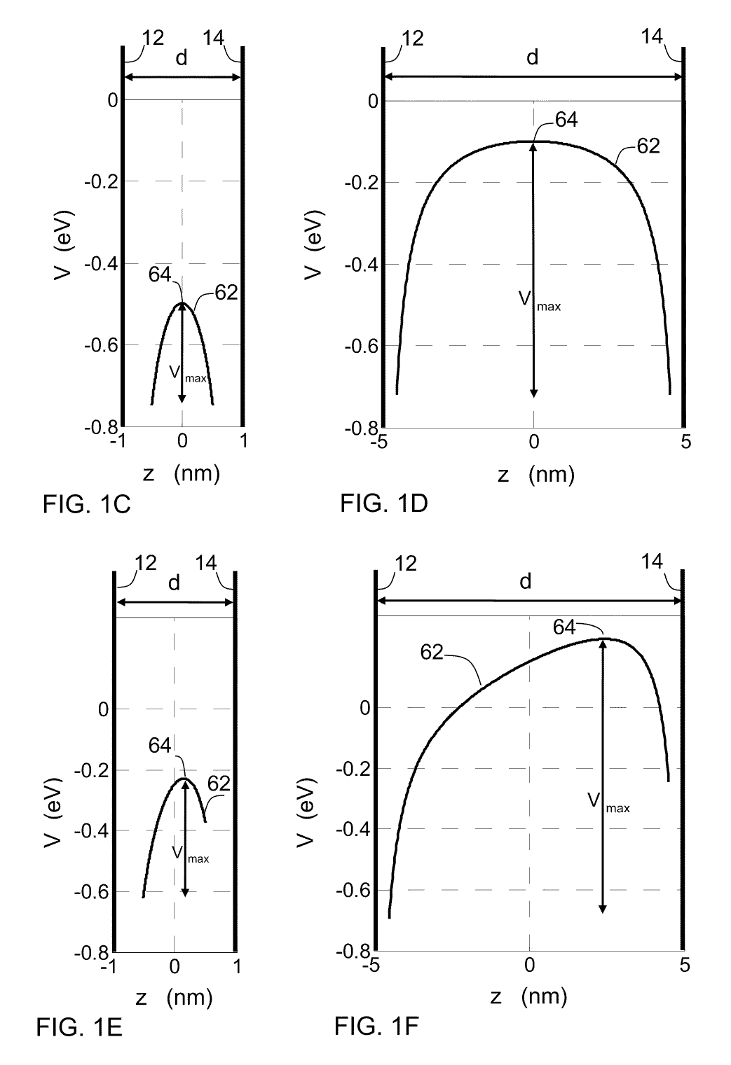

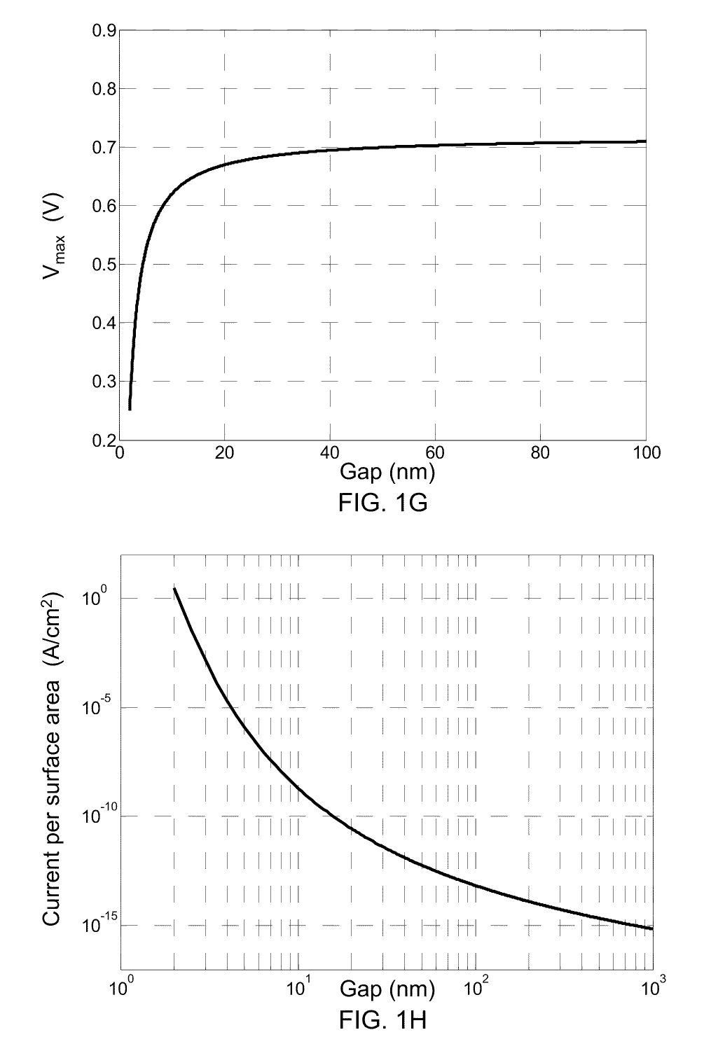

Referring now to the drawings, FIG. 1A illustrates a device 10 (a single cell) for generating electricity, according to various exemplary embodiments of the present invention. Cell device 10 comprises a pair of spaced apart surfaces 12 and 14, and a gas medium 16 between surfaces 12 and 14. Surfaces 12 and 14 are part of or are supported by substrates 32 and 34, respectively. Gas molecules 18 transport charge from first surface 12 to second surface 14. The motion of the gas molecules is caused by their thermal energy and is determined by the temperature of the gas. The temperature of the gas is maintained by thermal energy 22, supplied by a heat reservoir 20 as further detailed hereinunder. In the schematic illustration of FIG. 1A, surface 12 transfers negative charge to an electrically neutral molecule during the interaction of the molecule with surface 12 hence charging the molecule with a negative electrical charge. When the negatively charged molecule arrives at surface 14 and interacts therewith, surface 14 receives the negative charge from the molecule, neutralizing the molecule.

The interaction between the molecules and the surfaces can be momentary, e.g., via an elastic or inelastic collision process, or prolonged, e.g., via an adsorption-desorption process.

As used herein, “adsorption-desorption process” or “adsorption-desorption charge transfer process” means a process in which the molecule is firstly adsorbed by the surface for a sufficiently long time such that the molecule loses a significant amount of its kinetic energy and is subsequently desorbed from the surface, wherein the net charge of the molecule before the adsorption is different from the net charge of the molecule after the desorption.

In some adsorption-desorption processes, the molecule and the surface are in thermal equilibrium during the time interval at which the molecule is adsorbed. During the time of adsorption, the molecule can be considered as part of the surface. Thus, during this time interval, the electronic wavefunction of the surface includes the electronic wavefunctions of all molecules at the surface, including those which were adsorbed by the surface. Typically, but not necessarily, the adsorbed molecules are at the outermost molecular layer of the surface.

A “momentary process” between a molecule and a surface refers to a process in which the gas molecule is sufficiently close to the surface to allow charge transfer between the surface and the molecule, wherein the time interval of the process is significantly shorter than the time required for reaching thermal equilibrium between the molecule and the surface.

A typical type of momentary process is a collision. A gas molecule and a solid surface are said to be “in collision” if there is at least a partial spatial overlap between the electronic wavefunction of the molecule and the electronic wavefunction of the surface. Typically, a gas molecule and a solid surface are considered to be in collision when the distance between the center of the gas molecule and the outermost atom of the solid surface is less than 10 Angstroms, or alternatively less than 5 Angstroms.

A collision is said to be “elastic” when the kinetic energy before the collision equals the kinetic energy after the collision, and “inelastic” when the kinetic energy before the collision is higher than the kinetic energy after the collision. The collision between the molecules and the surface can be elastic or inelastic.

Although FIG. 1A illustrates the molecule as being neutral while moving from surface 14 to surface 12 and negatively charged while moving from surface 12 to surface 14, this need not necessarily be the case, since the molecules can alternatively be positively charged while moving from surface 14 to surface 12 and neutral while moving from surface 12 to surface 14. In any of the above scenarios, the ordinarily skilled person will appreciate that the process makes surface 12 positively charged and surface 14 negatively charged, as illustrated in FIG. 1A. Thus, in accordance with embodiments of the present invention, the gas molecules mediate negative charge transfer from surface 12 to surface 14 and/or positive charge transfer from surface 14 to surface 12.

In various exemplary embodiments of the invention, charge transfer from surface 12 to the molecules and from the molecules to surface 14 are facilitated by transferring electrons. Thus, in these embodiments the molecules receive electrons from surface 12 and transfer electrons to surface 14.

FIG. 1B schematically illustrates device 10 in embodiments in which bidirectional charge transfer is employed. In these embodiments, the molecules are negatively charged while moving from surface 12 to surface 14, as in FIG. 1A, and are positively charged while moving from surface 14 to surface 12. The advantage of these embodiments is that the efficiency of the thermal energy conversion process is higher. Bidirectional charge transfer, according to some embodiments of the present invention, will now be described.

Consider a molecule which has just received a negative charge from surface 12, and which is moving in the direction of surface 14. Suppose that this negatively charged molecule collides with surface 14 and interacts therewith. The collision process is not instantaneous. During the time the molecule spends in the vicinity of surface 14, the molecule can transfer a single negative charge to surface 14 (or equivalently receive a single positive charge from surface 14)—or more than a single charge. For example, during the first half of the interaction (while the molecule approaches or is being adsorbed by surface 14) the molecule can transfer a first negative charge to surface 14 to become electrically neutral, and during the second half of the interaction (while the molecule retreats or is being desorbed from surface 14) the molecule can transfer a second negative charge to surface 14 to become positively charged. A complementary charge transfer process can occur also at the vicinity of surface 12. For example, during the first half of the interaction between a positively charged molecule and surface 12 the molecule can receive a first negative charge from surface 12 to become electrically neutral, and during the second half of the interaction the molecule can receive a second negative charge from surface 12 to become negatively charged. When the molecules transport charges from one surface to the other, surface 12 becomes positively charged and surface 14 becomes negatively charged, thus establishing a potential difference between the surfaces. This potential difference can be exploited by connecting a load 24 (e.g., via electrical contacts 26) to the surfaces. Electrical current i flows from surface 12 to surface 14 through the load. Thus, device 10 can be incorporated in a power source device which supplies electrical current to a circuit, appliance or other load.

In various exemplary embodiments of the invention the kinetic energy of the gas molecules is due solely to the temperature of the gas. In these embodiments, no additional mechanism, (such as an external voltage source) is required for maintaining the motion of the gas molecules, which is entirely due to thermal energy. Moreover, though the gas interacts with the operating surfaces, unlike fuel cells, such interactions do not involve irreversible chemical reactions and the gas is not consumed in the process.

When device 10 reaches a steady state, the amount of charge passing through the load is approximately the same as the amount of charge transferred to the respective surface by the gas molecules, and, for a given load and temperature, the potential difference between the surfaces is approximately constant. Small temperature differences between the surfaces, even if present, do not play a significant part in the charge transfer mechanism described above.

The presence of charge on surfaces 12 and 14 creates an electrical potential which poses a barrier for the molecules transporting charge from one surface to the other. This manifests itself as attractive forces applied by surface 12 or 14 on oppositely charged molecules and as repulsive forces on like-charged molecules, as they bounce off their respective surfaces.

In thermally isolated conditions, the transfer of charges by the molecules bouncing between the surfaces (and, in so doing, overcoming the potential barrier) would continuously reduce the average kinetic energy of the gas molecules, resulting in a cooling of the gas medium to a temperature at which the kinetic energy of the gas molecules could no longer overcome the potential barrier. However, since device 10 is in thermal communication with thermal reservoir 20, thermal energy 22 is continuously supplied to the gas medium, thus replenishing the kinetic energy of the gas molecules. Thermal reservoir 20 can, for example, be the environment in which device 10 operates (for example the natural environment), and the thermal energy can be supplied to device 10 by conduction, convection and/or radiation and in turn be transferred to the gas medium.

Once the potential difference between the surfaces reaches a steady state, charge transfer is suppressed due to the electric field that has built up following the accumulation of charges on the surfaces. When device 10 is connected to load 24, accumulated charges are conducted from the surfaces through the load, thereby allowing the process of charge transfer to continue. As a result of the electrical current flowing through the load, heat or other useful work is produced at the load. Thus, at least part of the thermal energy transferred from reservoir 20 to the gas medium 16 is used by load 24 to perform useful work.

Generally, at a given non-zero temperature, although all gas molecules are in motion, not all molecules have the same velocity. Thus, not all charged gas molecules are able to successfully traverse the gap between the surfaces after bouncing off the charging surface. Only molecules having sufficient kinetic energy after passing the potential barrier can cross the gap and ensure charge transfer. Slower (less energetic) molecules can not overcome the potential barrier and do not participate in the charge transport process. For a given thermodynamic condition, the motion of gas molecule can be analyzed by means of statistical mechanics, particularly the Maxwell-Boltzmann speed distribution which is a scalar function describing the probability for a molecule to move within a particular range of speed (or, equivalently, to have a particular kinetic energy). Thus, the fraction of gas molecules which are sufficiently energetic to overcome the potential barrier between surfaces 12 and 14 can be estimated using the Maxwell-Boltzmann distribution. It is noted that the Maxwell-Boltzmann distribution is positive for any positive kinetic energy. Thus, there is always a non-zero probability of finding a sufficiently energetic molecule. In experiments performed by the present inventor, a current signal which is significantly above background noise was observed through load 24, demonstrating that at least some gas molecules successfully overcame the potential barrier. These experiments are described below.

The direction which a molecule leaves a surface depends on many parameters, such as the velocity (i.e., speed and direction) of the molecule arriving at the surface and the type of interaction between the molecule and the surface (e.g., number, location and orientation of surface atoms participating in the collision). Once the gas molecule leaves the surface in a particular direction, it travels a certain distance until it collides with a surface or another gas molecule and changes direction. The mean distance between two successive collisions of a gas molecule is known as the mean free path, and is denoted by the Greek letter λ. The value of λ, depends on the diameter of the molecule, the gas pressure and the temperature. In various exemplary embodiments of the invention, for any given pressure and composition of gas, the gap d between the surfaces is sufficiently small so as to limit the number of intermolecular collisions. This configuration increases the probability of a sufficiently energetic molecule to successfully traverse the gap without colliding with other gas molecules.

Aside from reducing the number of intermolecular collisions, a sufficiently small gap also lowers the image charge potential barrier produced by the interaction between the charged molecule and the surfaces, as will now be explained with reference to FIGS. 1C-1F. The image charge potential barrier is a sum of the contributions of the image charge potentials of both surfaces. Any charged gas molecule between two surfaces is attracted to both surfaces.

FIG. 1C illustrates the image potential between surfaces 12 and 14 for a case in which the surfaces are identical and are separated by a gap of 2 nm. The z-dependence of the potential is shown as curve 62 and was calculated for the case in which the charge transfer of one electron to the gas molecule occurs at a distance of 5 Å from the surface. The image potential has a point of local maximum 64, approximately halfway across the gap, at which there is no image charge force acting on the charged molecule. The image charge potential at local maximum 64 is denoted Vₘₐₓ and its value depends on d, the size of the gap.

FIG. 1D illustrates the situation when the size d of the gap is increased to 10 nm leading to an increase in the level of Vₘₐₓ. FIGS. 1E and 1F depict the potential across the same 2 nm and 10 nm exemplary gaps when surfaces 12 and 14 are not identical, herein illustrated by a difference in work function of 0.5 eV. In this case, the plotted potential corresponds to the image charge potential and to the potential due to the difference in work functions. The local maximum 64 at which there is no net force acting on the charged molecule is shifted toward the surface having the higher work function and the potential barrier Vₘₐₓ increases with increasing gap size.

Thus, when the size of the gap is reduced, the amount of kinetic energy required to overcome the potential barrier comprising the image charge potential barrier is also reduced allowing slower charged molecules to cross the gap.

Preferably, the gap d between surfaces 12 and 14 is of the order of the mean free path of the gas molecules at the operating temperature and pressure of device 10. For example, d can be less than 10 times the mean free path, more preferably less than 5 times the mean free path, more preferably less than 2 times the mean free path. For example, d may be approximately the mean free path or less. A typical value for the gap d between surfaces 12 and 14 is less than or about 1000 nm, more preferably less than about 100 nm, more preferably less than about 10 nm, more preferably less than or about 2 nm.

The separation between the surfaces 12 and 14 can be maintained in more than one way. In some embodiments of the present invention, one or more non-conductive spacers 28 are interposed between the surfaces to maintain separation. The spacer is “non-conductive” in the sense that it prevents short circuits in the gap. The size of spacer 28 is selected in accordance with the size d of the gap. Preferably, the dimension of the spacer is the desired spacing. The spacer can, for example, be a nanostructure of any shape. The cross-sectional area of the spacers in a plane essentially parallel to the surfaces is preferably substantially smaller than (e.g., less than 10% of) the area of surfaces 12 and 14, so as to allow sufficient effective exposure of the surfaces to one another.

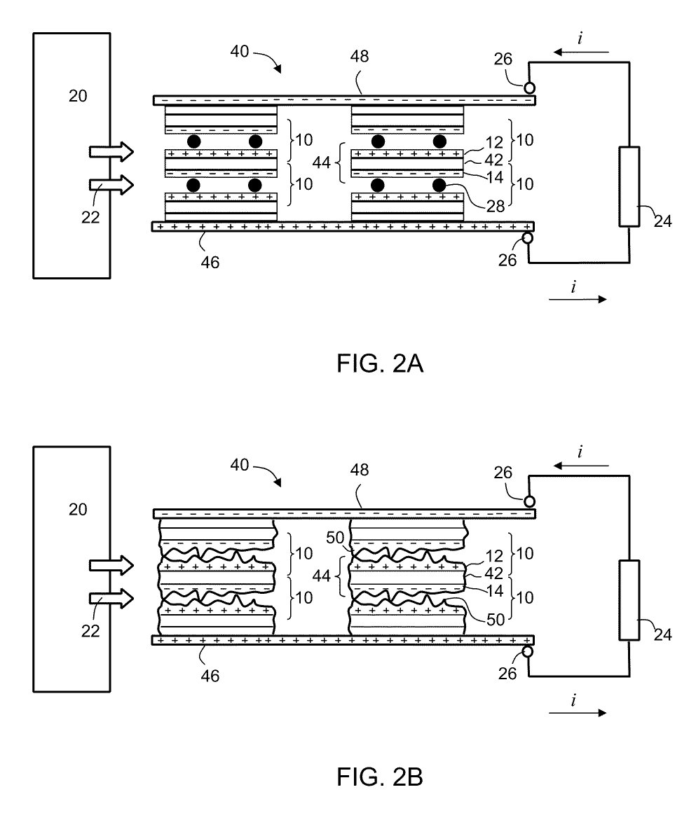

In some embodiments of the present invention, the separation between the surfaces is maintained by means of the outwardly protruding roughness features (not shown here, but see FIG. 2B for illustration) of the surfaces. These embodiments are particularly useful when at least one of surfaces 12 and 14 is made of a material which is poorly electrically conductive.

Molecule 18 extracts charge from a surface and transfers charge to a surface via a gas mediated charge transfer effect, whereby gas molecules gain or lose charge upon interacting with a surface. For example, the gas molecule can gain an electron by extracting it from the surface, or lose an electron by donating it to the surface. The gas mediated charge transfer can be effected by more than one mechanism. Transfer of an electron to a molecular entity can result in a molecule-electron unit in which there is a certain binding energy between the electron and the positively charged nucleus of the molecular entity. There is, however, interplay between the (short-range) electron binding and (long-range) Coulombic repulsion, which affect the stability of the molecule-electron unit. Broadly speaking, the quantum mechanical state of a molecule-electron unit can be stable, meta-stable or unstable.

When the binding energy is sufficiently high, the quantum mechanical state is stable and the molecule-electron unit is said to be an ion. For lower binding energies, the electron is only loosely attached to the molecule and the quantum mechanical state is meta-stable or unstable. Studies directed to electron attachment, particularly to formation of meta-stable or unstable molecule-units are found in the literature, see, e.g., \check{C}ade\check{z} et al., “Electron attachment to molecules and its use for molecular spectroscopy”, Acta Chim. Slov. 51 (2004) 11-21; R. A. Kennedy and C. A. Mayhew, “A study of low energy electron attachment to trifluoromethyl sulphur pentafluoride, SF₅CF₃: atmospheric implications”, International Journal of Mass Spectrometry 206 (2001) i-iv; Xue-Bin Wang and Lai-Sheng Wang, “Observation of negative electron-binding energy in a molecule”, Letters to Nature 400 (1999) 245-248.

It was found by the inventor of the present invention that molecule-electron units having loosely attached electrons can transport electrons from surface 12 to surface 14, since the lifetime of the molecule-electron quantum mechanical state is typically longer than the average time required for the molecule-electron unit to traverse the gap between the surfaces. It is postulated that charge transfer between the surfaces is predominantly via molecule-electron units being at a meta-stable or unstable quantum mechanical state. Yet, charge transfer via ionized molecules is not excluded.

During conception and reduction to practice of the present invention it has been postulated that attachment and detachment of electrons to and from the gas molecules or surfaces can be effected by a gas mediated mechanism similar to or related to the triboelectric effect.

The triboelectric effect (also known as “contact charging” or “frictional electricity”), is the charging of two different objects rubbing together or in relative motion with respect to each other and the shearing of electrons from one object to the other. The charging effect can easily be demonstrated with silk and glass. The present inventor has discovered and believes that a triboelectric-like effect can also be mediated by gas.

In various exemplary embodiments of the invention, the molecules acquire or lose an electron upon contacting the surface, e.g., via adsorption-desorption or a collision process as further detailed hereinabove.

The gas mediated charge transfer between the surfaces according to some embodiments of the present invention occurs at temperatures which are substantially below 400° C., or below 200° C., or below 100° C., or below 50° C. Yet, in some embodiments, the gas mediated charge transfer occurs also at temperatures higher than 400° C.

In various exemplary embodiments of the invention, both surfaces are at a temperature which is less than 30° C. and above 15° C., for example, at room temperature (e.g., about 25° C.) or in its vicinity. In some embodiments of the invention both surfaces are at a temperature which is less than 15° C. and above 0° C. and in some embodiments of the invention both surfaces are at a temperature which is less than 0° C.

Since the potential difference between the surfaces is generated by thermal motion of molecules serving as charge transporters from one surface to the other, there is no need to maintain a temperature gradient between the surfaces. Thus, the two surfaces can be at substantially the same temperature. This is unlike traditional thermoelectric converters in which an emitter electrode is kept at an elevated temperature relative to a collector electrode and the flow of electrons through the electrical load is sustained by means of the Seebeck effect. In such traditional thermoelectric converters, there are no gas molecules which serve as charge transporters. Rather, the thermal electrons flow directly from the hot emitter electrode to the cold collector electrode.

Surfaces 12 and 14 can have any shape. Typically, as illustrated in FIGS. 1A and 1B, the surfaces are planar, but non-planar configurations are also contemplated. Surfaces 12 and 14 are generally made of different materials or are surface modifications of the same material so as to allow the gas molecule, via the gas mediated charge transfer effect, to acquire negative charge (e.g., by gaining an electron) while contacting surface 12 and/or to acquire positive charge (e.g., by losing an electron) while contacting surface 14.

The gas mediated charge transfer of the present embodiments is attributed to the charge transferability.

“Charge transferability,” as used herein means the ability of a surface to transfer charge to the gas molecules or to receive charge from the gas molecules or, alternately, the ability of a gas molecule to transfer charge to the surface or to receive charge from the surface.

The charge transferability is determined by properties of the surfaces and of the gas molecules and may also depend on the temperature. Charge transferability describes the interaction between the particular surface and the particular gas molecules and reflects the likelihood of charge transfer, the degree of charge transfer as well as the polarity of charge transfer, caused by the interaction. In this document, a surface is said to have positive charge transferability when the gas molecule positively charges the surface, and negative charge transferability when the gas molecule negatively charges the surface. For example, a surface with positive charge transferability is a surface which loses an electron to a gas molecule, either neutralizing the gas molecule or forming a molecule-electron unit. A surface with negative charge transferability is a surface which receives an electron from a neutral gas molecule or a molecule-electron unit. Charge transferability depends on both the surface and the gas participating in the charge transfer. Charge transferability may also depend on temperature, since temperature affects the kinetic energy of the gas molecules as well as many material properties such as energy gap, thermal expansion, conductivity, work function and the like. Quantitatively, charge transferability, denoted Θ, can be expressed in energy units. For example, a positive charge transferability can be defined as Θ=E^{S}ₘᵢₙ, where E^{S}ₘᵢₙ is the minimal energy required to remove an electron from the surface and to attach it to a neutral gas molecule, and a negative charge transferability can be defined as Θ=−E^{M}ₘᵢₙ, where E^{M}ₘᵢₙ is the minimal energy required to remove an electron from a neutral gas molecule and transfer it to the surface.

It is appreciated that when Θ is expressed in energy units as defined above, its value is, in some cases, not necessarily identical to the energy which is required for transferring the charge to a neutral molecule, since charge transfer can also occur when the molecules and/or surfaces are already charged. Thus, the energy required to remove an electron from the gas molecule and bind it to the surface can be higher or lower than E^{M}ₘᵢₙ, and the energy which is required to remove an electron from surface and attach it to the gas molecule can be higher or lower than E^{S}ₘᵢₙ, as will now be explained in more details.

When a gas molecule is positively charged, there is an attractive Coulombic force between the molecule and an electron. Thus, the work done in removing an electron from the surface and attaching it to the positively charged molecule can be lower than E^{S}ₘᵢₙ, since the molecule favors such attachments. On the other hand, the work done in removing an electron from the positively charged molecule and transferring it to the surface can be higher than E^{M}ₘᵢₙ, since positively charged molecules do not favor detachment of electrons therefrom.

The situation is reversed when a gas molecule is negatively charged. The work done in removing an electron from the negatively charged molecule and transferring it to the surface can be lower than E^{M}ₘᵢₙ, particularly in the case in which the electron is loosely attached to the molecule. This is because the binding energy of a loosely connected electron is lower than the binding energy of a valence electron of a neutral molecule. The work done in removing an electron from the surface and attaching it to a negatively charged molecule can be higher than E^{S}ₘᵢₙ, due to the repulsive Coulombic force between the electron and the molecule.

Both E^{S}ₘᵢₙ and E^{M}ₘᵢₙ depend on the nature of the solid surface as well as the gas medium. Thus, the charge transferability describing the interaction of a given solid surface with one gas medium is not necessarily the same as the charge transferability describing the interaction of the same solid surface with another gas medium.

For some solid surfaces, the charge transferability of the surface is correlated to the work function of the surface. However, these two quantities are not the same. Whereas the work function of the surface is defined as the minimal energy which is required for freeing an electron from the surface (generally to vacuum), the charge transferability is related to the energy required to remove electrical charge and attach it to a gas molecule, and thus it depends on the properties of the gas molecule as well as those of the surface.

It is noted that a solid material having a certain work function in vacuum may behave differently in the presence of a gas medium and may display distinct contact potential differences in various gaseous environments. Throughout this specification and in the Claims, the term charge transferability describes the behavior of a particular solid surface in the presence of a particular gas medium and not in vacuum.

In addition to the work function, the charge transferability of a surface also depends upon its dielectric constant and on the ability of the gas molecule to receive or lose charge. This ability of the gas molecule to receive or lose charges is affected by electron affinity, ionization potential, electronegativity and electropositivity of the gas medium, which thus also roughly correlate with charge transferability.

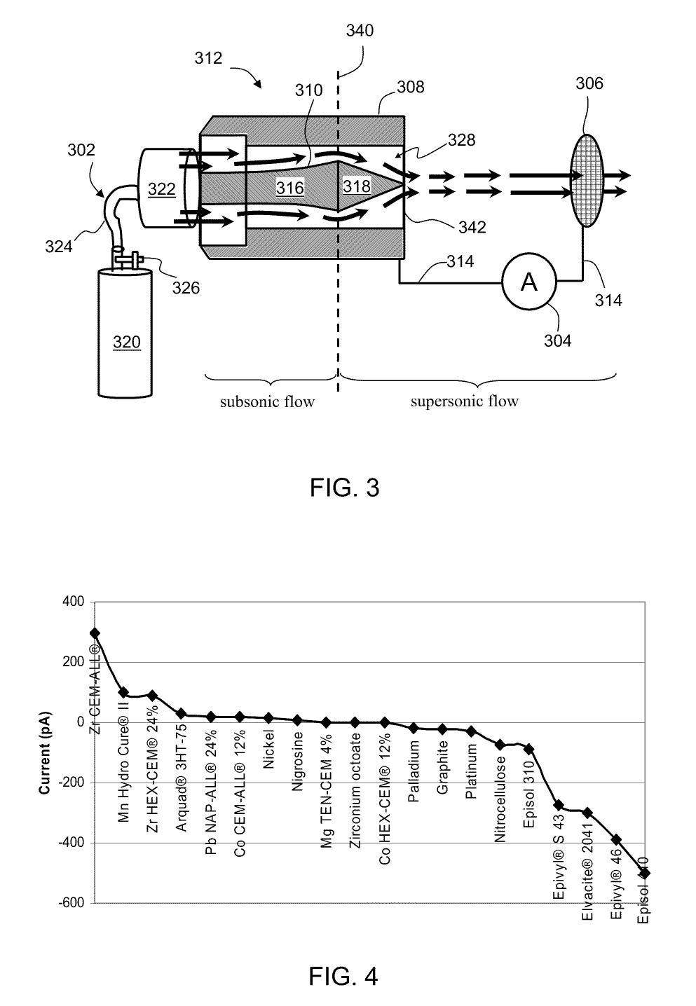

The present inventor discovered a technique for assessing the charge transferability of a test material. In this technique, a supersonic gas jet nozzle is used for generating a supersonic gas jet which is directed towards a conductive target mesh made of or coated with the test material. A current meter is connected between the target mesh and the jet nozzle. The direction and magnitude of electrical current flowing through the current meter is indicative of the sign and level of the charge transferability associated with the test material in the presence of the gas. Representative results of supersonic gas jet experiments performed by the present inventor are provided in Example 2 and FIG. 3 of the Examples section that follows.

In some embodiments of the invention, the charge transferability Θ is assessed by measuring a quantity referred to herein as Iₘₑₛₕ where Iₘₑₛₕ is the electrical current generated between a target mesh and a jet nozzle in response to an supersonic gas jet flowing through a mesh of predetermined density. Some exemplified measurements of Iₘₑₛₕ are described in the Examples section below (see Example 2).

In various embodiments of the invention, the charge transferability describing the interaction of surface 12 with the gas medium is positive. Typically, but not necessarily, the charge transferability describing the interaction of surface 14 with the gas medium is negative. It is appreciated that it is sufficient for the charge transferability of surface 12 to be positive, because when a molecule having a loosely attached electron collides with or is adsorbed by surface 14, it has a non-negligible probability of transferring the electron to surface 14 even when the charge transferability of surface 14 is not negative for neutral molecules.

An appropriate charge transferability for each surface can be achieved by a judicious selection of the gas medium and the materials from which surfaces 12 and 14 are made (which may be surface modifications of substrates 32 and 34). Substrates made of suitable materials can be used without any modification. Alternatively, once a substrate is selected, the respective surface can, according to some embodiments of the present invention, be modified or coated so as to enhance or reduce the charge transferability to a desired level. Surface modification can include alteration of the surface of the substrate, addition of material or materials to the surface of the substrate, removal of material or materials from the surface, or combination of these procedures. Surface modification can also include addition of material to the surface such that the underlying material of the substrate is still part of the surface and participates in the charge transfer process. Alteration of the surface of the substrate may include chemical reactions, including but not limited to oxidation or reduction. Addition of material or materials to the surface may include, without limitation, coating by one or more layers, adsorption of one or more layers of molecules or atoms and the like. Removal of material or materials from the surface includes, without limitation, lift off techniques, etching, and the like. Any of such surface modifications may be referred to herein as surface activation.

Surface modification can include coating. Coating of the substrate can be effected in more than one way. In some embodiments, the material which forms the respective surface directly coats the substrate. In some embodiments, one or more undercoats are provided, interposed between the substrate and the material which forms the respective surface.

Modification or coating of the substrate's surface may allow the use of the same material for both substrates 32 and 34, whereby the difference in characteristic charge transferability of surfaces 12 and 14 is effected using different surface treatment procedures. For example, both substrates 32 and 34 can be made of glass which is first coated with gold to form an undercoat for electrical conductivity. For surface 12 the gold undercoat can be further coated with cesium fluoride, CsF, or calcium carbonate, CaCO₃, and for surface 14 the gold undercoat can be further coated with magnesium chlorate, Mg(ClO₃)₂.

The substrates can also be coated by sputtering techniques known in the art of thin film coating. In this technique thin films are deposited by sputtering material from a target onto a substrate.

Representative examples of materials which can be used as substrates on which a coat can be sputtered include, without limitation, aluminum, stainless steel, metal foils, glass, float glass, plastic films, ceramics and semiconductors including silicon doped with various dopants (e.g., phosphorous and boron dopant) and at various crystallographic orientations (e.g., <100>, <110>, <111>), and any substrate previously coated on one or both sides including, but not limited to, aluminum-sputtered glass, aluminum sputtered float glass and chromium sputtered float glass. Representative examples of materials which can be used as target materials which can be sputtered onto a substrate to form a coat or undercoat thereon include, without limitation, Aluminum (Al), Aluminum nitride (AlN), Boron nitride (BN), Copper (Cu), Gold (Au), Lanthanum hexaboride (LaB₆), Nickel (Ni), Palladium (Pd), Platinum (Pt), Palladium-gold (Pd—Au), Hafnium (Hf), Manganese (Mn), Manganese dioxide (MnO₂), Tantalum (Ta), Tintanium (Ti), Chromium (Cr), Molybdenum (Mo), Gadolinium (Gd), Silica (SiO₂), Yttria (Y₂O₃), Titanium nitride (TiN), Tungsten (W), Hafnium carbide (HfC) Titanium carbide (TiC), Zirconium carbide (ZrC), Tungsten carbide (WC), Zirconium oxide (ZrO₂), Tungsten trioxide (WO₃), Indium tin oxide (ITO), Lanthanum oxide (La₂O₃), Barium titanate (BaTiO₃), Strontium oxide (SrO), Calcium fluoride (CaF₂), Yttrium calcium barium copper oxide (YCaBaCuO), calcium oxide (CaO), Chromium silicide (Cr₃Si), Alumina (Al₂O₃), Barium sulfide (BaS), Calcium sulfide (CaS), and combinations thereof.

In some embodiments of the present invention, substrates 32 and 34 are subjected to treatment for ensuring the difference in characteristic charge transferability of surfaces 12 and 14 in situ. For example, device 10 with substrates 32 and 34 can be filled with a liquid medium having therein electroactive species such as, but not limited to, salts and dyes. When the gap between substrates 32 and 34 is filled with the liquid medium, the size of the gaps can be considerably high, e.g., above 50 μm. The liquid medium may comprise a polar solvent or a non-polar solvent.

Substrates 32 and 34, and the liquid medium are subjected to an electric current, e.g., by connecting substrates 32 and 34 to an external power source, such as to commence an electrodeposition (ED) process. The electrodeposition can be electrochemical deposition (ECD), wherein the electroactive species are dissociated into ions within the solvent, or electrophoretic deposition (EPD) wherein the electroactive species are charged within the solvent.

It was found by the present inventor that the ED process can result in a modification of, or an overcoat on, at least one of the surfaces of substrates 32 and 34 such that there is a difference in their characteristic charge transferability. In electrochemical deposition, for example, either one of the surfaces is modified by, or coated with, ions present in the liquid medium, or both surfaces are concurrently modified or coated, one surface with anions and the other surface with cations. In electrophoretic deposition, dissolved or suspended species in the liquid medium can be electrophoretically deposited on one or both surfaces.

In any event, the liquid medium and materials of substrates 32 and 34 are selected such that, following the ED process, the resultant surfaces 12 and 14 each have different characteristic charge transferability.

Once one or both substrates 32 and 34 is modified or coated by the ED process, the liquid medium is preferably evacuated from device 10, either by drying in an oven, or by vacuum or by any other known drying method. In some embodiments of the invention, this evacuation or drying procedure shrinks the total volume (surfaces and liquid) such that, after evacuation, the distance between surfaces can be substantially smaller than before drying. For example, the gap can be reduced from 50 μm before evacuation by at least 50%, or at least 60%, or at least 70%, or at least 80%, or at least 90%, and can even be reduced to less than 5 μm. Much greater gap reduction ratios are also possible.

The above procedure thus serves as an activation process which ensures the difference in characteristic charge transferability between surfaces 12 and 14. The activation process can be executed whether substrates 32 and 34 are of the same material or whether each substrate is made of a different material. The above procedure can be performed for a single cell device or a plurality of cell devices as desired. For a plurality of cell devices, the procedure is preferably performed simultaneously for all the devices,

Further examples of surface treatment procedures suitable for the present embodiments are detailed in the Examples section below.

Each of surfaces 12 and 14 is preferably, but not necessarily, smooth. Surfaces that are not substantially smooth, but do not contact one another, are also contemplated. Preferably, surfaces 12 and 14 have a surface roughness which is less than or about 20 Å RMS roughness, more preferably less than or about 10 Å RMS roughness, more preferably less than or about 5 Å RMS roughness, as conventionally determined by image analysis of Atomic Force Microscopy (AFM) using standard procedures. Also contemplated are atomically flat surfaces. Further contemplated are surfaces having RMS roughness of several tens of nanometers (e.g., about 100 nanometers).

Suitable materials which can be used for surface 12 and/or surface 14, include magnetic or non-magnetic substances such as, but not limited to, metals, semi-metals, alloys, intrinsic or doped, inorganic or organic, semi-conductors, dielectric materials, intrinsic or doped polymers, conducting polymers, layered materials, ceramics, oxides, metal oxides, salts, crown ethers, organic molecules, quaternary ammonium compounds, cermets, glass and silicate compounds, and any combination thereof.

Representative examples include, without limitation, metals and semi metals (e.g., nickel, gold, cobalt, palladium, platinum, graphite, graphene, aluminum, chromium, gadolinium, molybdenum) and oxides thereof (e.g., graphite oxide (optionally reduced or partially reduced), silica, manganese dioxide, manganese nickel oxide, and tungsten trioxide), alloys (e.g., stainless steel), semi-conductors (e.g., boron or phosphorous doped silicon wafers), ceramics (e.g. glass ceramics such as MACOR®, aluminum nitride, and boron nitride), cermets (e.g., chromium silicide silica), glass and silicate compounds (e.g., glass and phlogopite mica), salts such as calcium salts (e.g., Calcium Petronate, Calcium naphtenate salts such as NAP-ALL®), rare earth salts (e.g., rare earth neodecanoate or versatate salts such as TEN-CEM®, rare earth octoate salts such as HEX-CEM® which are octoate salts prepared from 2-ethylhexanoic acid), zirconium salts (e.g., Zirconium carboxylate salts such as CEM-ALL®, Zirconium HEX-CEM®), manganese salts (e.g., Manganese HEX-CEM®, Manganese NAP-ALL®, Manganese Hydro Cure® and Hydro Cure® II), quaternary ammonium salts Arquad® (e.g., Arquad 3HT-75®), lead salts (e.g., Lead CEM-ALL®, Lead NAP-ALL®), cobalt salts (e.g., Cobalt TEN-CEM®, Cobalt NAP-ALL®, Cobalt CEM-ALL®), zinc salts (e.g., Zinc NAP-ALL®, Zinc CEM-ALL®, Zinc HEX-CEM®, Zinc Stearate), nigrosine, sodium petronate, polyethylene imine, gum malaga, OLOA 1200, lecithin, polymers such as nitrocellulose, nitrocellulose based polymers, optionally doped, (e.g. Zaponlack), polyvinyl chloride based polymers (e.g., Episol® 310, Episol® 410, Episol® 440, Epivyl® 32, Epivyl® 40, Epivyl® 43, Epivyl® S 43, Epivyl® 46) and acrylic resins (e.g., Elvacite® 2041) and any combination thereof.

Certain of the above materials are also suitable for substrates 32 and/or 34 to the extent that they are able to form self supporting structures.

Certain marks referenced herein may be common law or registered trademarks of third parties. Use of these marks is by way of example and shall not be construed as descriptive or limit the scope of this invention to material associated only with such marks.

Suitable materials which can be used as gas medium 16 include, without limitation, halogen and halogen containing gases e.g., At₂, Br₂, Cl₂, F₂, I₂, WF₆, PF₅, SeF₆, TeF₆, CF₄, AsF₅, BF₃, CH₃F, C₅F₈, C₄F₈, C₃F₈, C₃F₆O, C₃F₆, GeF₄, C₂F₆, CF₃COCl, C₂HF₅, SiF₄, H₂FC—CF₃, CHF₃, and CHF₃; inert gases, e.g., Ar, He, Kr, Ne, Rn, and Xe; nitrogen containing gases e.g., N₂, NF₃, NH₃, NO, NO₂, and N₂O; sulfur containing gases, e.g., SF₆, SF₄, SO₂F₂; oxygen comprising gases, e.g., O₂, CO, and CO₂; hydrogen containing gases, e.g., H₂, deuterium, i-C₄H₁₀, and CH₄; alkaline gases e.g., Cs, Li, Na, K, Cr, Rb, and Yb; and combinations thereof. In various exemplary embodiments of the invention the gas medium is chemically inert with respect to the surfaces of the cell or device.

Surfaces 12 and 14 can be paired according to their charge transferability in the presence of the gas medium as further detailed hereinabove. Preferably, surface 12 has positive charge transferability and in some embodiments, surface 14 has a negative charge transferability.

In some embodiments of the present invention, surface 12 can be made of a material selected from material Nos. 1-19 and surface 14 can be made of a material selected from material Nos. 23-46 as listed in Table 1 of the Examples section (see Example 2). However, this need not necessarily be the case, since, in some embodiments, both surfaces 12 and 14 can be selected from material Nos. 1-19, and in other embodiments, both surfaces 12 and 14 can be selected from material Nos. 23-46. Also contemplated are embodiments in which one or both surfaces 12 and 14 is made of a material selected from the materials listed in Table 6 of Example 8.

As a few non-limiting pairing examples, when the gas medium is sulfur hexafluoride (SF₆) one surface can be made of Zirconium CEM-ALL®, and another surface can be made of one of the following materials: Manganese Hydro Cure® II, Zirconium HEX-CEM®, Arquad® 3HT-75, Lead NAP-ALL®, Rare Earth HEX-CEM®, Cobalt CEM-ALL®, Nickel, Calcium NAP-ALL®, Manganese NAP-ALL®, Graphite Oxide, Cobalt NAP-ALL®, Rare Earth TEN-CEM, Nigrosine, Lead CEM-ALL®, Manganese HEX-CEM®, Zinc NAP-ALL®, Cobalt TEN-CEM®, Ca Petronate, OLOA 1200, Zinc HEX-CEM®, Lecithin, Manganese Hydro Cure®, Gold, Cobalt, Zinc stearate, Na Petronate, Palladium, Epivyl® 32, Zinc CEM-ALL®, Graphite, Platinum, polyethylene imine (PEI), Epivyl® 40, Gum Malaga, Nitrocellulose, Episol 310, Episol 440, Epivyl® S 43, Elvacite® 2041, Epivyl® 46, Epivyl® 43, and Episol 410. Additional non-limiting pairing examples and suitable gas media are provided in Table 6 of Example 8.

Since the desired charge transferability can be achieved by surface modification techniques, substrates 32 and 34 can be made of any material provided that it can conduct an adequate electrical current, at least in the thickness direction. In some embodiments of the present invention one or both substrates is made of a material having high bulk conductivity, such as a metal. However, this need not necessarily be the case since the electrical conductance of a material is affected by its geometry and orientation. Certain materials which may be considered to have poor bulk conductivity, can conduct current adequately in one of their crystalline axes. Certain layered materials, for example, may have poor bulk conductivity, but may have adequate conductivity through a thin layer of the material, whether comprising a single atomic monolayer or more.

By way of further example, glass and MACOR® are considered poor conductors since their typical conductivities at room temperature (10⁻¹⁵ S/m and 10⁻¹² S/m, respectively) are considerably lower than the typical conductivity of metals (of the order of 10⁶ S/m). Nevertheless, a sufficiently thin layer of such materials can conduct significant electrical current, adequate for certain low power applications. Consider a construction in which one of the substrates of device 10 is a glass plate, 50 mm in diameter and 100 μm in thickness. Suppose that the gas mediated charge transfer generates a voltage of 1 V across the thickness of the glass. Such voltage can generate a measurable current of several pA through the glass plate. Thus, for certain low current applications, substrates 32 and 34 can also be made of materials having relatively poor conductivity.

Representative examples of materials suitable for substrates 32 and 34 include, without limitation, metals, such as, but not limited to, aluminum, cadmium, chromium, copper, gadolinium, gold, iron, lead, magnesium, manganese, molybdenum, nickel, palladium, platinum, silver, tantalum, tin, titanium, tungsten, and zinc; semi-metals, including but not limited to antimony, arsenic, and bismuth; alloys, including but not limited to brass, bronze, duralumin, invar, and steel; intrinsic and doped, inorganic and organic, semi-conductors and semi-conductor hetero-structures, including but not limited to silicon wafers, germanium, silicon, aluminum gallium arsenide, cadmium selenide, gallium manganese arsenide, zinc telluride, indium phosphide, gallium arsenide and polyacetylene; lamellar materials including but not limited to graphite, graphene, graphite oxide, tungsten disulfide, molybdenum disulfide, tin disulfide, and hexagonal boron nitride; intrinsic or doped oxides including but not limited to silica, tungsten trioxide, manganese dioxide, manganese nickel oxide, tin-doped indium oxide (ITO); intrinsic or doped ceramics, including but not limited to boron nitride, aluminum nitride, and glass ceramics such as MACOR®; cermets, including but not limited to chromium silicide silica; glass and silicate compounds, including but not limited to glass and phlogopite mica; or combinations thereof. Also contemplated are substrates of any materials which are coated with any of the above materials.

Materials suitable for substrates and coatings can be magnetic (e.g., Co, Fe, Gd, Ni, GaMnAs and the like) and non-magnetic (e.g., Al, Cu and the like).

In any of the above embodiments of the invention, the substrate must provide adequate electrical conductivity (e.g., for allowing the current to flow through the load) as further detailed hereinabove. Adequate electrical conductivity can be established using either a substrate having high bulk conductivity (e.g., above 10³ S/m) or a substrate having poor bulk conductivity (e.g., below 10⁻⁹ S/m) or a substrate having midrange bulk conductivity (e.g., between 10⁻⁹ to 10³ S/m), provided that the substrate has sufficient conductance in the thickness direction (i.e. in the direction of the current flow).

Surfaces 12 and 14 can be bare substrates (32 and 34), surface-modified substrates or coated substrates. A typical thickness of bare substrates 32 and 34 is from about 1 nm to about 100 μm. In some embodiments of the invention the thickness of the bare substrate can be between 1-20 nm. In some embodiments the thickness can be as low as a single atomic monolayer (0.34 nm in the case of graphene). In the case of certain surface-modified substrates, (such as electrochemically modified, oxidized or reduced surfaces) the typical thickness of surfaces 12 and 14 can be below 1 nm. However, in the case of coated surfaces, the typical thickness of surfaces 12 and 14 is from about 1 nm to about 600 nm, but other thicknesses are not excluded from the scope of the present invention. In the case of any intermediate layer or binder layer (if present) between substrate 32 and surface 12 or between substrate 34 and surface 14 a typical thickness is from under 1 nm to about 250 nm.

In various exemplary embodiments of the invention, device 10 further comprises a sealed enclosure 36 for maintaining gas pressure and preventing leakage or contamination of the gas medium. Pressure within enclosure 36 can be different (either above or below) from the ambient pressure. The pressure within encapsulation 36 can be selected so as to achieve a desired mean free path and/or a desired thermal conductivity (the higher the pressure, the higher the thermal conductivity). As explained in Equation 1 in the Examples section that follows, the mean free path is inversely proportional to the pressure. Thus, by reducing the pressure within encapsulation 36, the mean free path can be increased. By increasing the pressure, the number of carrier molecules is increased, as is the thermal conductivity. An optimum pressure balances these effects to produce a maximum current. In various exemplary embodiments of the invention the pressure within encapsulation 36 is lower than 10 atmospheres, though higher pressures are also contemplated, particularly for close-spaced gaps. In fact, for gaps in the nanometer range, especially when using gases of small molecular diameter (such as helium), high efficiencies can be achieved at gas pressures of hundreds of atmospheres. In general, for such small gaps, the upper pressure limit will be set by either pressure containment considerations or by the liquefaction pressure of the gas at operating temperatures. Preferable gas pressures are in excess of one atmosphere. Typically, the gas pressure is higher than 1.1 atmospheres or higher than 2 atmospheres or higher than 3 atmospheres or higher than 4 atmospheres or higher than 5 atmospheres.

Reference is now made to FIGS. 2A and 2B which are schematic illustrations of a power source device 40, according to various exemplary embodiments of the present invention. Device 40 comprises a plurality of cells 10 each having a pair of surfaces 12 and 14 described above and a gas medium (not shown, see FIGS. 1A and 1B for illustration) between the surfaces. Via the gas mediated charge transfer effect, molecules of the gas medium transport negative charge from surface 12 to surface 14 and/or positive charge from surface 14 to surface 12, as further detailed hereinabove.

Cells 10 are interconnected thereamongst so as to allow current to flow between adjacent serially connected cells. In the illustration shown in FIGS. 2A and 2B, device 40 is arranged as a plurality of dual members 44, each being formed of a core 42 having two opposite surfaces 12 and 14, where one of the surfaces transfers negative charge to at least some of the gas molecules and the surface of the opposite side receives negative charge from at least some of the charged gas molecules. Dual members 44 are oriented such that surfaces having different charge transferability are facing one another. In the illustration shown in FIG. 2A, dual members 44 are separated by spacers 28, and the two surfaces of each dual member are in electrical communication via substrate 42. In the illustration shown in FIG. 2B, the gaps between dual members 44 are maintained by means of the outwardly protruding roughness features 50 of oppositely facing surfaces. Also contemplated are embodiments in which some dual members are separated by spacers as illustrated in FIG. 2A and some dual members are separated by outwardly protruding roughness features as illustrated in FIG. 2B. If at least one of the facing surfaces is made of a poorly-conducting material and the contact areas are small, the “leakage” caused by the contact is minimized.

The dual member configuration exemplifies an arrangement of several cells similar to cell 10. Two adjacent and interconnected cells share a core, whereby the surface 12 on one side of core 42 serves, e.g., as an electron donor of one cell while the surface 14 on the other side of core 42 serves, e.g., as an electron receiver of another cell. Heat exchange between the gas medium and heat reservoir 20 maintains the thermal motion of the gas molecules which transport charge between the surfaces of each cell. Said heat exchange may be effected directly between the gas and reservoir 20 and/or via the thermal conductivity of substrates 42. The electrical interconnectivity between the two cells can be effected by making the bulk of core layer 42 electrically conductive and/or by coating layer 42 by an electrically conductive material, which provides conductivity via the edges of substrate 42.

The arrangement of dual members can be placed between a first conductive member 46 and a second conductive member 48. The inner surfaces of the conductive members 46 and 48 can also serve as an electron donor surface and an electron receiver surface, respectively. Thus, electrons are transported from member 46 through dual members 44 to conductive member 48 thereby generating a potential difference between members 46 and 48, optionally in the absence of any external voltage source. Members 46 and 48 can be connected to external load 24.

Note that from an electrical point of view, such cells are arranged in series and/or in parallel, with the series arrangement providing an increased voltage output as compared to a single cell and the parallel arrangement providing an increased current. The total voltage of the device is the sum of voltages along the series direction, and the total current is determined by the transport area in the transverse direction.

In preferred embodiments of the invention, device 40 further comprises a sealed chamber for preventing leakage or contamination of the gas medium and for allowing control of pressure within the chamber, as defined above.

As used herein the term “about” refers to ±20%.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

### EXAMPLES

Reference is now made to the following examples, which together with the above descriptions illustrate some embodiments of the invention in a non limiting fashion.

### Example 1

### Theoretical Considerations

It is established from the kinetic theory of gases that gas molecules move in random directions at various velocities within a range which is defined by the temperature dependent Maxwell-Boltzmann distribution function, which can be derived using methods of statistical mechanics. The Maxwell-Boltzmann distribution function describes the velocity distribution in a collision-dominated system consisting of a large number of non-interacting particles in which quantum effects are negligible.

Gas molecules collide with each other and also with the container in which they are confined. For a gas molecule of diameter σ, the mean free path λ at a certain pressure P and absolute temperature T (° K) is given by

$$λ = \frac{RT}{\sqrt{2} {πσ}^{2} NP} , \qquad ( EQ . 1 )$$

where R is the universal gas constant (R=0.082 atm·liter·mol⁻¹.° K⁻¹) and N is Avogadro number. Thus, for a given pressure and temperature, the mean free path of the gas molecules depends upon the diameter of the gas molecules, wherein smaller molecules have a larger mean free path compared to larger molecules.

The diameter σ (in Angstroms) and corresponding mean free path λ (in nanometers) as calculated using Equation 1 for a few representative gases at a pressure P of 5 atmospheres and a temperature of 25° C. are:

Argon (σ=4.0 Å, λ=11.2 nm), CF₄ (σ=4.2 Å, λ=10.3 nm), C₃F₈ (σ=4.8 Å, λ=7.9 nm), CH₄ (σ=4.4 Å, λ=9.6 nm), Helium (σ=2.4 Å, λ=31.5 nm), Krypton (σ=4.6 Å, λ=8.6 nm), Neon (σ=2.9 Å, λ=22.2 nm), N₂ (σ=3.8 Å, λ=13.0 nm), SF₆ (σ=5.5 Å, λ=6.0 nm) and Xenon (σ=5.4 Å, λ=6.2 nm). These calculations indicate that mean free path values of common gases, under the indicated conditions, are generally in the nanometric range of distances. For higher temperatures (above 25° C.) and/or lower pressures (below 5 atmospheres) the mean free paths of these molecules are longer.

When gas molecules are placed between surfaces separated by a distance d<λ, the predominant interactions are between the molecules and the surfaces, and only a small fraction of interactions are intermolecular collisions. Thus, for d<λ most molecules move back and forth between surfaces. The number of molecules interacting with the surfaces per unit time is linearly dependent upon pressure. Upon interacting with a suitable surface, the molecules can lose or gain an electron thus acquiring a positive or negative electrical charge. In the vicinity of a surface, various forces may act on charged gas molecules. Charged gas molecules induce an image charge of opposite polarity in the surface, which in turn creates an attractive force between the charged molecule and the surface. Charged gas molecules of sufficiently high velocity can overcome the attractive force of the image charge to escape the first surface and cross the gap to reach the other surface.

When gas molecules are placed between surfaces separated by a distance d>λ, intermolecular collisions become more frequent and the probability η of a gas molecule of crossing the gap between the surface can be written as

$$η = \frac{λ}{d} , \qquad ( EQ . 2 ) .$$

Hence, as a result of the dependence between λ and P described in Equation 1, the probability of a molecule crossing the gap decreases with increasing pressure.

The average speed of a gas molecule can be written as

$$\overline{v} = \sqrt{\frac{8 RT}{π M}} , \qquad ( EQ . 3 )$$

where T is the temperature and M is the molecular weight of the gas. The average speeds (in meters/second) at a temperature of 25° C. for a number of representative gases as calculated from Equation 3 are:

Argon (398 m/s), CF₄ (268 m/s), C₃F₈ (183 m/s), CH₄ (627 m/s), Helium (1,256 m/s), Krypton (274 m/s), Neon (559 m/s), N₂ (474 m/s), SF₆ (208 m/s) and Xenon (219 m/s). Some of these average speeds exceed the speed of sound (about 346 m/s in air at 25° C., also defined as Mach 1).

For a charged molecule to successfully cross the potential barrier Vₘₐₓ generated by the image charge and reach the other surface, its kinetic energy must be higher than Vₘₐₓ. This implies that a molecule can cross the potential barrier if its speed is above vₘᵢₙ, where vₘᵢₙ is given by:

$${v}_{min} = \sqrt{\frac{2 {V}_{max}}{m}} , \qquad ( EQ . 4 )$$

and where m is the molecule's mass. Gas molecules having velocities above this value are expected to be able to transport charge between the surfaces.

The fraction x of molecules capable of escaping a surface by overcoming the potential barrier Vₘₐₓ can be calculated according to the following equation, which is based on Maxwell-Boltzmann distribution:

$$x = 1 - {\int }_{0}^{{v}_{min}} 4 {π ( \frac{M}{2 π RT} )}^{\frac{3}{2}} {e}^{- \frac{1}{2} {Mv}^{2} / RT} {v}^{2} d v . \qquad ( EQ . 5 )$$

vₘᵢₙ can be calculated from Vₘₐₓ according to Equation 4 above. The calculated value of the fraction x of sufficiently fast molecules reflects an ideal situation of 100% charge transfer efficiency. In practice, it is expected that a significantly lower fraction of molecules will participate in the charge transfer process. For example, for molecules moving in a direction which is not perpendicular to the surface, the required escape speed is higher than for molecules moving perpendicularly to the surface.

As a numerical example, consider two surfaces 12 and 14 which are made of ideal metals having a difference in work function of 0.5 eV. Suppose that charge transfer of one electron per gas molecule occurs at a distance of 5 Å from the surface and that the gap between the surfaces is filled with SF₆ gas (M=146 gram/Mol, diameter σ≈5.5 Å).

For a gap size d of 2 nm, the potential barrier Vₘₐₓ is estimated to be 0.39 eV, the image charge potential alone contributing 0.25 eV. The value of vₘᵢₙ as calculated using Equation 3 is vₘᵢₙ=710 m/s (about 2.1 Mach), which is about 3 times the average velocity ( v̅=208 m/sec) of SF₆ molecules at a temperature of 25° C., and the value of x as calculated using Equation 4 is 1.6×10⁻⁴%. Note that although the percentage is low, the number of molecules colliding (with or without adsorption) with surfaces 12, 14 is large (e.g., of the order of 10²¹ collisions/second per μm² for SF₆ at 1 Atm and 25° C.). Thus, approximately 10¹⁵ molecules/second can potentially escape one of the surfaces by overcoming the potential barrier and participate in the charge transfer process, for this example.

For a gap size of 10 nm (and the same surfaces and gas), the value of the potential barrier Vₘₐₓ is 0.92 eV, the image charge barrier contributing 0.62 eV, and the value of vₘᵢₙ is 1084 m/s (about 3.1 Mach) which is about 5 times the average velocity at 25° C., and the value of x is 2.5×10⁻¹¹%.

The dependence of the image charge barrier on the size of the gap was calculated for a molecule carrying one electron between two identical surfaces and is shown in FIG. 1C for a gap of 2 nm and in FIG. 1D for a gap of 10 nm. The dependence of the potential barrier, which comprises the image charge potential barrier, was calculated for a case in which the work function of surface 12 is lower by 0.5 eV than the work function of surface 14 and is shown in FIGS. 1E (2 nm gap) and 1F (10 nm gap). As shown, when the surfaces are not identical, the point of local maximum 64 is shifted toward the surface of higher work function. The value of the potential barrier Vₘₐₓ when surfaces are different is higher than the value of Vₘₐₓ when the surfaces are the same, in which case Vₘₐₓ corresponds to the image charge potential barrier alone.

FIG. 1G shows the expected potential barrier Vₘₐₓ (V) as a function of the size of the gap d (nm) for gaps of up to 100 nm, under the same illustrative conditions of molecules carrying one electron between surfaces having a difference in work function of 0.5 eV.

As Vₘₐₓ affects the number of molecules that can participate in the charge transfer (hence the probability of effective charge transfer between the surfaces), the resulting current also depends upon the gap size. For example, for molecules of SF₆ carrying one electron from surface 12 to surface 14 under the conditions of the above numerical example, the generated current per surface area (A/cm²) as a function of gap size (nm) behaves, ideally, as illustrated in FIG. 1H. It is noted that FIG. 1H corresponds to a perfect situation where each gas molecule having interacted with surface 12 receives an electron from it and each sufficiently fast charged molecule successfully crosses the gap and transfers an electron to surface 14. Moreover, the above calculation was made under the assumption that surfaces 12 and 14 are essentially flat, parallel and overlapping, such that the gap size is the same across the surfaces. In practice, lower current per area values are expected. Nevertheless, the non-linear dependence of the current upon gap size is expected to be similar. As demonstrated in some of the examples hereunder, the generated current increases with decreasing gap size.

Thus, the smaller the gap the lower the minimum velocity needed to overcome the potential barrier and the higher the portion of charged gas molecules which successfully traverse the gap. Similarly, smaller gaps enable the employment of higher gas pressures, i.e., with shorter mean free paths and higher thermal conductivity. Too high pressure levels may reduce the efficiency of gas mediated charge transfer between the surfaces, since higher pressure correspond to higher probability for intermolecular collisions. However, higher gas pressure also increases the number of molecules which may interact with the surfaces and which may efficiently transfer charge. There is therefore a balance between the rate of intermolecular collisions, the number of molecules serving as charge carriers and the width of the gap. As demonstrated in some of the examples hereinunder, there is a threshold pressure at which the gas mediated charge transfer reaches its maximal efficiency. Above the threshold pressure, the current can remain at a plateau value if the opposing effects of higher pressure (increased intermolecular collision vs. increased number of molecules interacting with surfaces) counterbalance one another. In a less than ideal balance situation, above the threshold pressure point, the current can decrease with increasing pressure.

### Example 2

### Charge Transferability Measurements by Supersonic Gas Flow

The present example describes experiments performed in accordance with some embodiments of the present invention to measure the charge transferability of surfaces in the presence of a gas medium. The charge transferability in this example is expressed in terms of the electrical current generated between a target mesh and a jet nozzle in response to a supersonic gas jet flowing through the mesh.

### Methods

FIG. 3 is a schematic illustration of the experimental setup for the measurements.

The setup included a gas supply unit 302 filled with gas, a target wire mesh 306, a jet nozzle 312 and a current meter 304 which was connected between mesh 306 and nozzle 312 via a pair of connection lines 314.

Gas supply unit 302 included a chamber 320 and an outlet 322 connected via a conduit 324. Chamber 320 was filled with a gas medium and was equipped with a valve 326 to control gas flow from chamber 320 to outlet 322 through conduit 324.

Nozzle 312 is based on NASA design KSC-11883 (NASA Tech Briefs, KSC-11883). A flow directing insert 310 was centrally positioned along a symmetry axis of a precision bored cylindrical section 308. Insert 310 was shaped as a mandrel having a first part 316 of gradually increasing diameter and a second part 318 of gradually decreasing diameter. Gas medium from outlet 322 of supply unit 302 was allowed to flow externally to insert 310 in a volume 328 formed between the inner walls of cylindrical section 308 and insert 310. While flowing externally to first part 316 of insert 310, the gas experienced narrowing of volume 328 due to the gradually increasing diameter of first part 316, and while flowing externally to second part 318 of insert 310, the gas experienced widening of volume 328 due to the gradually decreasing diameter of second part 318. For illustrative purposes, several flow trajectories of gas are indicated by thick arrows in FIG. 3.

The narrowing of volume 328 caused the gas to compress and accelerate, reaching sonic velocity at the plane of maximum diameter of insert 310. This plane (perpendicular to the plane of FIG. 3) is indicated by a dash line 340. After that plane, the flow was allowed to expand and accelerate further achieving supersonic speed at the supersonic outlet 342 of nozzle 312.

Mesh 306 was a 20 millimeter disc, using type 20 or 40 mesh wire screen, where the wires of stainless steel are separated by 750 or 450 μm, respectively. The wires were coated with the materials of interest. Coating was achieved by dipping the mesh for fifteen minutes in a solution or a suspension comprising the material of interest. Suspensions were prepared in water or volatile organic solvents such as acetone, butyl acetate, ethanol, and hexane, at a concentration of material of interest sufficient for achieving homogeneous coating of the mesh, while avoiding clogging of the open space by superfluous material. Typically, suspensions comprising 0.05-30% w/w of materials were used. After the dipping, excess material was removed from the mesh by capillarity, and the wires were dried at 110° C. for 48 hours.

The coated mesh was positioned opposite to supersonic outlet 342 such that the gas medium passed through the mesh as supersonic velocity.

Current meter 304 was a picoammeter (Model 617; Keithley). Electrical current (magnitude and direction) through the current meter was indicative of charge transfer between the gas molecules and the coating material. Current measurements were taken for periods of at least 2 seconds, with the peak current recorded for each material of interest.

All the experiments were performed without application of heat to the target or external electric field. This is unlike hyperthermal surface ionization techniques (see, e.g., Danon A. and Amirav A., “Hyperthermal surface ionization: a novel ion source with analytical applications”, International Journal of Mass Spectrometry and Ion Processes 96 (1990) 139-167).

The reason for using a supersonic gas jet streaming through a fine wire mesh screen rather than impinging upon a planar target is that the latter conditions create a substantial boundary layer which prevents the gas stream from stripping away the surface charges. In contrast, a supersonic jet streaming past the fine wires of the mesh enables a significant number of gas molecules to impinge upon the wire surfaces and then be vacated, together with their charges, by the shearing gas stream.

### Results

Table 1 summarizes the peak currents measured through the picoammeter for a gas medium of sulfur-hexafluoride (SF₆; BOC Gases; 99.999% pure) and 46 different materials of interest. The motivation for using SF₆ in the present experiment was that it is a non-toxic gas and known to be capable of low energy electron attachment (as described by L. G. Gerchikov and G. F. Gribakin in “Electron attachment to SF₆ and lifetimes of SF₆⁻ negative ions” Phys. Rev. A 77 (2008) 042724 1-15)

Some of the results are also indicated on the graph of FIG. 4.

TABLE 1

| Experiment | Mesh | | Peak Current |
|---|---|---|---|
| No. | Type | Tested Material | (pA) |
| 1 | 20 | Zirconium CEM-ALL ® 24% | 296 |
| 2 | 40 | Manganese Hydro Cure ® II | 100 |
| 3 | 40 | Zirconium HEX-CEM ® 24% | 90 |
| 4 | 40 | Arquad ® 3HT-75 | 28 |
| 5 | 40 | Lead NAP-ALL ® 24% | 20 |
| 6 | 40 | Rare Earth HEX-CEM ® 12% | 20 |
| 7 | 40 | Cobalt CEM-ALL ® 12% | 18 |
| 8 | 20 | Nickel | 13 |
| 9 | 40 | Calcium NAP-ALL ® 4% | 10 |
| 10 | 40 | Manganese NAP-ALL ® 6% | 10 |
| 11 | 20 | Graphite Oxide | 9 |
| 12 | 40 | Cobalt NAP-ALL ® 6% | 9 |
| 13 | 40 | Rare Earth TEN-CEM ® 6% | 8 |
| 14 | 20 | Nigrosine | 6 |
| 15 | 40 | Lead CEM-ALL ® 30% | 6 |
| 16 | 40 | Manganese HEX-CEM ® 6% | 6 |
| 17 | 40 | Zinc NAP-ALL ® 10% | 5 |
| 18 | 40 | Cobalt TEN-CEM ® 12% | 3 |
| 19 | 20 | Ca Petronate | 3 |
| 20 | 40 | Magnesium TEN-CEM 4% | 1 |
| 21 | 40 | Zirconium octoate | −1 |
| 22 | 40 | Cobalt HEX-CEM ® 12% | −1 |
| 23 | 20 | OLOA 1200 | −3 |
| 24 | 40 | Zinc HEX-CEM ® 18% | −5 |
| 25 | 20 | Lecithin 10% | −5 |
| 26 | 40 | Manganese Hydro Cure ® | −10 |
| 27 | 20 | Gold | −10 |
| 28 | 20 | Cobalt | −11 |
| 29 | 40 | Zinc stearate | −13 |
| 30 | 20 | Na Petronate | −18 |
| 31 | 20 | Palladium | −19 |
| 32 | 20 | Epivyl ® 32 | −20 |
| 33 | 40 | Zinc CEM-ALL ® 16% | −20 |
| 34 | 20 | Graphite | −21 |
| 35 | 20 | Platinum | −28 |
| 36 | 20 | PEI | −30 |
| 37 | 20 | Epivyl ® 40 | −44 |
| 38 | 20 | Gum malaga | −71 |
| 39 | 20 | Nitrocellulose | −73 |
| 40 | 20 | Episol 310 | −90 |
| 41 | 20 | Episol 440 | −100 |
| 42 | 20 | Epivyl ® S 43 | −273 |
| 43 | 20 | Elvacite ® 2041 | −300 |
| 44 | 20 | Epivyl ® 46 | −390 |
| 45 | 20 | Epivyl ® 43 | −500 |
| 46 | 20 | Episol 410 | −500 |

Table 1 demonstrates a significant positive current in Experiment Nos. 1-19, a significant negative current in Experiment Nos. 23-46, and non-significant current in Experiment Nos. 20-22. Thus, the materials in Experiments 1-19 were positively charged and therefore have positive charge transferability in the presence of SF₆ gas medium; and the materials in Experiments 23-46 were negatively charged and therefore have negative charge transferability in the presence of SF₆ gas medium. The charge transferability of the materials in Experiments 20-22 in the presence of SF₆ gas medium is low or consistent with zero.

Some small variations (within ±20%) were found using this experimental setup, which were thought to be due to such factors as variations in ambient air conditions, humidity, residual gas condensation and/or gas-surface chemical interactions. Notwithstanding these inconsistencies however, the general trend of charge transferability correlated reasonably well with the work function and/or triboelectric characteristics of the tested materials.

### Discussion

The results obtained in this set of experiments provide information about the charge transfer between solid materials and gas molecules. The gas molecules acquire charge (positive or negative) from the coated mesh leaving it oppositely charged. The high velocities of at least some of the gas molecules shearing across the surfaces of the fine wire mesh allow them to overcome the image charge potentials that are manifested as attractive forces between the surface and the gas molecules.

This experiment has shown that energetic gas molecules can transfer charge to and from certain surfaces. Since according to the Maxwell-Boltzmann distribution there is a non-zero probability of some molecules being sufficiently energetic for such charge transfer, charge transfer will occur, even in the absence of external acceleration of the molecules.

The present example demonstrated that thermal motion is sufficient for allowing the charged molecules to transport charge away from an oppositely charged surface, making the thermal motion of gas molecules a suitable mechanism for transferring charge between two surfaces. The present example also demonstrated that the charge transferability as defined according to some embodiments of the present invention is a measurable quantity.

### Example 3

### Measurements by Kelvin Probe

The present example describes experiments performed in accordance with some embodiments of the present invention to assess the charge transferability of surfaces by means of a Kelvin probe.

A Kelvin probe is a device that measures the contact potential difference (CPD) between a probe surface and a surface of interest. The contact potential difference is correlated to the difference in work functions of the reference and tested surfaces. This measurement is made by vibrating the probe in close proximity to the surface of interest. The difference in work function between the Kelvin probe surface and the testing surface results in an electric field. The work function of the surface of a conductor is defined as the minimum amount of work required to move an electron from the interior of the conductor to a point beyond the image charge region.

Hence a Kelvin probe can also be used at least to assess the charge transferability since it can be used to measure the energy required to remove electrical charge from the surface of interest and attach it to a gas molecule. In particular, a Kelvin probe was used in the present example to compare between the behavior of various surfaces in vacuum and in the presence of various gas media, and thus provide an indication of the suitability of various surface-gas pairs for charge transferability.

### Methods

A Kelvin probe (Kelvin Control 07, Besocke Delta Phi), was placed in a sealable chamber in which the gas environment was controlled. Measurements were done either in vacuum, in ambient air or in the presence of various gases at various pressures. All measurements were conducted at room temperature.

The solid materials to be tested, together with reference solid materials, were placed on a rotating table and were therefore probed at numerous points on their surfaces so that the measurements related to a scanned segment of each sample, rather than just a single spot. This method avoided single point measurement that could reflect local anomalies and not the overall values representing the material property. The Kelvin probe was calibrated using sample materials of known work function, such as gold.

Samples of polyethylene imine, 80% ethoxylated (PEI; Sigma Aldrich; 37% w/w in water); cesium carbonate (Cs₂CO₃; Alfa Aesar; 99%); cesium fluoride (CsF; Sigma Aldrich; 99%) and magnesium (Mg) were placed on the rotating disc and tested in vacuum, air, nitrogen trifluoride (NF₃; BOC Gases; 99.999% pure), xenon (Xe; BOC Gases; 99.999% pure), argon (Ar), acetylene (C₂H₂), carbon dioxide (CO₂), krypton (Kr), nitrogen (N₂), oxygen (O₂) and sulfur hexafluoride (SF₆; BOC Gases; 99.999% pure).

### Results

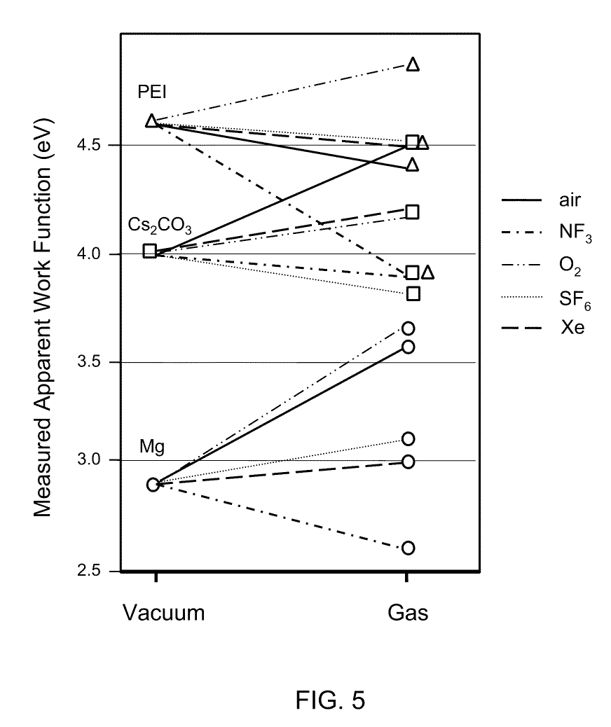

Table 2 summarizes the contact potential differences in eV, as assessed by a Kelvin probe at room temperature and one atmosphere (except for the NF₃ gas tested at 4 Atm). The results for some of the gas media (air, NF₃, Xe, O₂ and SF₆) are presented in FIG. 5.

TABLE 2

| | Medium | | | | | | | | | | |
|---|---|---|---|---|---|---|---|---|---|---|---|
| Material | Vacuum | Air | Ar | C₂H₂ | CO₂ | Kr | N₂ | NF₃ | O₂ | SF₆ | Xe |
| Cesium | 4.00 | 4.50 | 3.95 | 3.85 | 4.15 | 4.00 | 3.75 | 3.70 | 4.20 | 3.80 | 4.20 |
| Carbonate | | | | | | | | | | | |
| (Cs₂CO₃) | | | | | | | | | | | |
| Cesium | 4.00 | 4.40 | 4.05 | 4.13 | 4.10 | 4.17 | 4.15 | 3.90 | 4.06 | 4.20 | 4.30 |
| Fluoride | | | | | | | | | | | |
| (CsF) | | | | | | | | | | | |
| Magnesium (Mg) | 2.90 | 3.60 | 2.90 | 2.90 | 2.85 | 2.95 | 2.90 | 2.60 | 3.70 | 3.05 | 3.00 |
| Polyethylene- | 4.60 | 4.40 | 4.47 | 4.54 | 4.53 | 4.50 | 4.55 | 3.90 | 4.84 | 4.52 | 4.45 |
| imine (PEI) | | | | | | | | | | | |

As shown, the CPD is not the same in vacuum and in the presence of gas, and it depends on the type of the gas medium. For a given solid material, the CPD was increased in the presence of one type of gas medium and decreased in the presence of another type of gas medium relative to the vacuum condition. Similarly, the presence of a given gas medium increased the CPD for one solid material and decreases the CPD for another solid material relative to the vacuum condition.

It is hypothesized that the gas molecules in the measurement chamber become charged as a result of their interaction with the surface of the test material. A cloud of charged gas molecules remains trapped near the surface, retained by the attraction of the image charge, altering the measured CPD as a function of the degree and polarity of its charge.

This phenomenon allows the definition of a point of zero charge transferability (ZCT) for each gas medium. This point is defined as the CPD of materials at which the gas changes from an electron donor to an electron receiver. In other words, the ZCT of a gas falls between the highest work function of the materials which display an increase in CPD and the lowest work function of the materials which display a decrease in CPD.

For example, for PEI the presence of air decreased the CPD from about 4.6 eV in vacuum to about 4.4 eV in the presence of air. Thus, air behaves as an electron receiver for PEI. This behavior is illustrated in FIG. 5 as a decreasing solid line connecting the 4.6 eV point at vacuum condition with the 4.4 eV point at gas condition. For Cs₂CO₃, the presence of air increased the CPD from about 4.0 eV in vacuum to about 4.5 eV in the presence of air. Thus, air behaves as an electron donor for Cs₂CO₃. This behavior is illustrated in FIG. 5 as an increasing solid line connecting the 4.0 eV point at vacuum condition with the 4.5 eV point at gas condition. According to the above definition, the ZCT of air is estimated to be approximately 4.45 eV.

The same estimations were performed also for Xe resulting in a ZCT of about 4.45 eV. Since NF₃ behaves as an electron receiver for all the tested materials, no ZCT could be assessed, but it is expected to be below 2.9 eV. The ZCT values for some gas media as estimated according to the above procedure is listed in Table 3.

TABLE 3

| Gas medium | ZCT (eV) |
|---|---|
| air | 4.45 |
| Xe | 4.45 |
| O₂ | 4.60-5.05 |
| SF₆ | 2.90-4.90 |

The present example demonstrated that the gas molecules transport positive or negative charge away from the solid surface, and that the potential to which the surface becomes charged due to the interaction with the gas molecule depends on the type of solid material as well as the gas medium. The present example further demonstrated that a Kelvin probe may be useful for providing an indication of charge transferability as defined in some embodiments of the present invention.

### Example 4

### Generation of Electrical Current by Thermal Motion of Gas Molecules

The present example describes experiments performed in accordance with some embodiments of the present invention to generate electrical current by thermal motion of gas molecules between adjacent surfaces neither in direct contact nor having spacers therebetween.

### Methods

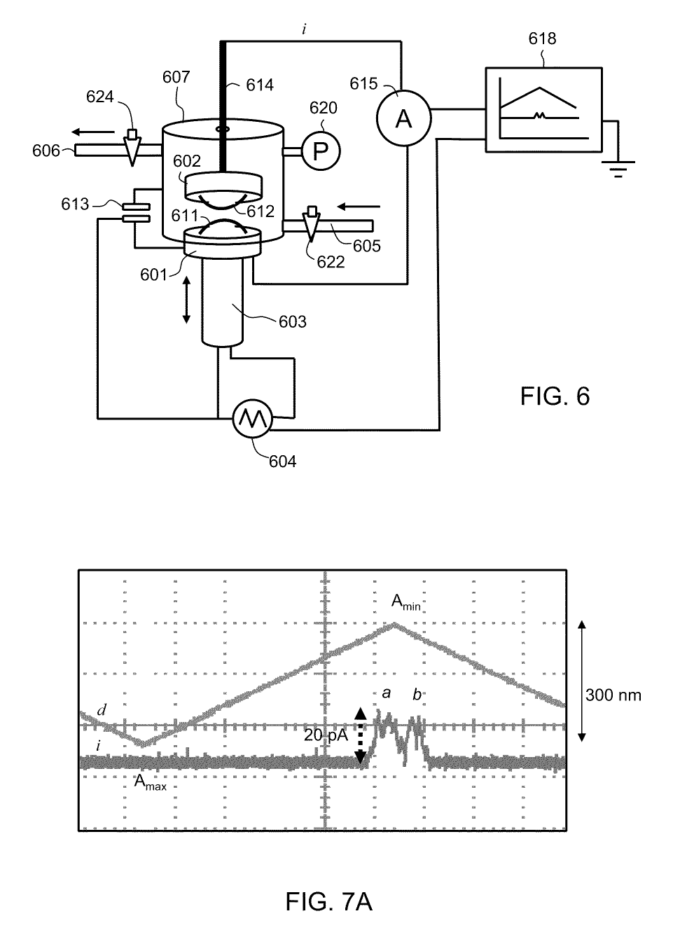

The experimental setup is schematically illustrated in FIG. 6. Two opposite disk-shaped holding electrodes 601 and 602 made of stainless steel were housed with the test gas in a pressurizable and sealable chamber 607 made of stainless steel. Alternatively, the holding electrodes and chamber can be made of a material with a low thermal expansion coefficient, such as Super Invar 32-5. Chamber 607 was cylindrical in shape, 9 cm in diameter, 4.3 cm in height, and 14 cm³ in gas capacity. The thickness of the walls of chamber 607 was at least 2.3 cm. An entry port 605 with an entry valve 622 and an exit port 606 with an exit valve 624 were provided for controlling the gas composition and pressure in the chamber. Chamber 607 was capable of sustaining a maximal pressure of 10 Atm. The pressure in chamber 607 was modified via entry port 605 and exit port 606, and monitored using a manometer 620 (Model ATM 0-10 Bar; STS).

Electrodes 601 and 602 served for holding samples having negative and positive charge transferability as further detailed hereinbelow. In some experiments the samples on the electrodes were planar (a flat disc), and in some experiments one or two plano-convex lenses 611 and 612 made of glass were coated by the test samples and mounted on the electrodes.

Electrode 601 was connected to a stacked piezoelectric crystal 603 (Physik Instrumente) driven by a high voltage power supply and controller 604 (Models E516/E761; Physik Instrumente). Reciprocal motion of electrode 601 was generated by piezoelectric crystal 603 in response to signals from controller 604. A capacitive sensor 613 (Model D105, Physik Instrumente) monitored the distance between electrodes 601 and 602 and sent a feedback signal to controller 604. This configuration allowed controlling the distance between the outermost layers of the samples on the electrodes with a resolution of about 0.2 nm. The range of distances used in the experiments was from about 1 nanometer to a few tens of micrometers.

Electrode 602 was fixed and was mechanically connected to chamber 607. Metal electrode 614 connected electrode 602 to a sensitive current meter 615 (picoammeter Model 617; Keithley), itself electrically connected to electrode 601. Current meter 615 measured the current i created by the gas-mediated charge transfer between the two samples on electrodes 601 and 602. Output was displayed on an oscilloscope 618 (Tektronix TDS3012).

Crystal 603 was set to oscillate by a triangular voltage pulse with a frequency ranging from DC to 2 Hz so that any distance between full contact to a separation of a few tens of microns was available. In addition to the oscillation, crystal 603 also could also be moved by a fixed distance by applying a DC voltage. In some experiments both the DC voltage and oscillating voltage were used consecutively to control the position of crystal 603 and therefore the distance between the outer surfaces of the two samples on the electrodes. During the oscillations, the current produced across the two surfaces was measured by the current meter. The analog voltage signal from capacitive sensor 613 was measured concurrently so as to monitor the distance between the surfaces. Both the analog voltage signal and the analog output of the current signal were displayed and measured by oscilloscope 618.

All experiments were performed at room temperature. The only voltage used was for controlling the motion of the piezoelectric crystal and for powering the oscilloscope. The electrodes were isolated from the power sources and measures were taken to ensure that the power sources and distance measurement system did not generate an electric field between the electrodes.

The following test materials with positive charge transferability were used: (a) a magnesium disc, 1 mm in thickness and 10 mm in diameter; (b) a highly oriented pyrolytic graphite (HOPG) square, 1 mm in thickness and 10 mm×10 mm in dimension (Micromasch, USA, Type: ZYH quality, mosaic spread: 3.5±1.5 degree, grain size in the range of 30-40 nm); (c) a gold coated glass lens; and (d) a gold coated glass lens further coated with materials having positive charge transferability (e.g., CsF and CaCO₃).

The surface of the test material was polished as known in the art and its roughness was determined using AFM following standard procedures (see, e.g., C. Nogues and M. Wanunu, “A rapid approach to reproducible, atomically flat gold films on mica”, Surface Science 573 (2004) L383-L389). HOPG is a material considered atomically flat and smooth in the subnanometer range and was therefore used without further surface polishing treatment. Polishing techniques are readily available in the industry for achieving less than 0.5 nm surface roughness. All materials tested were essentially smooth and most had a surface roughness of less than 5 Å RMS.

The following procedure was employed for the preparation of the gold coated lenses, which were used bare (gold coating only) or further coated with materials that either increased or decreased its initial charge transferability.

Glass lenses were coated with a 200 nm thick layer of 99.999% pure gold by conventional e-beam evaporation. Borosilicate glass lenses, 52 mm in diameter and 2 mm in thickness (Casix Inc.) were cleaned by sonication in a first bath of ethanol (analytical grade; Gadot), followed by a second sonication cleaning in n-hexane (analytical grade; Gadot). The lenses were then dried under N₂ atmosphere at room temperature. The convex sides of the lenses were coated by e-beam evaporation first with a thin adhesion layer (about 2-5 nm in thickness) of 99.999% pure chromium (Cr) then with a thicker layer (about 200-250 nm in thickness) of 99.999% pure gold (Au). The evaporation was performed under a pressure of 10⁻⁷ mbar. The thickness of the chromium and gold layers were monitored using quartz crystal micro balance. The gold outermost layer was annealed and its surface roughness was assessed by AFM followed by image analysis as disclosed in Nogues supra. The obtained surface had a roughness which is less than 5 Å RMS.

In some experiments, the gold layer was further coated with material having different charge transferability. The further coating was achieved using one of the following techniques: (a) spin coating; (b) drying of a drop applied to the support surface; (c) electrochemical deposition; and (d) by creating a self-assembled monolayer of molecules, e.g., by using molecules having a free thiol (—SH) terminal.

An additional way of providing a surface of positive or negative charge transferability is exemplified in Example 5 that follows.

### Results

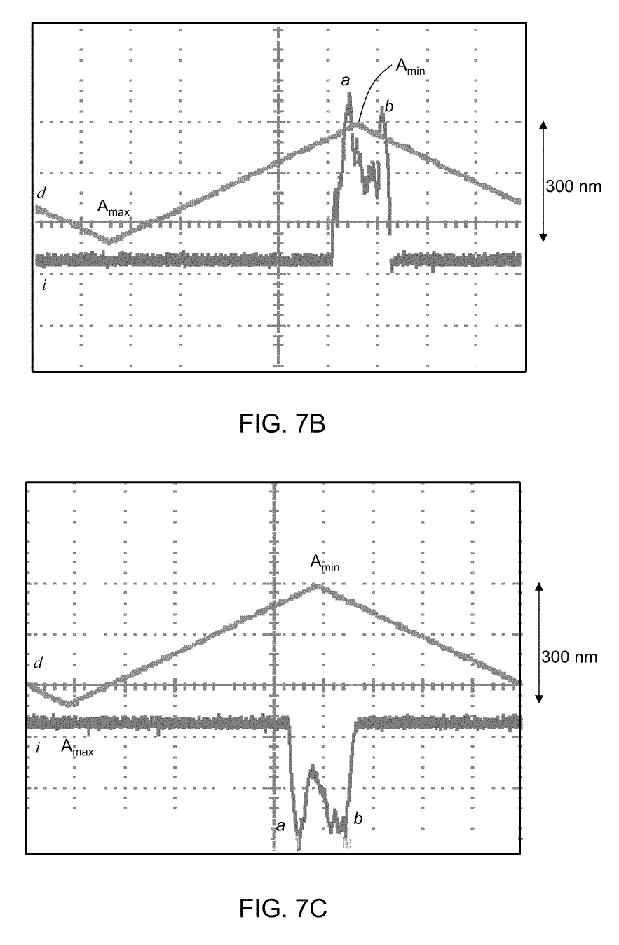

FIGS. 7A-C are oscilloscope outputs in three different experiments.

FIG. 7A corresponds to an experiment in which the surface of positive charge transferability was made of CsF and the surface of negative charge transferability was made of Mg(ClO₃)₂, where both materials were deposited on a gold layer carried by a glass lens.

FIG. 7B corresponds to an experiment in which the surface of positive charge transferability was made of a flat disc of Mg and the surface of negative charge transferability was a gold layer carried by a glass lens.

FIG. 7C corresponds to an experiment which was similar to the experiment of FIG. 7B, but with inverted positions of the two surfaces, hence the opposite direction of the current, to act as a control on the experiment.

The gas used in these experiments was SF₆ and the chamber was maintained at a pressure of 3 Atm.

Shown in FIGS. 7A-C is the signal i from the current meter 615 (lower graph) and the output of capacitive sensor 613 (upper graph) which is indicative of the distance d between electrodes 601 and 602. Note that FIG. 7C depicts an opposite current relative to FIGS. 7A-B due to the inverted positions of the materials of positive and negative charge transferability on the electrodes.

At point Aₘᵢₙ (maximal applied voltage and minimal distance between the electrodes) d equaled a few nanometers. At point Aₘₐₓ (minimal applied voltage and maximal distance between the electrodes) d equaled about 300 nm. Two main current peaks of similar amplitude (indicated a and b in FIGS. 7A-C), were observed, in FIG. 7A both of about 20 pA. These two peaks correspond to the two time instants within a single oscillation cycle at which the piezoelectric crystal 603 brought the electrodes within a distance of less than 5 nm from each other.

The profiles of the current depicted in FIGS. 7A-C are typical for many of the experiments. Similar results were obtained in an experiment in which the surface of positive charge transferability was made of a flat surface of highly oriented pyrolytic graphite (HOPG) and the surface of negative charge transferability was a gold layer carried by a glass lens; and in an experiment in which the surface of positive charge transferability was made of CaCO₃ deposited on a gold layer carried by a glass lens and the surface of negative charge transferability was a gold layer carried by a glass lens. In some experiments, different profiles were observed.

In a control experiment where both surfaces were identical gold coated lenses, no current was detected at all distances tested over the same range.

The device was set to prevent direct contact between the tested surfaces, as confirmed by the absence of a single current peak that would have suggested direct contact.

Since the experiment was performed in the absence of any external electric field (the electrodes were isolated from any power source), the current signal in the current meter 615 was indicative of charge transport via thermal motion of gas molecules.

The present example demonstrated the generation of electric current by deriving energy from thermal motion of gas molecules.

### Example 5

### Electrodeposition

The present example describes coating via electrodeposition (ED). Electrodeposition can be subdivided into electrochemical deposition (ECD) where the electroactive species, generally salts, are dissociated into ions within a solvent, and electrophoretic deposition (EPD) where the electroactive species are charged within a solvent. In both cases, the solvent may be polar or non-polar.

In electrochemical deposition, for example in an aqueous solution, either one surface is coated with, or modified by, ions present in the electrolytic solution, or both surfaces are concurrently coated or modified, one surface with anions and the other surface with cations. The electrochemical deposition can modify the work function of a surface.

In electrophoretic deposition, for example in a non-polar solvent, the work function was modified by dissolved or suspended materials. In some instances, dissolved or suspended species, such as dyes, were electrophoretically deposited in polar solvents such as water or alcohol.

Generally, when the surface acted as an anode, it was coated with, or modified by, a material having a higher work function, and when a surface acted as a cathode it was coated with, or modified by, a material having a lower work function.

In experiments performed by the present inventor, the above outcomes were obtained both with solvents comprising a single salt and with solvents comprising other dissolved or dispersed species and with solvents comprising mixtures thereof.

### Methods

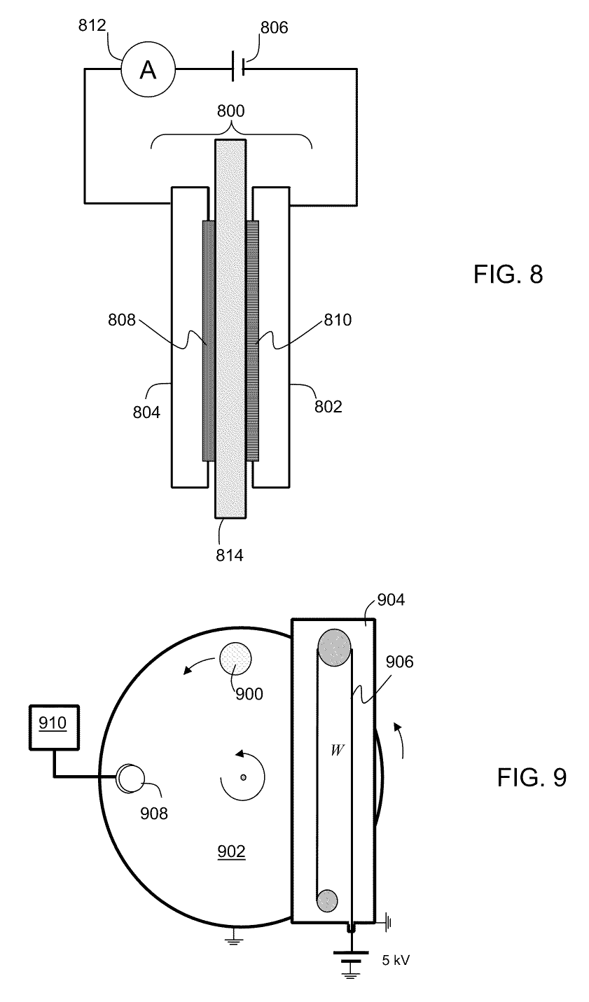

FIG. 8 is a schematic illustration of an experimental setup used for the modification of work function, according to some embodiments of the present invention.

An ED cell 800 was formed between conductive substrates, cathode 810 and anode 808. A voltage source 806 was used to apply a potential difference between the cathode and the anode. The ED cell also included at least one conductive support structure 802 or 804 and a solution of one or more salts or other dissolved or dispersed species in a polar or non-polar solvent. As schematically shown in FIG. 8, the conductive support structures 802 and 804 were built as grooved metal rings constructed to receive the conductive substrates (which can be identical or different from each other), and maintain them in position.

In some experiments the support structure was a metal disc, and in some experiments the substrate was a gold coated glass lens where the current was conveyed from the holding electrode to the surface to be coated through the conductive gold layer. For single electrode coating, these substrates were used either as the anode or cathode. For simultaneous coating, these substrates were used as both anode and cathode. Materials used for the substrates are provided hereinunder.

The anode and cathode were connected through a DC power supply 806 (Titan TPS 6030) and a constant voltage was applied for fixed periods of time. The current through the circuit was monitored by a DC millimeter 812.

In order to ensure the accuracy of the measurement for electrodeposition, and to prevent the random diffusion of the cations and anions from the support surface back to the solution, the solution comprising the electroactive species was impregnated into a porous material 814 placed between the surfaces to be coated. The porous material was made of glass microfiber filter paper (Whatman®; GF/D 2.7 μm) or of non-woven fabric made of thermoplastic polyester and having a pore diameter of about 5 μm. The soaked porous material was applied to the target surface with gentle pressure to ensure contact and conductivity. At the end of each electrodeposition experiment, the wet porous material was removed from the cell.

The coated surfaces were then removed from the ED cell and placed for 4 hours in a vacuum chamber at a pressure of about 10⁻² mbar at room temperature. The coating was assessed by measuring the work function as previously described using a Kelvin Probe (Kelvin Control 07, Besocke Delta Phi). The probe measured the work function in vacuum.

In some experiments, the nature of the substrate coating or modification was also analyzed by Energy Dispersed X-Ray Analysis (EDX). EDX confirmed the presence of a new substance on the substrate surface.

Discs made of the following materials were employed as substrates in the experiment: stainless steel (polished AISI 314; diameter 25 mm; thickness 1.5 mm); aluminum (A16061; diameter 25 mm; thickness 1.5 mm); gold (stainless steel discs sputtered with gold); stainless steel discs covered with flexible layers of graphite commercially known as Grafoil® (GrafTech; GT™ A graphite thickness about 0.13 mm), Graphite Oxide (GO) prepared by oxidation of graphite flakes (Asbury Carbon 3763; size between 40-71 micron) according to the method of Hummers (U.S. Pat. No. 2,798,878 and W. S. Hummers and R. E. Offeman, “Preparation of graphite oxide”, J. Am. Chem. Soc. 80 (1958) 1339), Grafoil® Oxide (GFO) prepared by the Hummers method; and gold coated glass lenses prepared as described in Example 4.

In a first set of experiments, the support material was treated in the above described ED cell with aqueous solutions comprising 20 mM or 2 μM of any of the following salts or dyes: Ba(CH₃COO)₂, Ba(NO₃)₂, BaSO₄, CsBr, CsF, CsN₃, Ethylene diamine (EDA), KF, KNO₃, Na(CH₃COO), NaNO₃, NH₄CO₃, (NH₄)₂CO₃, Basic Blue 7 and 9, Basic Green 1 and 5, Basic Orange 2 and 14, Basic Red 1, 1:1, 2, 12, 13, 14, and 18, Basic Violet 2, 10, 11 and 11:1, Basic Yellow 2, 11 and 37, Direct Red 80, Methyl Violet 2B, Rhodamine FB and mixtures of these salts and dyes. The salts were pure chemicals purchased from Sigma Aldrich or other suppliers, and the dyes were purchased from Dynasty Chemicals or other suppliers.

The water used for the preparation of the aqueous solutions was double distilled and filtered (Millipore filtration system: ExtraPure; 18.2 MΩ·cm) and the resulting solutions were sonicated for 5 minutes at maximal power (SoniClean) to ensure complete dissolution of the salts or dyes. When employing dyes, an additional step of filtration was added (0.2 μm filter).

In a second set of experiments, the support material was treated in the above described ED cell with 0.02 M CsN₃+0.02 M CsF dissolved in analytical grade ethanol and sonicated as further detailed hereinabove.

In a third set of experiments, the support material was treated in the ED cell with Isopar® L-based solutions comprising one of the following compositions: 30% w/w Ca Petronate; 30% w/w Lubrizol; 30% w/w Lecithin, 3% w/w Lecithin, 0.3% w/w Lecithin, 30% w/w Zr-Hex-Cem® 12%, 3% w/w Zr-Hex-Cem® 12%. Lecithin (Eastman Kodak) and the 2-ethylhexanoic acid octoate commercialized as Zr-Hex-Cem® (Mooney Chemicals) are used as food additives and paint dryers respectively.

### Results

Table 4 below summarizes some of the results. In all entries of Table 4, the substrate material was identical for the cathode and anode sites of the ED cell. The work functions of the anode and cathode after deposition, as measured in vacuum using a Kelvin Probe as described in Example 3, are provided in Table 4 both in absolute value (fifth and seventh columns, respectively) and in relative value (sixth and eighth columns, respectively). The relative values indicate the difference Δ=W_{f}−Wᵢ, where Wᵢ is the initial work function of the support material (before deposition) and W_{f} is the final work function of the anode or cathode after deposition. Thus, positive relative values indicate increments and negative relative values indicate decrements.

It is noted that GO coated material are more prone to variability than the other materials, depending on the coating method. The accuracy of the results quoted below is about ±20% for absolute measurements and within a few percent for relative measurements.

TABLE 4

| | | | | Work Function | | | |
|---|---|---|---|---|---|---|---|
| | Dissolved/Dispersed | Voltage | Deposition | Anode | | Cathode | |
| Substrate Material | Species | (V) | Time (min) | absolute | relative | absolute | relative |
| | 0.02M each in | | | | | | |
| | water | | | | | | |
| Stainless Steel + | BaSO₄ | 3 | 15 | 5.76 | 0.76 | 5.15 | 0.15 |
| GFO | CsF | 3 | 15 | 5.81 | 0.81 | 4.72 | −0.08 |
| | CsN₃ | 3 | 15 | 5.57 | 0.57 | 4.89 | −0.11 |
| | KF | 3 | 15 | 5.44 | 0.44 | 5.16 | 0.16 |
| | Basic Blue 7 | 3 | 5 | 5.13 | 0.13 | 4.61 | −0.39 |
| | Basic Green 5 | 3 | 5 | 5.12 | 0.12 | 4.87 | −0.13 |
| | Basic Orange 14 | 3 | 5 | 5.42 | 0.42 | 4.53 | −0.47 |
| | Basic Red 1 | 3 | 5 | 5.14 | 0.14 | 4.27 | −0.73 |
| | Basic Violet 11:1 | 3 | 5 | 4.99 | −0.01 | 3.18 | −1.82 |
| | Basic Yellow 2 | 3 | 5 | 5.17 | 0.17 | 4.45 | −0.55 |
| | Methyl Violet 2B | 3 | 5 | 5.31 | 0.31 | 4.46 | −0.56 |
| | BaSO₄ + CsF | 3 | 15 | 5.63 | 0.63 | 4.50 | −0.50 |
| | EDA + CsBr | 3 | 5 | 5.41 | 0.41 | 4.84 | −0.16 |
| | CsN₃ + CsF | 3 | 15 | 5.71 | 0.71 | 4.33 | −0.67 |
| Stainless Steel + | CsN₃ + CsF | 3 | 15 | 5.56 | 0.36 | 4.77 | −0.43 |
| GO | | | | | | | |
| | 0.02M each in | | | | | | |
| | EtOH | | | | | | |
| Au Coated lens + | CsN₃ + CsF | 40 | 30 | 4.74 | −0.46 | 4.59 | −0.61 |
| GO | | | | | | | |
| | In Isopar ® L | | | | | | |
| Aluminum | 30% w/w of Zr- | 700 | 2880 | 5.32 | 1.42 | 3.95 | 0.05 |
| | Hex-Cem ® 12% | | | | | | |
| | Ca petronate | 700 | 2880 | 4.75 | 0.85 | 3.92 | 0.02 |
| | Lubrizol 1191 | 700 | 2880 | 5.55 | 1.65 | 3.70 | −0.20 |
| Stainless Steel | 30% w/w of Zr- | 700 | 2880 | 5.08 | 0.18 | 4.14 | −0.76 |
| | Hex-Cem ® 12% | | | | | | |
| | 3% w/w lecithin | 700 | 2880 | 5.77 | 0.87 | 4.60 | −0.30 |

Table 4 demonstrates that the electrodeposition technique described is capable of depositing a relatively high work function material on the anode and a relatively low work function material on the cathode, in polar solvents with salts and dyes as well as in non-polar solvents with a variety of dissolved/dispersed species. In general, depending upon the gas being employed, when anodes and cathodes coated or modified according to the teachings herein are exposed to a suitable gas medium, the anode will in general have more negative charge transferability than the cathode, which will have more positive charge transferability.

### Example 6

### Selection of Non-Conductive Spacers

The present example describes experiments performed in accordance with some embodiments of the present invention to estimate the electrical resistance of several materials and to assess their efficacy as potential non-conductive spacers of the cell and power source device of the present embodiments.

### Methods

The experimental setup is illustrated in FIG. 9. Metal disc 900 was coated by a homogeneous film of spacer test material, using one of the following techniques: spin coating, roller coating, spray coating or any other coating method known in the art. In the case of insoluble materials which cannot be readily made into homogeneous coatings, the metal disc was first coated with a conductive tacky resin on which a powder layer of test material was adhered.

Coated disc 900 was then mounted on a rotating aluminum table 902 (30 rotations per minute) that was electrically grounded. Disc 900 was charged for 25 seconds by a corona charging device, 904 as described in U.S. Pat. No. 2,836,725, placed above the rotating table. The tungsten wire emitter 906 of the corona charging device was held at a DC bias of +5 kV. Then, with the voltage switched off and table 902 continuing to rotate, the disc charge was measured by a disc shaped copper electrode 908 placed above the rotating disc and connected to an oscilloscope 910. The decay rate of the disc surface charge was monitored for eight minutes by observing the potential drop induced on the copper electrode. Thus, the electrical resistivity of various candidate spacer materials was compared by using electrostatic discharge rates.

In addition, the charge transferability in the presence of nitrogen was assessed for all test materials using a Kelvin probe as described in Example 3.

### Results

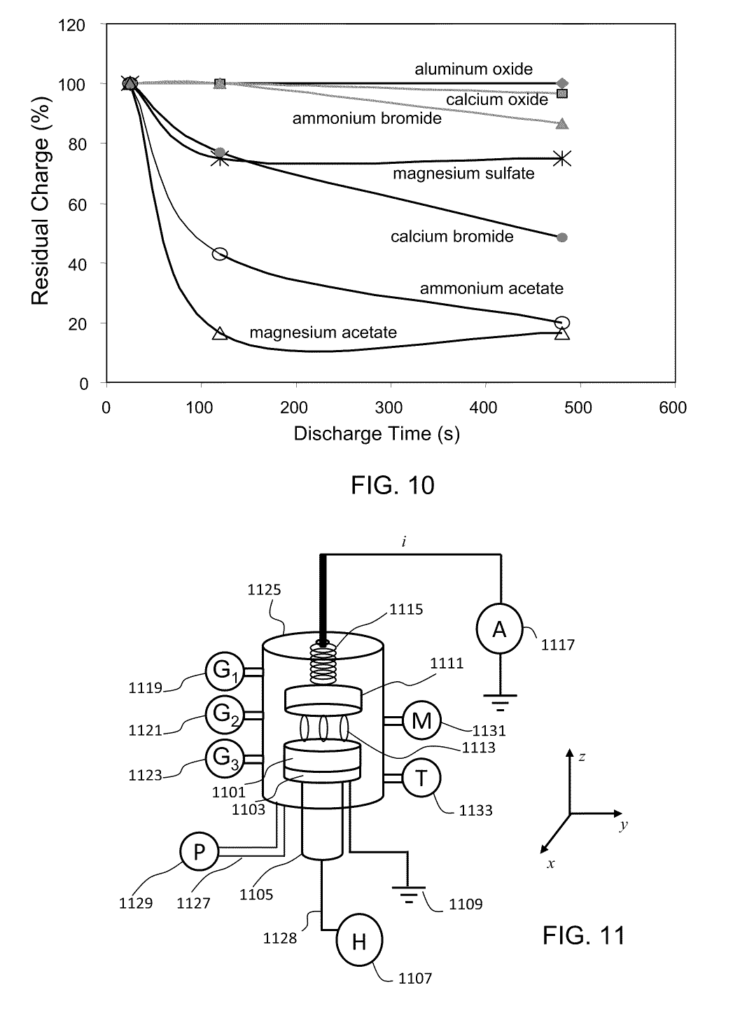

FIG. 10 shows discharge graphs for a number of materials that have been studied in the experiment. Results are expressed as percent of residual charge versus time in seconds. As shown, some materials, such as magnesium acetate and ammonium acetate, lost about 80% of their initial charge over 8 minutes after charging, while others, such as aluminum oxide and calcium oxide, retained about 100% of their initial charge during the full measurement period. The materials which best retained their charge were considered to be potential candidates as non-conductive spacers in the cell and power source device of various exemplary embodiments of the invention.

The non-conductivity of materials contemplated for uses other than spacing can be assessed by this procedure. For example, Phlogopite mica and MACOR® were tested in this experimental setup and respectively displayed a residual charge of about 90% and about 98% after 2 minutes, which dropped to about 50% and about 75% after 8 minutes.

### Example 7

### Sputtering

The present example describes experiments performed in accordance with some embodiments of the present invention to modify the charge transferability of materials by depositing on their surface a thin layer of another material emitted by cathode sputtering.

### Methods

Sputtering is widely used to deposit thin films by depositing material from a target onto a substrate or to remove unwanted films in a reversal of this process. Sputtering methods are known in the art of thin film coating (see for instance chapters 4 and 5 in the 2^{nd} edition of “Materials science of thin films” by Milton Ohring, 2001).

The sputtering process, achieved by bombarding the target material with argon gas ions to coat the nearby substrate, took place inside a vacuum chamber under low base pressure of down to 2.7×10⁻⁷ mbar. The sputtering was performed using an ATC Orion 8 HV sputtering system (AJA International Inc). The sputtering system, included a DC and an RF power sources, and was customized to accommodate up to four 3″ targets (about 7.62 cm), which allowed performing sequential sputtering with different materials or co-sputtering with combinations of different materials. The sputtering system was also able to accommodate reactive gases, such as N₂, O₂ and the like, to perform reactive sputtering. The system was optimized to achieve thickness uniformity with variations of less than 1% on substrates of up to about 15 cm in diameter.

The following structures were used as substrates: (i) discs of Aluminum (Al, AL6061-T4) or Stainless Steel (S/S, AISI303) having 50 mm in diameter, 5 mm in thickness no more than 100 nm in roughness; (ii) Thin Glass Discs (TGD, Menzel-Glaser Inc.), having a 50 mm in diameter, 100 μm in thickness, and less than 50 nm in roughness; (iii) Float Glass Discs (FGD, Perez Brothers, Israel), 40 mm or 50 mm in diameter, 5 mm or 10 mm in thickness, and less than 10 nm in roughness; (iv) double side polished silicon (Si) wafer discs (Virginia Semiconductor Inc.), 50.8 mm in diameter, 300 μm in thickness, at most 1 nm in roughness, crystallographic orientation <100> and electrical resistivity of 8-12 Ω·cm or 0.1-1.2 Ω·cm of boron dopant, or 8-12 Ω·cm of phosphorous dopant; and (v) single side polished Si wafer discs (Virginia Semiconductor Inc.) 50.8 mm in diameter, 350 μm in thickness, crystallographic orientation <111> and electrical resistivity of 7-10 Ω·cm of phosphorous dopant.

The roughnesses of the substrates were determined by surface profilometer (Veeco—Dektak 3ST).

The following materials were used as target materials to ultimately coat, alone or in combination, the substrates: Aluminum (Al), Aluminum nitride (AlN), Boron nitride (BN), Gold (Au), Lanthanum hexaboride (LaB₆), Nickel (Ni), Palladium-gold (Pd—Au), Hafnium (Hf), Manganese (Mn), Tantalum (Ta), Titanium (Ti), Chromium (Cr), Molybdenum (Mo), Gadolinium (Gd), Silica (SiO₂), Yttria (Y₂O₃), Tungsten (W), Zirconium oxide (ZrO₂), Tungsten trioxide (WO₃), Lanthanum oxide (La₂O₃), Barium titanate (BaTiO₃), Strontium oxide (SrO), Calcium oxide (CaO) and Chromium silicide (Cr₃Si). The purity of each target material was at least 99.9%. All target materials were purchased from AJA International Inc. or Kurt Lesker Company. To ensure optimal adhesion and homogenous thin film deposition, substrates were first cleaned by sonication in organic solvents (sequentially in n-hexane, acetone and isopropanol, for 5 minutes each), followed by rinsing under sonication in filtered deionised water for one minute, and drying under a nitrogen gas stream. Prior to sputtering, the samples underwent plasma etching to remove any residual organic/non-organic contamination from the surface using typically 20 minutes plasma at 4×10⁻³ mbar, 30 W RF power, 10 Sccm Ar, while the substrate was heated to 250° C.

### Results

Selected examples of the coated substrates so prepared are presented in Table 5. Listed in Table 5 are the main sputtering conditions, including the type of power supply and its strength (watts), the flow rate of the gases (standard cubic centimeter per minute, sccm), the pressure in the chamber (mbar), and the duration of the sputtering (second). In all following examples, the distance between the target and the substrate was 146 mm. The thickness (nm) and roughness of the resulting uniform film was measured by surface profilometer. The film coating was thin enough not to modify significantly the original smoothness of the substrates. TGD/Al and FGD/Al refer respectively to Thin and Flat Glass Discs entirely sputtered on both sides of the substrate with aluminum. Similarly, FGD/Cr refers to a glass substrate entirely sputtered with chromium. Sputtering could be performed on one or both sides of the substrate, as desired. The asterisk indicates that following the sputtering procedure, the samples were post-annealed for one hour at 500° C., at 10⁻⁶ mbar.

TABLE 5

| | | Power | Power | Ar flow | O₂ flow | Pressure | Time | Film thickness |
|---|---|---|---|---|---|---|---|---|
| Substrate | Target | supply | [w] | [sccm] | [sccm] | [mbar] | [s] | [nm] |
| TGD | Al | DC | 200 | 10 | 0 | 4 × 10⁻³ | 1,800 | 200 |
| TGD | Cr | DC | 200 | 10 | 0 | 4 × 10⁻³ | 1,800 | 230 |
| S/S | SiO₂ | RF | 250 | 15 | 1.5 | 4 × 10⁻³ | 14,400 | 430 |
| S/S | AlN | RF | 150 | 10 | 0 | 4 × 10⁻³ | 14,400 | 300 |
| Si | Al | DC | 200 | 10 | 0 | 4 × 10⁻³ | 1,800 | 200 |
| Si | BN | RF | 200 | 10 | 0 | 4 × 10⁻³ | 10,800 | 220 |
| TGD/Al | WO₃ | RF | 200 | 10 | 5 | 4 × 10⁻³ | 7,200 | 100 |
| TGD/Al | Mn | DC | 100 | 10 | 8 | 4 × 10⁻³ | 21,600 | 220 |
| TGD/Al | Cr | DC | 200 | 10 | 0 | 4 × 10⁻³ | 1,800 | 230 |
| TGD/Al | Mn | DC | 90 | 10 | 8 | 4 × 10⁻³ | 18,000 | 300 |
| | Ni | DC | 60 | | | | | |
| TGD/Al* | Cr₃Si | DC | 190 | 10 | 0 | 4 × 10⁻³ | 5,400 | 540 |
| | SiO₂ | RF | 75 | | | | | |
| FGD | Al | DC | 200 | 10 | 0 | 4 × 10⁻³ | 1,800 | 200 |
| FGD | Cr | DC | 200 | 10 | 0 | 4 × 10⁻³ | 1,800 | 230 |
| FGD/Al | SiO₂ | RF | 250 | 10 | 0 | 4 × 10⁻³ | 12,000 | 600 |
| FGD/Al | AlN | RF | 150 | 10 | 0 | 4 × 10⁻³ | 14,400 | 300 |
| FGD/Cr | Mo | DC | 200 | 10 | 0 | 4 × 10⁻³ | 5,400 | 330 |
| FGD/Cr | Gd | DC | 100 | 10 | 0 | 4 × 10⁻³ | 2,400 | 560 |

Surfaces prepared according to the above described method were used in the experimental setup schematically illustrated in FIG. 11, as further detailed in Example 8 below.

### Example 8

### Generation of Electrical Current by Thermal Motion of Gas Molecules

The present example describes experiments performed in accordance with some embodiments of the present invention to generate electrical current by thermal motion of gas molecules between surfaces having different charge transferability. In the experiments described below, the surfaces were kept apart by spacers or outwardly protruding roughness features.

### Outlines of the Experiments

### Setup

The experimental setup used in all experiments of the present example is schematically illustrated in FIG. 11. An electrically grounded structure 1101 was placed within a sealable stainless steel chamber 1125 (AISI 316). Structure 1101 was positioned over an electrically insulating ceramic interface 1103 of an internal heater 1105. A controller 1107 (Ceramisis—Controllable Sample Heater up to 1,200° C.) was connected to heater 1105 via a connection line 1128. The connection of structure 1101 to ground potential is shown at 1109. A non-grounded structure 1111 was positioned within chamber 1125 over structure 1101. The charge transferability of the surface of structure 1101 was different from that of structure 1111.

In experiments in which one or more of structures 1101 and 1111 was made of a material of poor bulk conductivity, structure 1111 was, unless otherwise indicated, positioned directly over structure 1101. In these experiments, the distance between the facing surfaces of structures 1101 and 1111 was dictated in part by their roughness. The distance varied across the surfaces from 0 (namely direct contact) to tens or hundreds of nanometers in other areas depending on the size and distribution of the roughness features.

In experiments in which both structures 1101 and 1111 were made of bulk conductive material, spacers 1113 were introduced between them. Spacers 1113 were spin coated on the surface of the grounded structure 1101 facing 1111. The height of spacers 1113 along the z direction (generally perpendicular to the surface of structures 1101 and 1111, see FIG. 11) was from several hundred nanometers to several microns.

A conductive spring 1115, made of music wire high carbon steel, was positioned within chamber 1125 over structure 1111 and was connected through an electrical feed-through in the upper wall of chamber 1125 to an external electrometer 1117 (Keithley 6517A). The electrometer was calibrated and displayed a high accuracy of less than ±1% of readings. In some experiments multiple cells, each comprising a pair of structures 1101 and 1111 with a gap between them, were stacked within the chamber. In these experiments, the lowermost structure 1101 of the stack was connected to ground 1109 and the uppermost structure 1111 of the stack was connected to electrometer 1117. The uppermost structure in the stack is referred to hereinunder as “the non-grounded structure”.

Chamber 1125 was provided with inlets 1119, 1121 and 1123 for injecting gas into the chamber, and an outlet 1127 configured for evacuating gas out of the chamber via vacuum pump 1129 (Boc Edwards, XDS 10; optionally connected in series through a second vacuum pump Boc Edwards, EXT-255H Turbo). Chamber 1125 was cylindrical in shape, with an average diameter of about 8.5 cm, a height of about 7 cm, walls about 0.17 cm thickness, and a gas capacity of about 400 cm³. The chamber was built of corrosive resistant low-outgassing materials, with parts and connections through O-rings adapted to sustain at least the operational vacuum and temperature conditions. The pressure within chamber 1125 was controlled upon gas injection and evacuation. The pressure was monitored using manometer 1131 (BOC Edwards, Active digital controller, with gauge models APG100-XLC, ASG 2000 mbar, and WRG-SL each covering a different portion in the range of pressure measurement). The experiments were conducted at various pressures, in the range of 10⁻¹⁰ to 8 bars.

The temperatures during the experiments were controlled in two ways: the temperature T_{In} of structure 1101 was controlled via internal heater 1105 and controller 1107, and the temperature T_{Ex} of the walls of chamber 1125 was controlled by means of an external ribbon heater (not shown), connected to the external wall of the chamber. The experiments were conducted at various internal and external temperatures. Specifically, T_{In} was varied from 25° C. to 400° C. and T_{Ex} was varied from 50° C. to 150° C. T_{In} and T_{Ex} were monitored using a type-k thermocouple and controller 1133 (Eurotherm 2216e).

It was established in preliminary experiments in which both structures 1101 and 1111 were connected to thermocouples, that when only internal heating was applied (via heater 1105) while the external heating was switched off, the temperature difference between the structures 1101 and 1111 was negligible in the presence of gas. Specifically, the Kelvin temperature of structure 1101 was higher by no more than 1% than that of structure 1111. Moreover, the residual temperature gradient, if any, would, assuming thermionic emission at low temperature, generate negative current in the present experimental setup where the grounded structure is heated. Thermionic emission is not expected at the present operating temperatures, nor in the absence of a temperature gradient. Additionally, thermionic generated current should also exist in vacuum, as opposed to the current generated according to the present invention, which as stated, relies on gas mediated charge transfer and is therefore nonexistent in vacuum. As demonstrated by the results section below, in vacuum there was no current above noise level.

As the signals monitored in this experiment were generally below 1 mA, any device which might affect the recorded signals, and which was not essential at the time of the measurement, was disconnected once no longer required. For instance, the manometer was turned off once the desired stable pressure was reached and measured.

### Materials

The experiments described below employed for structures 1101 and 1111 materials having high electrical conductivity (above 10³ S/m) poor electrical conductivity (below 10⁻⁹ S/m) or midrange electrical conductivity (between 10⁻⁹ and 10³ S/m).

### Methods

The roughnesses of the surfaces of structures 1101 and 1111, when not provided by the manufacturer, were measured by surface profilometer. Generally, metallic surfaces were gently polished using a polishing disc (Struers, MD-NAP) with a suspension of 0.1 μm agglomerated alpha alumina. Thus, unless otherwise stated, the surfaces had a roughness of about 100 nm or less.

Before each experiment, the resistance between structures 1101 and 1111 was measured using a Wavetek Meterman DM28XT Multimeter (not drawn). The resistance was always above 2 GigaOhm ensuring that there were no electrical shorts between the surfaces.

Each experiment was preceded by evacuation of chamber 1125 in accordance with the following procedure. The chamber was sealed, vacuum was applied for at least 1 hour (to baseline pressure of at most 10⁻⁵ bar) while the grounded structure was heated to at least 100° C. to remove residual moisture. The chamber was periodically evacuated overnight at high vacuum while heated to T_{Ex} of 150° C., to further eliminate the possibility of outgassing contamination between experiments. The stabilization of the experimental setup was verified by ensuring a stable baseline pressure P_{b} and about null baseline current i_{b}. Unless otherwise stated, P_{b} was less than 10⁻⁵ bar and i_{b} was less than 0.1 pA.

For each experiment, the following parameters were varied and monitored: (i) type of gas fed into the previously evacuated chamber, (ii) pressure (P) in the chamber, (iii) temperature (T_{In}) of the internal heater, and (iv) temperature (T_{Ex}) of the wall of the chamber.

The resulting current or voltage across the structures for each set of parameters was measured and recorded at a sampling rate of approximately 1 measurement per second. Since the typical time scale for a single experiment was 10-50 hours, there were 10⁴-10⁵ measurements per run. The statistical error of the experiments is therefore marginal. The present inventor predicted negative current signal for experiments in which the charge transferability of the grounded structure is positive and the charge transferability of the non-grounded structure is negative. The present inventor also predicted a positive current signal for the opposite configuration (negative charge transferability for the grounded structure and positive charge transferability for the non-grounded structure).

Though the facing surfaces of structures 1101 and 1111 may each have in the following experiments a diameter of at least 2.5 cm and in some cases a theoretical overlapping area of about 20 cm² per pair, it is to be understood that the effective area might be less than the maximal theoretical overlapping area. For any pair of materials, it was found that the overlapping area is most effective when the adjacent surfaces are spaced apart (either through spacers or outwardly protruding roughness features), by a gap which does not exceed several multiples of the mean free path of the gas being used under the operational conditions. The proportion of the effective overlap between two surfaces depends on the geometry, shape, flatness, roughness and distribution of the protruding features of each surface.

### Experiment I

### Materials and Methods

Gadolinium (Gd; disc of 24.7 mm diameter and 1.5 mm thickness; 99.95% pure; Testbourne Ltd.) was used as the grounded structure, aluminum (Al; AL6061-T4; disc of 50 mm diameter and 12 mm thickness) was used as the non-grounded structure, and C₃F₈ (a gas having high electron affinity) was used as the gaseous medium. The measured work function in vacuum of gadolinium was 3.2 eV and of aluminum was 3.9 eV. Alumina microparticles (Al₂O₃; K.C.A.) with an average particle size of about 5 μm were spin coated from a suspension of 0.01% by weight in isopropanol at 2,000 RPM over the gadolinium disc resulting in highly dispersed spacers on the surface of the disc.

At the initial stage of the experiment, the chamber was evacuated and the internal heater was heated to 400° C. No external heating was applied to the chamber. Subsequently, 5, 11 and 23 mbars of C₃F₈ were injected into the chamber at three different time points.

This experiment using Gd and Al structures, was repeated under varying conditions, employing both electric configurations and various types of spacers and gases.

### Results

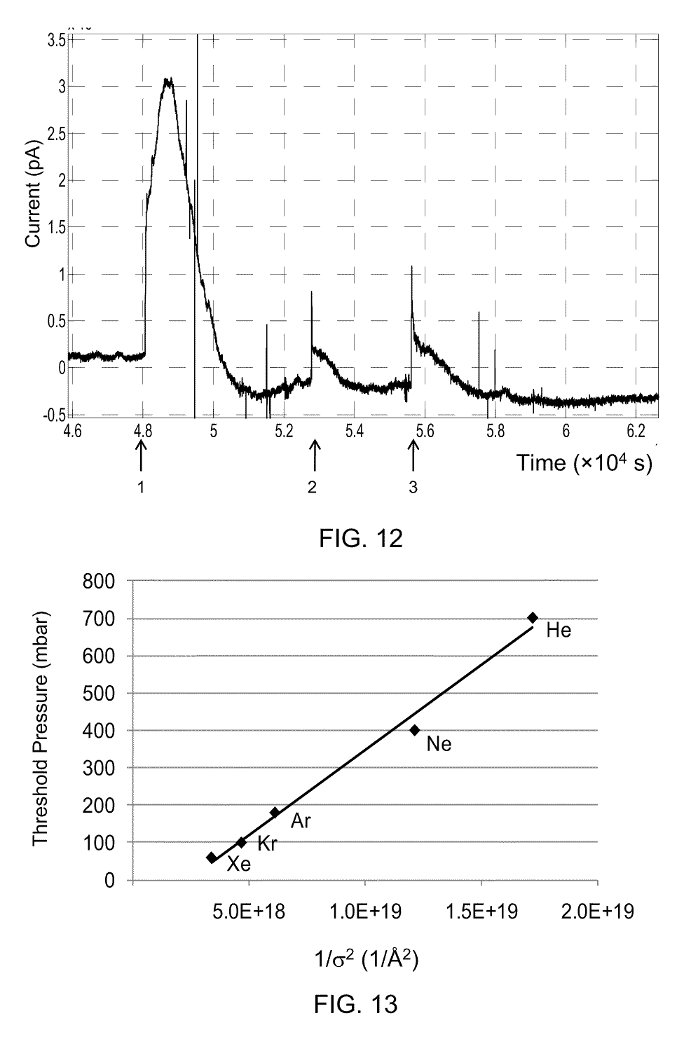

FIG. 12 shows measured current (pA) as a function of time (s). As shown in FIG. 12, after overnight evacuation the current under vacuum conditions was about +0.1 pA. Arrow 1 indicates the time point when 5 mbar of C₃F₈ was injected into the chamber. After a transient current increase of about 30 minutes, the current stabilized in the presence of gas to a negative value of about −0.2 pA. Arrow 2 indicates the time point when the pressure of the C₃F₈ was raised to 11 mbar. A short spike of positive current was again observed upon the modification of the measurement conditions, but thereafter the current stabilized back to a negative current of about −0.25 pA. Arrow 3 indicates when the pressure of the C₃F₈ gas was further increased to 23 mbar, yielding (after the transient positive peak) a stable negative current of about −0.4 pA. The fact that the observed current is negative indicates that the potential across the gadolinium-aluminum pair is negative. Because the standard reduction potential of these metals is −2.4 V for Gd and −1.67 V for Al, the setup described above would expected to provide a positive electrochemical current if the C₃F₈ gas were replaced by a liquid electrolyte. The measurement of a negative current thus rules out the possibility that the observed current results from electrochemical reactions.

FIG. 12 demonstrates that the current which was generated has a greater amplitude and opposite direction compared to the baseline current observed in vacuum conditions. FIG. 12 further demonstrates that the absolute value of the current was pressure dependent, in accordance with the principle of gas mediated charge transfer.

Results of additional experimental runs performed with this pair of materials positioned in reverse orientation within the chamber (Al grounded, Gd non-grounded), with different spacers and/or gases are shown in Table 6 below as entry Nos. 2 to 4.

### Experiment II

### Materials and Methods

MACOR® is a machineable glass-ceramic which comprises silicon dioxide (SiO₂), magnesium oxide (MgO), alumina (Al₂O₃), potassium oxide (K₂O), diboron trioxide (B₂O₃) and fluorine (F). In the macroscopic scale, the electrical conductivity of MACOR® at room temperature is about 10⁻¹⁵ S/m.

In the present experiment, MACOR® disc (50 mm in diameter, 3.5 mm in thickness, and roughness of less than 400 nm) was used as the grounded structure. Aluminum disc (Al; AL6061-T4; 50 mm in diameter and 12 mm in thickness) was used as the non-grounded structure. Each of the gases CF₄, C₃F₈, SF₆, N₂, and noble gases Argon (Ar), Helium (He), Krypton (Kr), Neon (Ne), and Xenon (Xe), all being at least 99.99% pure and dry, was separately used as a gas medium. The MACOR® and aluminum disc were positioned in the chamber in direct contact, without any spacers, with the material surface roughness providing the gap.

The internal heater was heated to 200° C. and no external heat was applied to the chamber. Each respective gas was injected after the chamber had been evacuated and after a baseline value of almost zero positive current had stabilized.

For each gas, the pressure was gradually increased. The current, once stabilized, was measured and recorded for each pressure.

This experiment, using MACOR® and aluminum structures, was repeated under varying conditions employing various combinations of gases, including Air (N₂:O₂:Ar:CO₂ ratio of about 78:21:0.9:0.04 by volume) and a combination of CF₄ and C₃F₈ at a 1:1 ratio by volume.

This experiment further included several experimental runs with thin glass discs (as described in Example 7, i.e. 50 mm in diameter, 100 μm in thickness, and less than 50 nm surface roughness) as the grounded structure. The electrical conductivity of glass at room temperature is about 10⁻¹² S/m. The glass disc was sputtered with aluminum on one side, as described in Example 7, to facilitate good contact to the ground terminal. The non-grounded structure in these runs was an aluminum disc (as described in Experiment I, i.e. 12 mm in thickness and 50 mm in diameter), and several of the above gasses as the gas medium. The glass disc was positioned with the uncoated side facing the aluminum disc. Additional runs were performed with a thin glass disc (same dimensions) sputtered with chromium on one side for contact to ground as the grounded structure and a chromium disc prepared by complete sputter coating of a float glass disc (230 nm Cr thickness, over glass substrate having 10 mm in thickness and 50 mm in diameter) as the non-grounded structure, and employing several of the above types of gas media.

### Results

In all cases, the measured current was positive, indicating that MACOR® served as electron acceptor while aluminum served as electron donor. A dependence of the absolute value of the current upon the gas pressure was observed. Specifically, for each gas, there was a first phase where current linearly increased with increasing pressure, until the current reached a maximum value and then over a range of pressures remained at a constant, or slowly decreased. In the present experiment, the term threshold pressure relates to the minimum pressure at which maximum current was first measured at the plateau phase. This observation is detailed in experiment XI described below. The threshold pressure and maximal current observed with a variety of pure and mixed gases are reported as entry Nos. 5-15 in Table 6 below.

FIG. 13 shows the threshold pressure (mbar) of some gases as a function of 1/σ², where σ is the diameter of the gas molecule in Angstroms. According to EQ. 1 above, the mean free path, λ, is linearly proportional to 1/σ². As shown in FIG. 13, there is a linear correlation (R²=0.9898) between the measured threshold pressure and 1/σ²: the lower the diameter of the gas molecule, the higher the pressure at which maximal current was observed.

The maximal currents and threshold pressures for experiments with a one side aluminum-sputtered thin glass disc as the grounded structure, a non-grounded aluminum disc opposed on the glass side without spacers, and pure gases at T_{In}=200° C. and T_{Ex}=70° C. are provided as entry Nos. 16-20 in Table 6, below. Similar results were obtained in experiments without spacers wherein the grounded structure was a thin glass disc chromium-sputtered on one side and the non-grounded structure was a chromium disc prepared by complete sputter coating of a flat glass, with pure gases at T_{In}=150° C. The external ribbon heater was not active. These results are reported as entry Nos. 21-23 in Table 6 below. Experiments performed with spacers are reported as entry Nos. 33-41 and are described hereinunder (see experiments III and VIII).

It can be noted that the fact that mixtures of gases are suitable (see entry Nos. 14-15 for the MACOR®-Aluminum configuration), was confirmed in a separate experiment where 811 mbar of dry air in an Aluminum-Glass configuration generated the current reported as entry No. 24 in Table 6.

Experiment II confirmed with a variety of gases that current is generated by gas mediated charge transfer between various surfaces. No current was observed in the absence of gas, confirming that there was no detectable thermionic contribution to the current. Pressure dependence of the current was observed. Without being bound to any theory, it is postulated that the threshold pressure value depends upon the relationship between the inter-surface gap and the mean free path of the gas. The fact that stable currents were observed using inert gases rules out contributions from gaseous chemical reactions. Experiment II further demonstrated that the operative surfaces of the cell device of the present invention can also be made from materials such as glass and MACOR®, which have relatively low conductivity. The results obtained with gas combinations demonstrate that the cell device of the present embodiments is operative also with mixtures of gases.

### Experiment III

### Materials and Methods

This experiment included several experimental runs, referred to below as runs (a)-(i), as follows. In run (a), a thin disc of lamellar phlogopite mica (50 mm in diameter, 50 μm in thickness) was used as the non-grounded structure. The phlogopite mica was sputtered on one side with Pd/Au to enhance electrical contact with conductive spring 1115. An aluminum disc (AL6061-T4, 40 mm in diameter, 3 mm in thickness) was used as the grounded structure. The grounded and non-grounded structures were in direct contact without spacers. The internal heater was heated to 400° C. The external heater was switched off. The chamber was evacuated and the baseline current under vacuum was less than 1 fA (i.e., less than 10⁻¹⁵ A). At this stage, 300 mbars of helium was injected into the chamber. The internal temperature was varied over an overall time period of about 80 hours, and the current was measured and recorded.

In run (b), doped nitrocellulose was used as the grounded structure; stainless steel (AISI303, disc of 40 mm diameter, 5 mm thickness) was used as the non-grounded structure, and argon gas at a constant pressure of 100 mbar was used as the gas medium. The grounded structure was prepared by spin coating an aluminum disc (AL6061-T4, having a diameter of 50 mm and a thickness of 12 mm) at 1,000 rpm with a solution of cyclohexanone comprising nitrocellulose based Zweihorn Zaponlack NR 10026 (Akzo Nobel Deco GmbH, 5% by weight of solvent) and LiClO₄ (40% by weight of Zaponlack). The grounded and non-grounded structures were in direct contact without spacers. T_{In} was gradually raised from about 25° C. to about 85° C.

In run (c), an aluminum disc (AL6061-T4, 50 mm in diameter and 12 mm in thickness) was used as the grounded structure, a thin glass disc (50 mm in diameter, 100 μm in thickness, less than 50 nm roughness, sputtered with aluminum for contact with the conducting spring) was used as the non-grounded structure, and helium at a constant pressure of 300 mbar was used as gas medium. The grounded and non-grounded structures were in direct contact without spacers. T_{Ex} was gradually raised from 60° C. to 100° C.

In run (d), MACOR® disc (50 mm in diameter, 3.5 mm in a thickness, and roughness of less than 400 nm) was used as the grounded structure, aluminum (AL6061-T4, as above) was used as the non-grounded structure, and 300 mbar argon was used as gas medium. The grounded and non-grounded structures were in direct contact without spacers. T_{In} was gradually raised from 100° C. to 200° C.

In run (e), thin glass disc (50 mm in diameter, 100 μm in thickness, and less than 50 nm surface roughness, sputtered on one side with chromium for contact with ground) was used as the grounded structure, and a flat thicker glass disc (50 mm in diameter, 10 mm in thickness, and less than 10 nm in roughness) completely sputter coated with a 230 nm layer of chromium was used as the non-grounded structure. The grounded and non-grounded structures were separated by alumina spacers having an average height of 3 μm. The spacers were spin coated on the glass surface as described in experiment I. T_{In} was gradually raised from 150° C. to 250° C., in the presence of xenon at a constant pressure of 130 mbar.

In runs (f) to (i), thin glass discs (50 mm in diameter, 100 μm in thickness, and less than 50 nm surface roughness, sputtered on one side with chromium for contact with ground) were used as the grounded structure. In run (f), the non-grounded structure was r-GO spin coated on a stainless steel disc as described in experiment XII. In run (g), the non-grounded structure was a disc of MnO₂ (thickness of 220 nm) prepared by complete sputter coating of a flat glass disc having a diameter of 40 mm, a thickness of 5 mm and a surface roughness of less than 10 nm. In run (h), the non-grounded structure was a disc of Molybdenum (thickness of 330 nm) prepared by complete sputter coating of a flat glass disc having a diameter of 40 mm, a thickness of 5 mm and a surface roughness of less than 10 nm. In run (i), the non-grounded structure was a disc of cermet made of Cr₃Si and SiO₂ (thickness of 540 nm) prepared by sputter coating of a thin glass disc having a diameter of 50 mm, a thickness of 100 μm in thickness, and less than 50 nm in surface roughness.

The grounded and non-grounded structures were in direct contact without any spacers. T_{In} was gradually raised from about 70° C. to about 180° C., in the presence of helium at a constant pressure of 1,100 mbar.

### Results

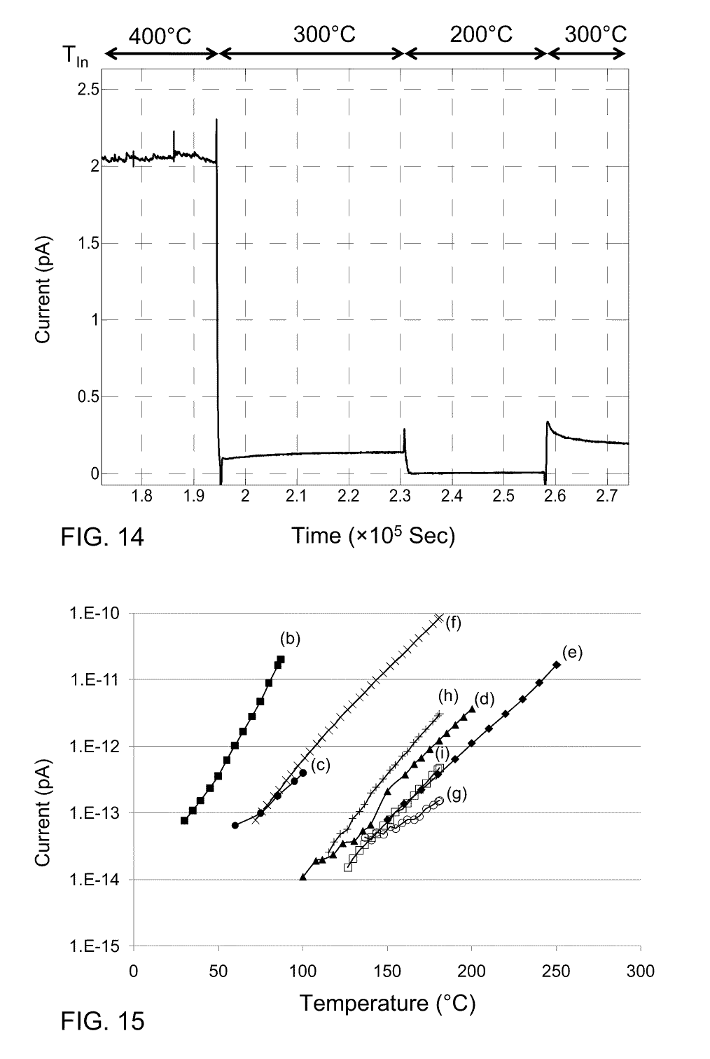

FIG. 14 shows the measured current in pA as a function of the time in seconds for run (a) with the phlogopite mica-aluminum pair. The internal temperatures at each time interval are indicated in the upper part of FIG. 14. When the internal temperature was 400° C., the measured current was about 2.1 pA for at least 7 hours. At t=194.500 s (about 54 hrs), the temperature of the internal heater T_{In} was decreased to 300° C. and the current dropped to about 0.2 pA where it remained stable for about 10 hours of measurement. Further cooling to 200° C. at t=231,000 s (about 64 hrs), resulted in a current drop to about 4 fA. At t=280,000 s (about 78 hrs), the temperature was raised back to 300° C. and the current increased to about 0.25 pA, close to the value previously obtained at this temperature.

In this configuration, the current direction was positive, indicating that the aluminum acted as an electron acceptor whereas the phlogopite mica acted as an electron donor. This experiment confirmed that bulk insulators can be used in the devices and methods of the invention. It is noted that the measured currents were stable for hours over the time windows of the measurements. The fact that the current is temperature-dependent is in accordance with the gas mediated charge transfer mechanism discovered by the present inventor.

FIG. 15 shows the measured current in absolute values (Amperes) as a function of the temperature (° C.) for runs (b)-(i).

The squares in FIG. 15 correspond to run (b) with the doped nitrocellulose-stainless steel pair. As shown, the gradual increase of T_{In} from about 25° C. to about 85° C. resulted in a current increase from about 76 fA to 20 pA. It is noted that the low current measured at about room temperature was above the baseline current (1 fA) measured under vacuum conditions.

The circles in FIG. 15 correspond to run (c) with the aluminum-thin glass pair. As shown, the gradual increase of T_{Ex} from 60° C. to 100° C. resulted in a current increase from 65 fA to 0.4 pA.

The triangles in FIG. 15 correspond to run (d) with the MACOR®-aluminum pair. As shown, the gradual increase in T_{In} from about 100° C. to about 200° C. resulted in a current increase from 11 fA to 3.67 pA.

The diamonds in FIG. 15 correspond to run (e) with the thin glass-chromium pair. As shown, the gradual increase in T_{In} from about 150° C. to about 250° C. resulted in a current increase from 78 fA to 17 pA. These results are shown as entry Nos. 25-29 in Table 6.

The crosses in FIG. 15 correspond to run (f) with the thin glass-r-GO pair. As shown, the gradual increase in T_{In} from about 72° C. to about 180° C. resulted in a current increase from 78 fA to 86 pA. The empty circles correspond to run (g) with the thin glass-MnO₂ pair. As shown, the gradual increase in T_{In} from about 136° C. to about 180° C. resulted in a current increase from 43 fA to 0.16 pA.

The plus signs in FIG. 15 correspond to run (h) with the thin glass-Mo pair. As shown, the gradual increase in T_{In} from about 111° C. to about 180° C. resulted in a current increase from 15 fA to 3 pA. The empty squares correspond to run (i) with the thin glass-(Cr₃Si—SiO₂) pair. As shown, the gradual increase in T_{In} from about 126° C. to about 180° C. resulted in a current increase from 15 fA to 0.48 pA. These results are shown as entry Nos. 63-66 in Table 6.

These experiments demonstrate that the temperature dependence of the measured current is generally similar, and roughly exponential, irrespective of the technique employed for heating (internal heating in runs (b), (d) to (i), and external heating in run (c)). This confirms that the measured current does not result from any minor temperature gradient which may exist between the surfaces when heating only the lower surface, but from the temperature of the gas itself.

The fact that stable currents were observed using inert gases rules out contributions from gaseous chemical reactions. The results of run (b) demonstrate that a single pair of structures is sufficient to generate measurable current sufficiently above noise level at room temperature. Furthermore, extrapolation of any of the curves in FIG. 15 suggests that measurable current sufficiently above noise level can be generated from a single pair at room temperature or below for any of runs (b)-(i). It is evident that the use of a plurality of such pairs in a serial stack will increase the generated electrical potential across the stack and a plurality of such pairs in parallel will increase the current.

### Experiment IV

This experiment was directed to confirm the prediction that reversing the two structures results in a reversal of the current direction. The experiment was similar to experiment III, run (c), except that the glass disc was used as the grounded structure and the aluminum disc was used as the non-grounded structure. Following chamber evacuation, 300 mbar of helium was injected while the chamber was externally heated to T_{Ex}=60° C. The resulting current was −100 fA which is opposite in sign, and of generally similar magnitude, to the current measured in run (c) of experiment III (+65 fA). The results of the reversed structures are reported as entry Nos. 27 and 30 in Table 6. This finding confirms that the measured current stems from the difference between the two surfaces and their interaction with the gaseous medium and not from an undesired experimental effect. The differences in absolute value between the two currents may be attributed to numerous factors, such as the slight difference in gap dimension and overlap area.

### Experiment V

### Materials and Methods

A thin glass disc (50 mm in diameter, 100 μm in thickness, and less than 50 nm in roughness) was sputtered on one side with aluminum as described in Example 7. A stack of ten such aluminum sputtered glass discs was placed in the chamber such that for every two adjacent discs, the sputtered side of one disc contacted the exposed (non-sputtered) side of the other disc. The lowermost disc was positioned such that its sputtered side was facing the internal heater and was grounded, and its exposed side was facing the second to lowermost disc. Thus, in this experiment, the grounded side was glass and the non-grounded side was aluminum. Helium was used as the gas medium.

Following evacuation of the chamber, the internal heater was heated to 200° C., and 300 mbar of helium was injected. The voltage signal was measured and recorded. This procedure was repeated for a single glass-aluminum pair.

### Results

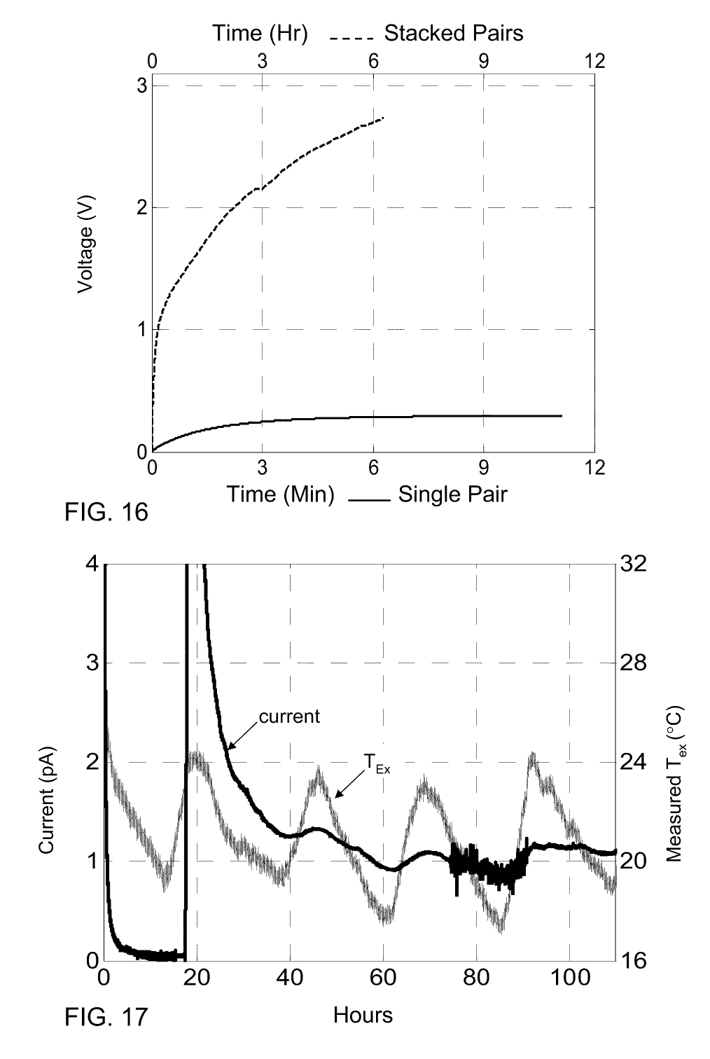

FIG. 16 shows the voltage as a function of time for a single pair of structures (continuous line) and for a stack of ten pairs (dashed line). The origin (t=0) corresponds to the time point at which the experimental setup was switched from short circuit for current measurements to open circuit for voltage measurements. The time is shown in minutes for the single pair (bottom axis) and hours for the stack (upper axis), since the stack has higher resistance. It is noted that the overall capacitance of the experimental setup is dominated by the measuring device which was the same for all experiment runs. Thus, while the overall resistance is significantly higher for the stack than for the single pair, the capacitance is generally the same for both cases. Since the characteristic response time is proportional to the resistance multiplied by the capacitance, the response time of the stack is significantly higher than the response time of a single pair.

As shown in FIG. 16, the accumulated voltage for the stack approaches 3V after 6 hours, while the accumulated voltage for the single pair approaches 0.3V after 6 minutes. The ratio between these voltages is 10:1, which is the same as the ratio between the number of cells in the stack run (10) and the number of cell in the single pair run (1). This finding supports the conclusion that the measured voltage results from the electrical potential generated by each gas-filled cell and not from any undesired experimental effects.

### Experiment VI

In this experiment the accumulated voltage was measured for three different donor-acceptor structure pairs. In a first run, a Glass-aluminum pair was employed, in a second run an aluminum-MACOR® pair was employed and in a third run a Glass-MACOR® pair was employed. In all runs, the internal heater was heated to 200° C. and, following chamber evacuation, 300 mbar of helium was injected.

The first run yielded a voltage plateau of about 0.3 V. The aluminum served as electron donor and the glass served as electron acceptor. The second run yielded a voltage plateau of about 0.9 V. The MACOR® served as electron donor and the aluminum served as electron acceptor. The third run yielded a voltage plateau of about 1.15 V. The MACOR® served as electron donor and the glass served as electron acceptor.

It is demonstrated that the accumulated voltage measured using the Glass-MACOR® pair (1.15 V), approximately equals the sum of voltages measured using the Glass-aluminum pair (0.3 V) and an aluminum-MACOR® pair (0.9 V). The fact that the voltage is additive confirms that the measurements result from the gas mediated charge transfer occurring between the surfaces, and not from the external circuit.

### Experiment VII

### Materials and Methods

It was demonstrated in the previous experiments (see e.g., experiment III, particularly FIGS. 14 and 15) that the generated current was stable for periods of at least several hours, and that the current depended on T_{In} or T_{Ex}. In the present experiment, both T_{In} and T_{Ex} were monitored over more than 4 days. The grounded structure in this experiment was an aluminum disc spin coated by LiClO₄-doped nitrocellulose, the non-grounded structure was a disc of stainless steel (40 mm in diameter, 5 mm in thickness), and argon was used as the gas medium.

The internal heater was heated to 80° C., the chamber was evacuated and the baseline current stabilized at about 0.1 pA. After approximately 17 hours, 100 mbar of argon was injected and the system was monitored for four days under these conditions.

### Results

FIG. 17 shows the current and external temperature T_{Ex} as a function of time. The current is indicated in pA on the left ordinate, T_{Ex} is indicated in degrees centigrade on the right ordinate, and the time is indicated in hours on the abscissa. The current and external temperatures were recorded at the same time points. In FIG. 17, the time period from t=0 to t=19 hours corresponds to the initial evacuation of air from the chamber for stabilization. The experiment began with the introduction of argon into the chamber at t=19 hours.

A transient current peak was observed upon introduction of the gas into the chamber. Approximately 20 hours thereafter, the system reached a steady state and the current generally stabilized to a value of about 1 pA. Current fluctuations were observed as the chamber temperature varied. When the chamber was at about 24° C., the current level was about 1.25 pA, decreasing to about 0.8 pA when the chamber temperature dropped to about 18° C. after about 12 hours.

This experiment confirms that once a steady state is reached, the current is generally stable (with sub picoamperes fluctuations) over several days. This experiment also demonstrates the dependence of the current on temperature. Assuming an average current of 1.0 pA at an average temperature of about 21° C., the present experiment shows that fluctuations of ±3° C. in chamber temperature can result in variations of about ±20% in measured current. Results are shown as entry No. 31 in Table 6. There is a difference between entry Nos. 26 and 31 of Table 6, which may be attributable to several factors, such as slight differences in gap dimensions and differences in the thickness of the doped nitrocellulose coating.

### Experiment VIII

This experiment was directed to the investigation of the dependence of the electrical current (and pressure at which maximal current is obtained) on the size of the gap between the two surfaces.

Broadly speaking, there are two conditions for the generation of electricity by the device of the present embodiments: charge transfer between the gas and the solid surfaces and successful traversal of the gap between the surfaces by the charged gas molecules. The probability of charge transport by the gas molecules is greater for smaller gaps (provided the gap is sufficiently large to allow the gas molecules to enter). Thus, all else being equal, smaller gaps will generate higher electrical currents and maximum current will be achieved at higher pressure.

### Materials and Methods

This experiment included nine experiment runs, referred to below as runs (a)-(i), as follows.

In runs (a) to (c), the grounded structure was thin glass disc (50 mm in diameter, 100 μm in thickness, less than 50 nm roughness) sputtered on one side with chromium, and the non-grounded structure was a flat glass disc (50 mm in diameter, 10 mm in thickness, less than 10 nm in roughness) completely sputter coated with a 230 nm layer of chromium, as described in experiment III run (e). The one-side coated glass disc was positioned in the chamber with its coated side connected to the ground terminal, and its uncoated side facing the completely coated chromium disc. The two structures were separated by alumina (Al₂O₃) spacers having an average height of 3 μm. The alumina spacers were spin coated on the thin glass surface as described in experiment I above. In run (a) the gas medium was xenon, in run (b) the gas medium was argon, and in run (c) the gas medium was helium.

Runs (d) to (f) were the same as runs (a) to (c), respectively, but with alumina spacers having an average height of 1 μm.

Runs (g) to (i) were the same as runs (a) to (c), respectively, but without spacers. For these runs, the gap size is not 0, but corresponds to the average roughness of the surfaces.

All runs were conducted at T_{In}=150° C. Run (a) corresponds to the lowest temperature point in the curve described in experiment III run (e), where the relation between T_{In} and the measured current was established over the internal temperature range of 150 to 250° C. Three more runs similar to (a)-(c), but with alumina spacers having an average height of 7 μm were performed at T_{In}=250° C. In each run, the threshold pressure was determined and the maximal current recorded. These measurements are shown in Table 6 as entry Nos. 21-23 and 32-41.

### Results

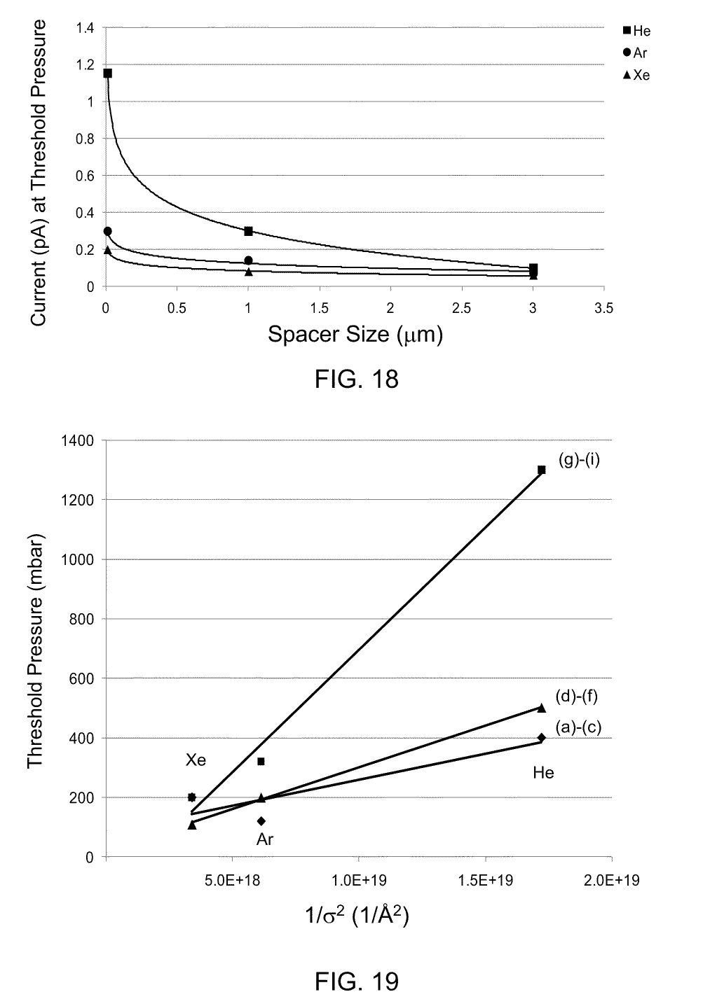

FIG. 18 shows the current (pA) measured at threshold pressure as a function of the spacing (μm) for each of the three gases used. The squares correspond to helium (σ=2.4 Å), the circles to argon (σ=4.0 Å), and the triangles to xenon (σ=5.4 Å). As shown, the current decreased with increasing spacing. The non-linearity of the dependence on gap size leads the present inventor to conclude that a further reduction of the gap size will result in much higher electrical currents. FIG. 18 also demonstrates that the smaller the diameter of the gas molecule, the higher the current measured at threshold pressure, consistent with the gas mediated charge transfer model pursuant to which smaller molecules have a larger mean free path, hence a higher probability of transporting charge across a given gap.

FIG. 19 shows the threshold pressures (mbar), at which maximal currents were first measured at the plateau phase, as a function of 1/σ², where a is the diameter of the gas molecule in Angstroms. In FIG. 19, diamonds correspond to runs (a)-(c) namely with 3 μm spacers, triangles correspond to runs (d)-(f) namely with 1 μm spacers, and squares correspond to runs (g)-(i) namely without spacers. Note that there is an overlap between the data points corresponding to runs (a) and (g) namely the runs with 3 μm spacers and no spacers performed with xenon.

As shown, there is a linear correlation between the threshold pressure and 1/σ²: the smaller the diameter of the gas molecule, the higher the threshold pressure, consistent with the results of experiment II presented above. FIG. 19 also shows that there is an anti-correlation between the gap size and the threshold pressure: larger gap size needs lower pressure to generate maximal current.

### Experiment IX

This was a control experiment in which electrochemically derived currents were deliberately generated. To this end, water vapor was used as the gas medium. Unlike other gases such as those described above, water can be in liquid phase at the temperatures and pressures at which the experiments were performed.

### Materials and Methods

A thin glass disc (100 μm in thickness, 50 mm in diameter, and less than 50 nm in roughness) was used as the grounded structure. The glass disc was sputtered with aluminum on one side for facilitating good contact to the ground terminal. The non-grounded structure in these runs was an aluminum disc (7 mm in thickness and 40 mm in diameter), and water vapor was used as the gas medium. The glass disc was positioned with the uncoated side facing the aluminum disc without spacers.

The internal heater was set to 60° C. and the pressure was set to 7 mbar so as to ensure that there is no water condensation in the chamber. Thereafter, the pressure was set to 27 mbar while maintaining the internal heater at 60° C. so as to induce water condensation. The current was monitored and recorded throughout the experiment.

### Results

The current measured in the presence of 7 mbar water vapor was +0.6 pA, whereas the current measured at the higher pressure of 27 mbar was −12 pA (see Table 6, entry Nos. 42-43). The 27 mbar pressure corresponds to the pressure achieved by saturating the chamber with water vapor to its vapor pressure at room temperature. The direction of the current in the water condensation mode is consistent with electrochemically based current, while the direction of the current in the absence of water condensation is opposite. This experiment demonstrates that the current generated when the inter-surface gap is filled by a non-condensed gas does not originate from an electrochemical process.

### Experiment X

This experiment was directed to determine the power generation region and to find the optimal working points (current and voltage) where maximal power is obtained using a device or method of the invention.

### Materials and Methods

The experimental setup (see FIG. 11) was slightly modified and a DC voltage source (Yokogawa 7651) was connected between structure 1101 and ground 1109. The DC voltage source is not shown in FIG. 11. Voltage was applied and current was monitored through external electrometer 1117 connected to second structure 1111. Two experiment runs were performed. In run (a), a silica disc (SiO₂ sputtered at a thickness of 600 nm on a flat glass disc having a diameter of 40 mm, a thickness of 5 mm and a roughness of less than 10 nm, previously precoated with aluminum for contact to ground) was used as the grounded structure, and manganese dioxide (220 nm sputtered on a thin glass disc having a diameter of 50 mm, a thickness of 100 μm and a roughness of less than 50 nm, pre-sputter coated with aluminum) served as non-grounded structure. The manganese dioxide faced the silica side of the grounded structure without any spacers. In run (b), a thin glass disc having a diameter of 50 mm, a thickness of 100 μm and a roughness of less than 50 nm, sputtered on one side with aluminum for contact to ground was used as grounded structure and reduced graphite oxide (r-GO) spin coated on a stainless steel disc having a diameter of 52 mm and a thickness of 5 mm served as non-grounded structure. The preparation of the r-GO disc is further detailed below (see example XII). The r-GO faced the glass side of the grounded structure without any spacers. For runs (a) and (b), the internal heater was heated to 180° C. and following chamber evacuation, helium, which served as the gas medium, was injected at 1,100 mbar.

### Results

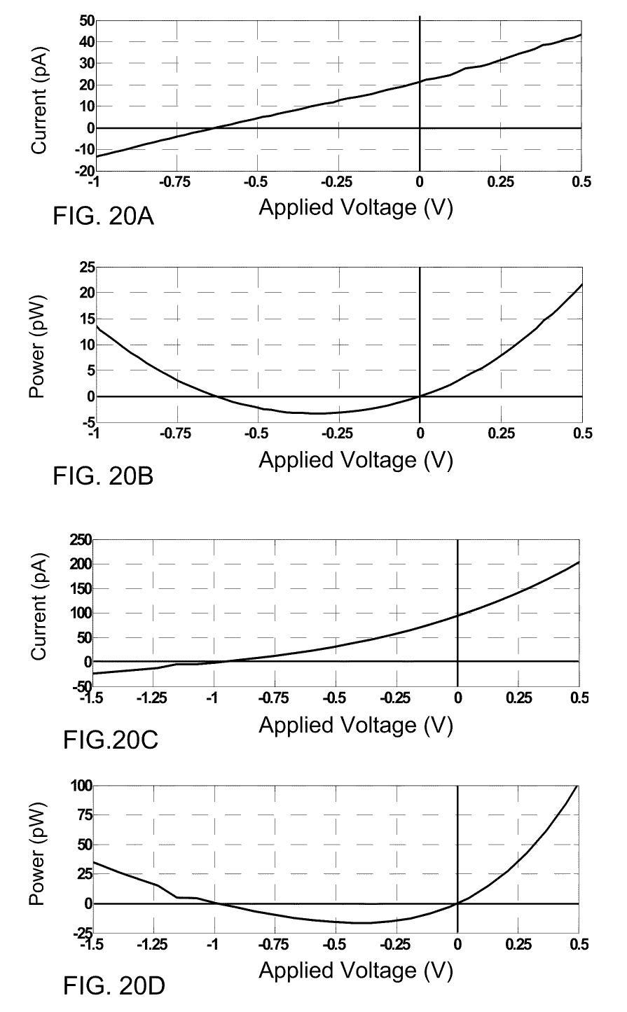

FIGS. 20A and 20C show the measured current I in picoamperes as a function of the applied voltage V in volts, and FIGS. 20 B and 20D show the calculated power p in picowatts (p=I·V) as a function of the applied voltage V. FIGS. 20A and 20B relate to run (a), and FIGS. 20C and 20D relate to run (b).

As shown in FIG. 20A, the short circuit current in run (a) when no voltage is applied is about 21.5 pA, whereas the open circuit voltage is −0.63 V when the current is 0 pA. As shown in FIG. 20B, power is generated between applied voltage of −0.63 to 0 V and the maximal obtained power in absolute value is of about 3.3 pW at applied voltage V of about −0.34 V. As shown in FIG. 20C, the short circuit current in run (b) when no voltage is applied is about 94 pA, whereas the open circuit voltage is −1 V when the current is 0 pA. As shown in FIG. 20D, power is generated between applied voltage of −1 to 0 V and the maximal obtained power in absolute value is of about 16.3 pW at applied voltage V of about −0.4 V. Thus, in the range of 0 to −0.63 volts for run (a) and in the range of 0 to −1 volts for run (b), the resistance is negative, and the system operates as an electrical generator. The results of the present experiment demonstrate that the device of the invention generates electrical power from thermal motion of gas molecules.

### Experiment XI

This experiment was directed to measure the current values as a function of pressure to determine the threshold pressure where maximal current is obtained using the teachings of the present application.

### Materials and Methods

The grounded and non-grounded structures were the same as the thin glass and chromium structures used in experiment VIII described above. T_{In} was set to 200° C., T_{Ex} to 50° C., and helium was used as the gas medium. Following chamber evacuation and stabilization of null baseline current, helium was injected at pressure steps of 50 mbar from 50 to above 1,200 mbar. At the first pressure step, the system was allowed to stabilize for at least two hours and the current was then recorded. At each following pressure step, the current was allowed to stabilize and was then recorded. In this experiment, a stabilization period of 15 minutes was sufficient, since the measurements began at a pressure of 50 mbar and not in vacuum, and since small pressure steps of 50 mbar were applied.

### Results

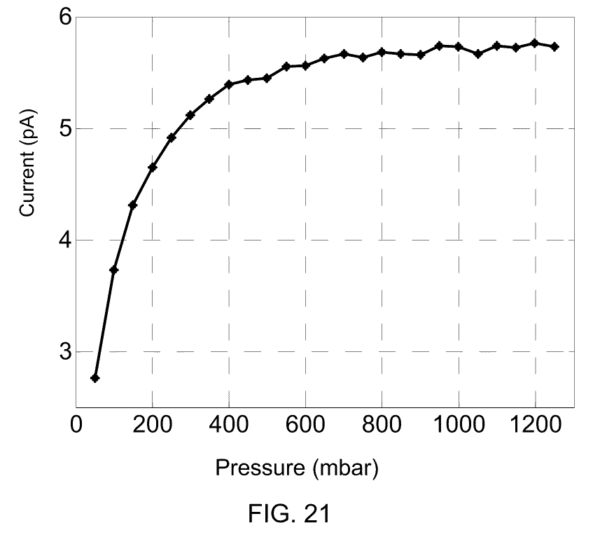

FIG. 21 shows the measured current (pA) as a function of the gas pressure (mbar). As shown in FIG. 21, the current monotonically rises from about 2.7 pA to about 5.7 pA in a first phase where pressure is gradually increased from 50 to about 700 mbar in a increments of 50 mbar. In a second phase, from about 700 to about 1,250 mbar, the current reaches a plateau as a function of pressure.

The observed pressure dependence is in accordance with the gas mediated charge transfer mechanism discovered by the present inventor. The generated current is increased with pressure up to a pressure where the mean free path of the gas molecules is smaller than the gap between the two surfaces. Increasing the pressure above this point also increases the probability of collision between gas molecules before they can transport their charge across the gap to the second surface, but also increases the number of molecules able to transfer said charges. There is therefore a balance between the intermolecular collisions, which reduce the rate of charge transport per molecule, and the total number of molecules, which increases the overall amount of gas mediated charge being transferred. It is believed that FIG. 21 demonstrates such balance. The two conflicting effects appear to counterbalance one another, so that above the threshold pressure the current is no longer, or only weakly, dependent upon gas pressure.

The monotonically increasing part of the graph corresponds to pressures yielding a mean free path larger than the gap size. As explained in Example 1, under the condition of λ>d the number of molecules interacting with the surfaces per unit time is expected to be linearly dependent upon pressure. The plateau part of the graph corresponds to pressures yielding a mean free path smaller than the gap size. The threshold pressure can be defined as the lowest pressure at which the current no longer significantly increases with pressure. It is possible that for certain combinations of surface materials, gases and operating conditions, the current may decline with increasing pressure, rather than stabilizing at a plateau. In the present experiment, FIG. 21, the threshold pressure is about 700 mbar.

### Experiment XII

Experiment III run (a) indicated that lamellar materials can be used as surfaces. This was demonstrated when one of the surfaces was made of the poorly conductive mineral phlogopite mica, a natural silicate compound. In the present experiment, the lamellar material used was electrically conductive reduced graphite oxide (r-GO), which corresponds to graphene, the single layers which comprise graphite.

### Materials and Methods

Graphite (Asbury graphite 3763 having a flake size in the range of about 25-75 μm) was oxidized using the method of Hirata (see e.g., U.S. Pat. No. 6,596,396). The resulting Graphite Oxide (GO) was cleaned, washed and concentrated using Microza® membrane filtration (Pall Corp., UMP-1047R). AFM scans established that the GO nanoplatelets so obtained had thicknesses ranging from single GO sheets of about 1 nm thickness to multiple sheets, with an overall average thickness of about 3 nm.

The GO was then thermally reduced to graphene by overnight heating at 230° C. in vacuum, achieving reduced GO expected to comprise only 15-20% remaining functional groups. The r-GO was dispersed in a solution of 1% acetic acid at a weight concentration of 0.4%.

A polished D2 steel disc, having a diameter of 52 mm, a thickness of about 5 mm, and less than 50 nm roughness, served as a support surface. The periphery of the disc was machined to avoid r-GO thickness buildup during coating. The disc, first cleaned with isopropanol, was pre-coated with a thin layer of adhesive primer (supernatant of Microlite HST-XE 20). The pre-coated disc was placed on a spin coater and wetted with the suspension of r-GO. The disc was then spun at 1,200 RPM. The thin resultant coating of r-GO (graphene) was dried while spinning with a hot air blower at a temperature not exceeding 80° C. When the layer appeared dry, the spin coating procedure was repeated until a total of 9 grams of r-GO suspension were used. Spin coating was used to ensure that the lamellar graphene layers were being built up as an oriented layered coating.

The layered r-GO spin-coated disc was then further dried for 24 hours at 95° C. in a vacuum oven. Following this preliminary drying step, the disc was transferred to a furnace (Ney Vulcan 3-1750) where it was heated in 20° C. increments for a period of 2 hours each, until the temperature reached 230° C., at which it was left for a final 10 hours bake to ensure complete drying. Thereafter, it was stored in a dessicator until use.

A thin glass disc (diameter of 50 mm and thickness of 100 μm, sputtered on one side with aluminum for contact with ground) was used as the grounded structure and the r-GO disc served as non-grounded structure (where the r-GO faced the glass without any spacers and the stainless steel substrate served as contact to the external circuit). T_{In} was set to 180° C. and, following chamber evacuation and establishment of null baseline current, helium was used as the gas medium.

### Results

In the presence of 1,100 mbar of helium, the measured current was about +150 pA, as reported as entry No. 59 in Table 6 below. In the present setup, glass served as the electron acceptor and r-GO as the electron donor. This experiment demonstrates that lamellar materials can be used in the device of some embodiments of the present invention.

### Experiment XIII

The above experiments established that various materials having wide range of bulk conductivity are suitable for the surfaces of the device of some embodiments of the invention. In the present experiment, surfaces made of semiconductors were studied in seven experimental runs.

### Materials and Methods

In run (a), a disc of phosphorous doped silicon wafer (double side polished, having a diameter of 50.8 mm, a thickness of 300 μm, and a roughness of less than 1 nm), with a <100>surface crystallographic orientation and an electrical resistivity of 8-12 Ω·cm was used as the grounded structure.

In run (b), a disc of boron doped silicon wafer having the same dimensions and crystallographic orientation, but a resistivity of 0.1-1.2 Ω·cm, was used as the grounded structure.

In both runs (a) and (b), a disc of aluminum (200 nm thickness sputtered on a flat glass disc of 40 mm diameter and 5 mm thickness) was used as the non-grounded structure.

In run (c), the silicon wafer discs of runs (a) and (b) were paired, namely the above described disc of phosphorous doped silicon wafer was used as the grounded structure and the boron doped silicon wafer disc was used as the non-grounded structure.

In run (d), a disc of phosphorous doped silicon wafer (double side polished, having a diameter of 50.8 mm, a thickness of 140 μm, a roughness of less than 1 nm) with a <110> surface crystallographic orientation and a resistivity of 0.7-1.3 Ω·cm, was used as the grounded structure and a disc of gadolinium (560 nm thickness sputtered on a flat glass disc of 40 mm diameter and 5 mm thickness) was used as the non-grounded structure.

In all of runs (a)-(d), the grounded and non-grounded structures faced one another without spacers. Helium was used as the gas medium at a constant pressure of 1,100 mbar and the internal temperature T_{In} differed for each run as detailed below, but always comprised a common point at 200° C.

In runs (e)-(g), a disc of aluminum as in runs (a)-(b) served as the grounded structure and a disc of phosphorous doped silicon wafer as in run (a) served as the non-grounded structure. Alumina spacers having an average height of 7 μm were spin coated on the grounded structure as described in experiment I. The internal heater was set at T_{In}=250° C. and the external heater was set at T_{Ex}=70° C. The gas medium was injected, following chamber evacuation, at a constant pressure of 1,100 mbar. The gas medium was xenon in run (e), argon in run (f) and helium in run (g).

### Results

The results of the experiment are listed in entry Nos. 44-50 of Table 6 below. As shown in entry Nos. 44-47, when at least one of the surfaces used without any spacers is made of a semiconductor material, the measured current dramatically increased by orders of magnitude to the nanoampere range. In run (a), increasing T_{In} from 150° C. to 200° C. increased the current from 8.5 nA to 52 nA. In run (b), the same increase in internal temperature raised the current from −2.7 to −15 nA. The negative current indicates that in this setup the boron doped silicon wafer served as electron donor. In run (c), the pair comprising two silicon wafers differently doped was tested at T_{In}=200° C. and the measured current was 0.9 nA.

As shown in entry Nos. 48-50, when spacers were used between the metal and semiconductor surfaces, the measured current was 0.24 pA when the gas medium was xenon, and 1 pA when the gas medium was argon or helium. Though the presence of spacers caused a dramatic drop in the measured current, it was still significant. These experiments demonstrate that semiconductor materials can be used in the device of some embodiments of the present invention. One advantage of materials having midrange bulk conductivity, such as semiconductors, is that they are sufficiently conductive to transport current, and sufficiently non-conductive to be used without any spacers.

### Experiment XIV

In the present experiment, in situ surface activation by electrodeposition according to some embodiments of the present invention was studied.

### Materials and Methods

A thin glass disc sputtered with chromium on one side for contact (50 mm diameter, 100 μm thickness, and less than 50 nm surface roughness) was used as the grounded structure. A r-GO disc (prepared as described in experiment XII) was used as the non-grounded structure. A solution of Isopar® L containing as the electroactive specie 0.01% per weight of Sodium Petronate® L (Witco) was placed on the glass surface. The r-GO was placed above the non polar solution without any spacers. In a first stage, the non-grounded r-GO structure was connected through its steel support to the positive terminal of a voltage source and +100V was applied for two hours at room temperature.

Following electrodeposition, the activated cell, while remaining under voltage bias, was heated to T_{In}=120° C. and the chamber was evacuated for 10 hours to remove the Isopar® L based solution and any residual moisture. The cell was fully discharged by short circuiting the surfaces, thus establishing a null baseline current. Helium was injected as the gas medium at constant pressure of 1,100 mbar.

### Results

As shown in Table 6 below, in entry No. 61, when at least one of the surfaces was activated by the electrodeposition process, the measured current was about 130 pA. It is noted that at the same temperature of about 120° C., the non-activated cell of glass-r-GO generated a current of about 2 pA. This experiment demonstrates that activation of the surfaces according to some embodiments of the present invention caused a significant increase of about two orders of magnitude in the generated current.

It is noted that in all of the above experiments, there was no drop in gas pressure, indicating that no gas was consumed through gaseous reaction.

Table 6 summarizes the results obtained in experiments I-XIV and other experiments performed using the setup of FIG. 11. In Table 6, NA indicates that a given entry is not applicable. Glass indicates that the surface used was a thin glass disc having a diameter of 50 mm, a thickness of 100 μm and a roughness of less than 50 nm. The temperatures shown relate to T_{In} and/or T_{Ex} as applicable.

TABLE 6

| | | Non- | | | Measurement Conditions | | | | |
|---|---|---|---|---|---|---|---|---|---|
| | Grounded | Grounded | | | P (mbar) | | | Measured | |
| | Structure | Structure | | | T_{In} (° C.) | | | Current | |
| No. | Surface | Surface | Spacers | Gas | T_{Ex} (° C.) | | | (pAmp) | |
| 1 | Gadolinium | Aluminum | Alumina, | C₃F₈ | P | 5-23 | mbar | −0.2 to −0.4 | |
| | | | 5 μm | | T_{In} | 400° | C. | pA | |
| 2 | Aluminum | Gadolinium | Alumina, | Helium | P | 400 | mbar | +0.06 | pA |
| | | | 3 μm | | T_{In} | 200° | C. | | |
| 3 | Aluminum | Gadolinium | Alumina, | C₃F₈ | P | 7 | mbar | +0.15 | pA |
| | | | 1 μm | | T_{In} | 230° | C. | | |
| | | | | | T_{Ex} | 50° | C. | | |
| 4 | Aluminum | Gadolinium | Mica | C₃F₈ | P | 10 | mbar | +0.13 | pA |
| | | | flakes, | | T_{In} | 180° | C. | | |
| | | | 300 nm | | | | | | |
| 5 | Macor ® | Aluminum | NA | Argon | P | 135 | mbar | +1.9 | pA |
| | | | | | T_{In} | 200° | C. | | |
| 6 | Macor ® | Aluminum | NA | Helium | P | 525 | mbar | +4.0 | pA |
| | | | | | T_{In} | 200° | C. | | |
| 7 | Macor ® | Aluminum | NA | Krypton | P | 75 | mbar | +1.3 | pA |
| | | | | | T_{In} | 200° | C. | | |
| 8 | Macor ® | Aluminum | NA | Neon | P | 300 | mbar | +1.9 | pA |
| | | | | | T_{In} | 200° | C. | | |
| 9 | Macor ® | Aluminum | NA | Xenon | P | 45 | mbar | +0.5 | pA |
| | | | | | T_{In} | 200° | C. | | |
| 10 | Macor ® | Aluminum | NA | N₂ | P | 113 | mbar | +2.2 | pA |
| | | | | | T_{In} | 200° | C. | | |
| 11 | Macor ® | Aluminum | NA | SF₆ | P | 30 | mbar | +1.6 | pA |
| | | | | | T_{In} | 200° | C. | | |
| 12 | Macor ® | Aluminum | NA | CF₄ | P | 53 | mbar | +1.7 | pA |
| | | | | | T_{In} | 200° | C. | | |
| 13 | Macor ® | Aluminum | NA | C₃F₈ | P | 22 | mbar | +1.3 | pA |
| | | | | | T_{In} | 200° | C. | | |
| 14 | Macor ® | Aluminum | NA | CF₄ + | P | 12.5 | mbar | +1.7 | pA |
| | | | | C₃F₈ | T_{In} | 200° | C. | | |
| 15 | Macor ® | Aluminum | NA | Air | P | 225 | mbar | +2.6 | pA |
| | | | | | T_{In} | 200° | C. | | |
| 16 | Glass | Aluminum | NA | Argon | P | 170 | mbar | +2.3 | pA |
| | | | | | T_{In} | 200° | C. | | |
| | | | | | T_{Ex} | 70° | C. | | |
| 17 | Glass | Aluminum | NA | Krypton | P | 120 | mbar | +2.0 | pA |
| | | | | | T_{In} | 200° | C. | | |
| | | | | | T_{Ex} | 70° | C. | | |
| 18 | Glass | Aluminum | NA | Helium | P | 1,000 | mbar | +3.0 | pA |
| | | | | | T_{In} | 200° | C. | | |
| | | | | | T_{Ex} | 70° | C. | | |
| 19 | Glass | Aluminum | NA | Xenon | P | 135 | mbar | +1.4 | pA |
| | | | | | T_{In} | 200° | C. | | |
| | | | | | T_{Ex} | 70° | C. | | |
| 20 | Glass | Aluminum | NA | CH₄ | P | 170 | mbar | +3.5 | pA |
| | | | | | T_{In} | 200° | C. | | |
| | | | | | T_{Ex} | 70° | C. | | |
| 21 | Glass | Chromium | NA | Argon | P | 320 | mbar | +0.3 | pA |
| | | | | | T_{In} | 150° | C. | | |
| 22 | Glass | Chromium | NA | Helium | P | 1,300 | mbar | +1.2 | pA |
| | | | | | T_{In} | 150° | C. | | |
| 23 | Glass | Chromium | NA | Xenon | P | 200 | mbar | +0.2 | pA |
| | | | | | T_{In} | 150° | C. | | |
| 24 | Aluminum | Glass | NA | Air | P | 811 | mbar | −1.1 | pA |
| | | | | | T_{In} | 200° | C. | | |
| 25 | Aluminum | Phlogopite | NA | Helium | P | 300 | mbar | +0.004 to 2.1 | |
| | | Mica | | | T_{In} | 200-400° | C. | pA | |
| 26 | Doped | Stainless | NA | Argon | P | 100 | mbar | +0.076 to 20.3 | |
| | nitrocellulose | Steel | | | T_{In} | 25-87° | C. | pA | |
| 27 | Glass | Aluminum | NA | Helium | P | 300 | mbar | +0.065 to 0.4 | |
| | | | | | T_{Ex} | 60-100° | C. | pA | |
| 28 | Macor ® | Aluminum | NA | Argon | P | 300 | mbar | +0.011 to 3.67 | |
| | | | | | T_{In} | 100-200° | C. | pA | |
| 29 | Glass | Chromium | Alumina, | Xenon | P | 130 | mbar | +0.078 to 17 | |
| | | | 3 μm | | T_{In} | 150-250° | C. | pA | |
| 30 | Aluminum | Glass | NA | Helium | P | 300 | mbar | −0.1 | pA |
| | | | | | T_{Ex} | 60° | C. | | |
| 31 | Doped | Stainless | NA | Argon | P | 100 | mbar | +0.8 to 1.25 | |
| | nitrocellulose | Steel | | | T_{In} | 80° | C. | pA | |
| | | | | | T_{Ex} | 18-24° | C. | | |
| 32 | Glass | Chromium | Alumina, | Argon | P | 200 | mbar | +0.14 | pA |
| | | | 1 μm | | T_{In} | 150° | C. | | |
| 33 | Glass | Chromium | Alumina, | Helium | P | 500 | mbar | +0.3 | pA |
| | | | 1 μm | | T_{In} | 150° | C. | | |
| 34 | Glass | Chromium | Alumina, | Xenon | P | 110 | mbar | +0.08 | pA |
| | | | 1 μm | | T_{In} | 150° | C. | | |
| 35 | Glass | Chromium | Alumina, | Argon | P | 120 | mbar | +0.07 | pA |
| | | | 3 μm | | T_{In} | 150° | C. | | |
| 36 | Glass | Chromium | Alumina, | Helium | P | 400 | mbar | +0.1 | pA |
| | | | 3 μm | | T_{In} | 150° | C. | | |
| 37 | Glass | Chromium | Alumina, | Xenon | P | 200 | mbar | +0.06 | pA |
| | | | 3 μm | | T_{In} | 150° | C. | | |
| 38 | Glass | Chromium | Alumina, | Xenon | P | 130 | mbar | +17 | pA |
| | | | 3 μm | | T_{In} | 250° | C. | | |
| 39 | Glass | Chromium | Alumina, | Argon | P | 320 | mbar | +2.3 | pA |
| | | | 7 μm | | T_{In} | 250° | C. | | |
| 40 | Glass | Chromium | Alumina, | Helium | P | 1,000 | mbar | +5 | pA |
| | | | 7 μm | | T_{In} | 250° | C. | | |
| 41 | Glass | Chromium | Alumina, | Xenon | P | 240 | mbar | +1 | pA |
| | | | 7 μm | | T_{In} | 250° | C. | | |
| 42 | Glass | Aluminum | NA | Water | P | 7 | mbar | +0.6 | pA |
| | | | | vapour | T_{In} | 60° | C. | | |
| 43 | Glass | Aluminum | NA | Water | P | 27 | mbar | −12 | pA |
| | | | | vapour | T_{In} | 60° | C. | | |
| 44 | Ph doped Si | Aluminum | NA | Helium | P | 1,100 | mbar | +8.5x to 52x10³ | |
| | wafer (8-12 | | | | T_{In} | 150-200° | C. | pA | |
| | ohm · cm) | | | | | | | | |
| 45 | Bo doped Si | Aluminum | NA | Helium | P | 1,100 | mbar | −2.7 to −15x10³ | |
| | wafer (0.1-1.2 | | | | T_{In} | 150-200° | C. | pA | |
| | ohm · m) | | | | | | | | |
| 46 | Ph doped Si | Bo doped Si | NA | Helium | P | 1,100 | mbar | +0.9x10³ | |
| | wafer (8-12 | wafer (0.1-1.2 | | | T_{In} | 200° | C. | pA | |
| | ohm · cm) | ohm · cm) | | | | | | | |
| 47 | Ph doped Si | Gadolinium | NA | Helium | P | 1,100 | mbar | +6.5x to 110x10³ | |
| | wafer (0.7-1.3 | | | | T_{In} | 110-195° | C. | pA | |
| | ohm · cm) | | | | | | | | |
| 48 | Aluminum | Ph doped Si | Alumina, | Xenon | P | 1,100 | mbar | +0.24 | pA |
| | | wafer (8-12 | 7 μm | | T_{In} | 250° | C. | | |
| | | ohm · cm) | | | T_{Ex} | 70° | C. | | |
| 49 | Aluminum | Ph doped Si | Alumina, | Argon | P | 1,100 | mbar | +1 | pA |
| | | wafer (8-12 | 7 μm | | T_{In} | 250° | C. | | |
| | | ohm · cm) | | | T_{Ex} | 70° | C. | | |
| 50 | Aluminum | Ph doped Si | Alumina, | Helium | P | 1,100 | mbar | +1 | pA |
| | | wafer (8-12 | 7 μm | | T_{In} | 250° | C. | | |
| | | ohm · cm) | | | T_{Ex} | 70° | C. | | |
| 51 | SiO₂ | WO₃ | NA | Helium | P | 500 | mbar | +1.25 to 1.50 | |
| | | | | | T_{In} | 250-300° | C. | pA | |
| 52 | BN | Aluminum | Alumina, | Helium | P | 1,100 | mbar | −1 | pA |
| | | | 1 μm | | T_{In} | 200° | C. | | |
| 53 | Aluminum | BN | Alumina, | Helium | P | 1,100 | mbar | +0.2 | pA |
| | | | 1 μm | | T_{In} | 200° | C. | | |
| 54 | Glass | Aluminum | Alumina, | Helium | P | 750 | mbar | +1.6 | pA |
| | | | 3 μm | | T_{In} | 200° | C. | | |
| | | | | | T_{Ex} | 70° | C. | | |
| 55 | AlN | MnO₂ | NA | Helium | P | 1,100 | mbar | +0.2 | pA |
| | | | | | T_{In} | 180° | C. | | |
| 56 | SiO₂ | MnO₂ | NA | Helium | P | 1,100 | mbar | +6 | pA |
| | | | | | T_{In} | 180° | C. | | |
| 57 | Aluminum | Mn—Ni—O | NA | Helium | P | 1,100 | mbar | +1 | pA |
| | | | | | T_{In} | 180° | C. | | |
| 58 | SiO₂ | Mn—Ni—O | NA | Helium | P | 1,100 | mbar | +2 | pA |
| | | | | | T_{In} | 180° | C. | | |
| 59 | Glass | r-GO | NA | Helium | P | 1,100 | mbar | +150 | pA |
| | | (graphene) | | | T_{In} | 180° | C. | | |
| 60 | Glass | Cr₃Si—SiO₂ | NA | Helium | P | 1,100 | mbar | +1 | pA |
| | | | | | T_{In} | 180° | C. | | |
| 61 | Glass | Mo | NA | Helium | P | 1,100 | mbar | +8 | pA |
| | | | | | T_{In} | 180° | C. | | |
| 62 | Act. Glass | Act. r-GO | NA | Helium | P | 1,100 | mbar | +130 | pA |
| | | | | | T_{In} | 120° | C. | | |

| | | | | | | | | |
|---|---|---|---|---|---|---|---|---|
| 63 | Glass | r-GO | NA | Helium | P | 1,100 | mbar | +0.008 to 86 |
| | | (graphene) | | | T_{In} | 72-180° | C. | pA |
| 64 | Glass | Cr₃Si—SiO₂ | NA | Helium | P | 1,100 | mbar | +0.015 to 0.48 |
| | | | | | T_{In} | 126-180° | C. | pA |
| 65 | Glass | Mo | NA | Helium | P | 1,100 | mbar | +0.015 to 3 |
| | | | | | T_{In} | 111-180° | C. | pA |
| 66 | Glass | MnO₂ | NA | Helium | P | 1,100 | mbar | +0.043 to 0.16 |
| | | | | | T_{In} | 136-180° | C. | pA |

Table 6 demonstrates that electrical current was generated using devices and methods according to various exemplary embodiments of the invention. The experiments showed that the measured current and voltage originated from the interactions between the selected materials and gas medium. This was evidenced by the temperature and pressure dependence of the current, by the fact that no current was observed in vacuum, and by the fact that current direction was reversed when the cell structure was inverted. The experiments further showed that current was generated even with noble gases and/or inert materials, thus ruling out electrochemical reactions. The experiments additionally demonstrated that the direction of the current is opposite to the current that would have been generated by electrochemical processes.

The fact that the total voltage of a stack of multiple pairs of structures corresponds to the appropriate multiple of the voltage of a single pair (experiment V) further indicates that the measured electrical power generated by this invention is not derived from any external circuit or undesired experimental effect.

The observations made in connection with the generation of current and voltage according to some embodiments of the invention, were in agreement with the gas mediated charge-transfer mechanism discovered by the present inventor. The generation of electricity was shown for a variety of surfaces of different charge transferability, with a conductivity range spanning several orders of magnitude. Numerous gasses were found suitable under various working conditions. The dependence of efficiency upon temperature and pressure evidences existence of the gas mediated charge-transfer mechanism of this invention. The experiments show that, pursuant to this invention, the current, already significant above noise at room temperature, grows exponentially with temperature (FIG. 15). For a given pair of spaced apart surfaces and a specific gas, the current reaches a plateau of maximal value at an threshold pressure that correlates with the size of the gas molecules. For a given pair of surfaces and specific gas, the smaller the gap the higher the measured current and the smaller the gap the higher the threshold pressure at which maximal current is generated.

The experimental data clearly evidence the underlying mechanism of the invention: a gas mediated charge transfer effect which converts thermal energy directly into electric current.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. For example, the device of FIG. 2 is shown as having parallel columns of serially connected cells. In some embodiments of the invention, the cells may be overlapping so that they are not in the form of parallel columns, but rather in the form of cells which form a more complex structure, such as a brickwork or random structure. Further, while the spacers are described as being formed of particles or separate elements, the surface asperities (surface roughness) of the partially-conducting surfaces themselves may act as spacers, in that only a small percentage of one surface actually makes contact with the other surface, so that the overall conductivity between the surfaces remains low, notwithstanding the surface asperity contact. In addition, while the invention describes methods and devices that operate at or near room temperature, the method may be practiced at elevated temperatures such as 50, 100, 150, 200 or 400° C. as well as at higher, intermediate and lower temperatures.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A cell device for directly converting thermal energy to electricity, comprising:
a first surface and second surface with a gap between said surfaces; and
a gas medium having gas molecules in thermal motion situated between the surfaces;
said first surface being operative to transfer an electric charge to gas molecules interacting with said first surface, and said second surface being operative to receive said charge from gas molecules interacting with said second surface;
wherein an electrical potential difference between said surfaces is generated by said charge transfer in the absence of externally applied voltage.

2. A cell device for directly converting thermal energy to electricity, comprising:
a first surface and second surface with a gap between said surfaces; and
a gas medium having gas molecules in thermal motion situated between the surfaces;
said first surface being operative to transfer an electric charge to gas molecules interacting with said first surface, and said second surface being operative to receive said charge from gas molecules interacting with said second surface;
wherein said gap is less than 1000 nanometers.

3. A cell device for directly converting thermal energy to electricity, comprising:
a first surface and second surface with a gap between said surfaces; and
a gas medium having gas molecules in thermal motion situated between the surfaces;
said first surface being operative to transfer an electric charge to gas molecules interacting with said first surface, and said second surface being operative to receive said charge from gas molecules interacting with said second surface;
wherein said first and said second surfaces are within 50 C.° of each other.

4. (canceled)

5. The device according to claim 3, wherein one of said surfaces charges the gas molecules and the other surface neutralizes the charged gas molecules.

6. The device according to claim 3, wherein both of said surfaces charge gas molecules, one charging gas molecules positively and the other charging gas molecules negatively.

7. The device according to claim 3, wherein said first surface has a positive charge transferability and said second surface has a negative charge transferability.

8. (canceled)

9. The device according to claim 3, wherein at least one of said surfaces is a surface of an electrically conducting substrate.

10. The device according to claim 3, wherein at least one of said surfaces is a surface of a substrate having electrical conductivity less than 10⁻⁹ S/m.

11. A power source device, comprising a plurality of cell devices according to claim 3, wherein at least one pair of adjacent cell devices is interconnected by a conductor such that current flows through said conductor from a second surface of a first device of said pair to a first surface of a second device of said pair.

12. The power source device according to claim 11, wherein said pairs of adjacent cell devices are arranged in a series and parallel arrangement such that the current of the power source device is greater than that of any single cell and such that the voltage of the power source device

13. A power source device, comprising:
a first electrically conducting electrode and a second electrically conducting electrode;
a first stack of cell devices and a second stack of cell devices between said electrodes, each cell device being according to claim 3;
wherein in each stack, each pair of adjacent cell devices of said stack is interconnected by a conductor such that current flows through said conductor from a second surface of a first cell device of said pair to a first surface of a second cell device of said pair; and
wherein both said first stack and said second stack convey charge from said first electrode to said second electrode.

14. The device according to claim 11, wherein said conductor is an electrically conductive substrate having two sides, one side of which constitutes a surface of one cell device and the opposite side constitutes a surface of an adjacent cell device.

15. The device according to claim 11, wherein said conductor is a substrate coated with a conductive material such as to establish electrical conduction between a first side of said substrate and a second side of said substrate; and
wherein said coated substrate has two sides, one side of which constitutes a surface of one cell device and the opposite side constitutes a surface of an adjacent cell device.

16. The device according to claim 11, wherein the surfaces of the cells overlap one another in an ordered or random manner, such that a single substrate's surface is partially shared by at least two cells.

17. The device according to claim 3, further comprising a sealed enclosure for preventing leakage of said gas medium.

18-21. (canceled)

22. The device according to claim 3, wherein any voltage between said surfaces is generated by said charge transfer in the absence of externally applied voltage.

23. The device according to claim 3, wherein said gap is less than 1000 nm.

24-27. (canceled)

28. The device according to claim 1, wherein said first and said second surfaces are within 50 C.° of each other.

29-33. (canceled)

34. The device according to claim 3, wherein at least one of said first surface and second surface is selected from the group consisting of:
(i) a substantially smooth surface, wherein said gap is maintained by spacers; and
(ii) a generally non-smooth surface having roughness features outwardly protruding therefrom, wherein said gap is maintained by said roughness features.

35-38. (canceled)

39. The device according to claim 3, wherein each of said first surface and said second surface is supported by a substrate selected from the group consisting of a graphene substrate and a graphite substrate.

40. (canceled)

41. The device according to claim 3, wherein each of said first surface and said second surface is a modified graphite or graphene substrate.

42. The device according to claim 3, wherein one of said first surface and said second surface is a modified graphite or graphene substrate and the other is an unmodified graphite or graphene substrate.

43-47. (canceled)

48. The device according to claim 3, wherein said gas medium is not consumed during operation of the device.

49. (canceled)

50. A method of directly converting thermal energy to electricity, comprising:
providing a first surface and second surface with gap between said surfaces;
interacting molecules of a gas medium with said first surface so as to transfer an electric charge to at least some of the gas molecules; and
interacting a portion of said gas molecules with said second surface, so as to transfer said charge to said second surface from at least some of said gas molecules, thereby generating a potential difference between said surfaces;
wherein said first and said second surfaces are within 50 C.° of each other.

51-54. (canceled)

55. The method according to claim 50, wherein any voltage between said surfaces is generated by said charge transfer in the absence of externally applied voltage.

56. The method according to claim 50, wherein said gap is less than 1000 nm.

57-65. (canceled)

66. A method of modifying properties of a surface, comprising:
providing at least one cell device having a first surface and second surface with a gap between said surfaces filled with a liquid medium having therein electroactive species, said gap being of less than 50 micrometers;
applying voltage between said first and said second surfaces so as to induce electrochemical or electrophoretic interaction of said electroactive species with at least one of said surfaces, thereby modifying surface properties of said interacted surface; and
evacuating at least a portion of said liquid so as to reduce said gap by at least 50%.

67. The method according to claim 66, wherein said at least one cell device is a plurality of cell devices.

68. (canceled)

69. The method according to claim 66, wherein said first and said second surfaces are made of the same material prior to said surface modification, and wherein said electroactive species are selected such that subsequent to said electrochemical or electrophoretic interaction, a characteristic charge transferability of said first surface differs from a characteristic charge transferability of said second surface.

70. The method according to claim 69, wherein said same material is selected from the group consisting of graphene and graphite.

71-72. (canceled)
